(19) United States
(12) Patent Application Publication
(10) Pub. No.: US 2016/0085163 A1
(43) Pub. Date: Mar. 24, 2016

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Kenji KAJIWARA, Kanagawa (JP); Katsumi NUKADA, Kanagawa (JP); Hidekazu HIROSE, Kanagawa (JP); Tomoya SASAKI, Kanagawa (JP); Yuko IWADATE, Kanagawa (JP); Tatsuki SANO, Kanagawa (JP)

(21) Appl. No.: 14/602,997

(22) Filed: Jan. 22, 2015

(30) Foreign Application Priority Data
Sep. 24, 2014 (JP) 2014-194116

(51) Int. Cl. G03G 15/00

(52) U.S. Cl. CPC G03G 5/0648; G03G 5/0507; G03G 5/0618; G03G 5/062

(57) ABSTRACT

An electrophotographic photoreceptor includes a conductive substrate and a photosensitive layer provided on the conductive substrate, wherein an outermost surface layer of the electrophotographic photoreceptor is a cured film of a composition containing a reactive charge transporting material and silica particles having a hydrophobization-treated surface.

### CROSS-REFERENCE TO RELATED APPLICATIONS

This application is based on and claims priority under 35 USC 119 from Japanese Patent Application No. 2014-194116 filed Sep. 24, 2014.

### BACKGROUND

1. Technical Field

The present invention relates to an electrophotographic photoreceptor, a process cartridge, and an image forming apparatus.

2. Related Art

It has been proposed to provide a protective layer on the surface of an electrophotographic photoreceptor used in an image forming apparatus in an electrophotographic mode to increase the strength.

In recent years, protective layers composed of acrylic materials have attracted public attention.

### SUMMARY

According to an aspect of the invention, there is provided an electrophotographic photoreceptor including a conductive substrate and a photosensitive layer provided on the conductive substrate,

wherein an outermost surface layer of the electrophotographic photoreceptor is a cured film of a composition comprising a reactive charge transporting material and silica particles having a hydrophobization-treated surface.

### BRIEF DESCRIPTION OF THE DRAWINGS

Exemplary embodiments of the present invention will be described in detail based on the following figures, wherein:

FIG. 1 is a schematic partial cross-sectional view showing an example of the layer configuration of the electrophotographic photoreceptor according to the present exemplary embodiment;

FIG. 2 is a schematic partial cross-sectional view showing another example of the layer configuration of the electrophotographic photoreceptor according to the present exemplary embodiment;

FIG. 3 is a schematic partial cross-sectional view showing still another example of the layer configuration of the electrophotographic photoreceptor according to the present exemplary embodiment;

FIG. 4 is a schematic block diagram showing an example of the image forming apparatus according to the present exemplary embodiment; and

FIG. 5 is a schematic block diagram showing another example of the image forming apparatus according to the present exemplary embodiment.

### DETAILED DESCRIPTION

Hereinafter, the present exemplary embodiment which is one example of the invention will be described.

Electrophotographic Photoreceptor

The electrophotographic photoreceptor according to the present exemplary embodiment has a conductive substrate, and a photosensitive layer provided on the conductive substrate.

The outermost surface layer of the electrophotographic photoreceptor is composed of a cured film of a composition containing a reactive charge transporting material and silica particles having a hydrophobization-treated surface (hereinafter also referred to as “hydrophobic silica particles”).

Here, the outermost surface layer is a layer provided farthest from the conductive substrate among the layers provided on the conductive substrate in the electrophotographic photoreceptor. Specifically, the outermost surface layer is provided, for example, as a layer functioning as a protective layer, a layer functioning as a charge transport layer, or a layer having a combination of these functions.

According to the above configuration, the electrophotographic photoreceptor according to the present exemplary embodiment may be an electrophotographic photoreceptor having an outermost surface layer which is excellent in stability of electrical characteristics and scratch resistance. The reason is not clear, but it is presumably due to the following reason.

First, when the outermost surface layer of the electrophotographic photoreceptor includes silica particles, the mechanical strength of the outermost surface layer increases due to its function as a lubricant. On the other hand, the silica particles are particles having a surface exhibiting hydrophilicity since they have a number of silanol groups on the surface, and they have low affinity for the reactive charge transporting material which is an organic material. As a result, when the composition including a reactive charge transporting material is simply blended with silica particles, it has lower dispersibility in the composition due to the effect of the silanol group. Further, in an outermost surface layer including a cured film formed by curing the composition, the dispersibility of the silica particles is lowered, and thus, a function as a lubricant is not sufficiently exhibited and the mechanical strength hardly increases. Further, by the local effect of the silanol group (polar group) of the surface of the silica particles, the stability of electrical characteristics of the outermost surface layer may be deteriorated in some cases.

In this regard, when hydrophobic silica particles are blended in a system including a reactive charge transporting material, the dispersibility of the hydrophobic silica particles in the composition increases. Further, the behavior of the hydrophobic silica particles that are formed as the composition is cured (particularly by heating) is also prevented. Thus, the hydrophobic silica particles are more easily dispersed in a substantially uniform state in an outermost surface layer including a cured film formed by curing this composition. As a result, in the outermost surface layer, the hydrophobic silica particles sufficiently exhibit a function as a lubricant, and thus the mechanical strength of the outermost surface layer increases.

Furthermore, it is thought that the hydrophobic silica particles are easily dispersed in a substantially uniform state, and further, the number of silanol groups on the surface decreases or is hardly exposed to the surface by a hydrophobization treatment, which result in substantially uniform dispersion of the hydrophobic silica particles as well as suppressed local effects of the silanol groups in the outermost surface layer, thereby increasing the stability of electrical characteristics of the outermost surface layer.

For the above reason, it is presumed that the electrophotographic photoreceptor according to the present exemplary embodiment would be an electrophotographic photoreceptor having an outermost surface layer which is excellent in stability of electrical characteristics and scratch resistance.

Incidentally, an image forming apparatus (or a process cartridge) provided with the electrophotographic photoreceptor according to the present exemplary embodiment may prolong the duration of the service life.

Here, the composition including a reactive charge transporting material is a low-viscosity composition since it includes a monomer component representative of reactive charge transporting materials. Further, the coating film of the low-viscosity composition tends to have low uniformity in the film thickness. On the other hand, since the hydrophobic silica particles have a high dispersibility in the composition including a reactive charge transporting material, the content of the hydrophobic silica particles may be increased. As a result, by adjusting the amount of the hydrophobic silica particles blended into the composition including a reactive charge transporting material, it is promoted to adjust the viscosity (increase the viscosity) of the composition. That is, the coating film of the composition including the reactive charge transporting material and the hydrophobic silica particles have increased uniformity in the film thickness, and thus, the uniformity in the film thickness of the outermost surface layer including a cured film of the obtained composition increases.

In the electrophotographic photoreceptor according to the present exemplary embodiment, it is preferable to apply hollow silica particles (silica particles having holes inside the particles) as a hydrophobic silica particle. The hollow silica particles have a low dielectric constant and prevent light scattering, and thus, the stability of the electrical characteristics of the outermost surface layer increases.

In the electrophotographic photoreceptor according to the present exemplary embodiment, it is preferable to use a cured film of a composition including at least one kind selected from the group consisting of reactive compounds represented by the formulae (I) and (II) (hereinafter also referred to as “a specific reactive charge transporting material”) as the reactive charge transporting material as an outermost surface layer. When the cured film of the composition is used as an outermost surface layer, the stability of electrical characteristics and the scratch resistance of the outermost surface layer easily increase. The reason is not clear, but it is presumably due to the following reason.

First, since the specific reactive charge transporting material has a vinyl phenyl group (styryl group) having high-hydrophobicity, it has higher hydrophobicity and higher affinity for hydrophobic silica particles than a reactive charge transporting material having a (meth)acryloyl group. As a result, when hydrophobic silica particles are blended into a specific composition including a reactive charge transporting material, the dispersibility of the hydrophobic silica particles further increases. Thus, it is thought that in the outermost surface layer, the hydrophobic silica particles further exert a function as a lubricant, and thus, the mechanical strength of the outermost surface layer further increases.

Next, the specific reactive charge transporting material is excellent in charge transporting performance, and further, has a small number of polar groups disturbing a charge transporting property, such as —OH and —NH—, and further, as a vinyl phenyl group (styryl group) having π electrons effective for charge transport, the materials are connected by polymerization, and therefore, the residual distortion is prevented, and formation of a trap having a structure capturing electrons is prevented. Further, it is thought that the specific reactive charge transporting material has a property of being more hydrophobic than an acrylic material and moisture is hardly attached thereto, and thus, the electrical characteristics are maintained for a long period of time.

In addition, the specific reactive charge transporting material has a property of having a high reaction rate, and thus likely to generate pores in a film (outermost surface layer) thus formed.

As a result, it is presumed that when a cured film of a composition including at least one kind selected from the group consisting of specific reactive charge transporting materials as a reactive charge transporting material is used in an outermost surface layer, an electrophotographic photoreceptor having an outermost surface layer which is excellent in stability of electrical characteristics and scratch resistance is easily obtained.

Furthermore, in the electrophotographic photoreceptor according to the present exemplary embodiment, it is sufficient for the outermost surface layer to form the top surface of the electrophotographic photoreceptor itself, and the outer layer is provided as a layer functioning as a protective layer or a layer functioning as a charge transport layer. In the case where the outermost surface layer is a layer functioning as a protective layer, the protective layer has a photosensitive layer including a charge transport layer and a charge generating layer, or a single layer type photosensitive layer in the lower layers.

Specifically, in the case where the outermost surface layer is a layer functioning as a protective layer, an exemplary embodiment in which a photosensitive layer (a charge generating layer and a charge transport layer, or a single layer type photosensitive layer), and a protective layer as the outermost surface layer are sequentially formed on a conductive substrate may be mentioned. On the other hand, in the case where the outermost surface layer is a layer functioning as a charge transport layer, an exemplary embodiment in which a charge generating layer and a charge transport layer as the outermost surface layer are sequentially formed on a conductive substrate may be mentioned.

Hereinafter, the electrophotographic photoreceptor according to the present exemplary embodiment will be described in detail with reference to the accompanying figures. Incidentally, in the figures, the same or corresponding parts are denoted with the same symbols and duplicated explanations are omitted.

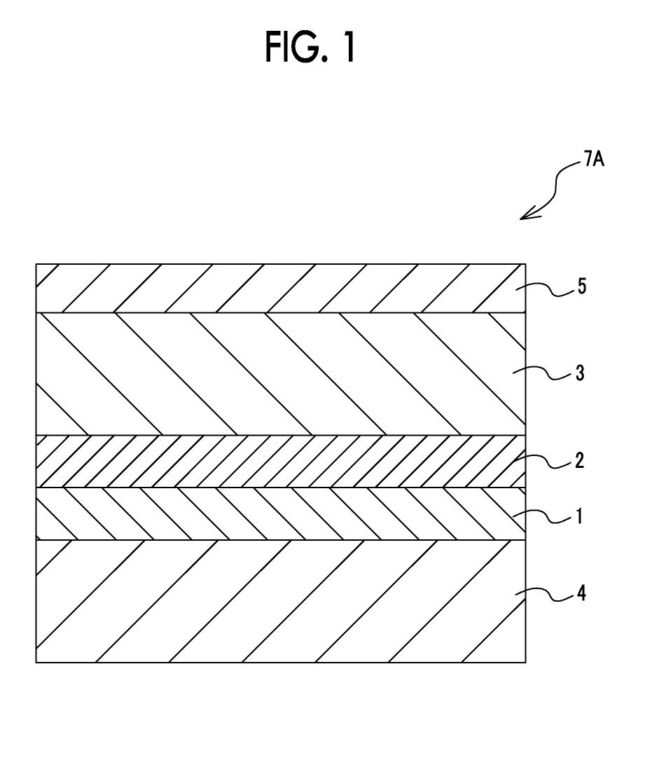

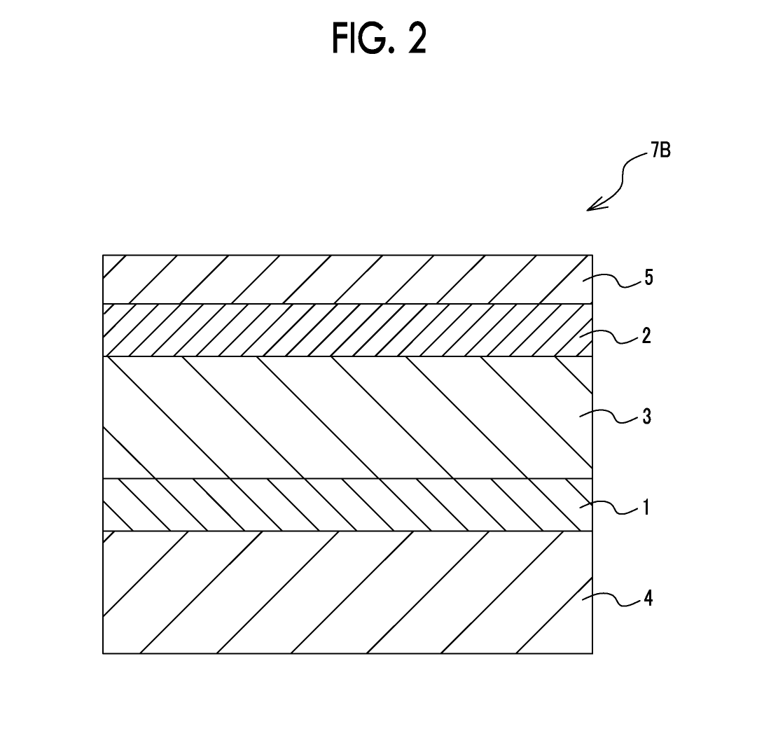

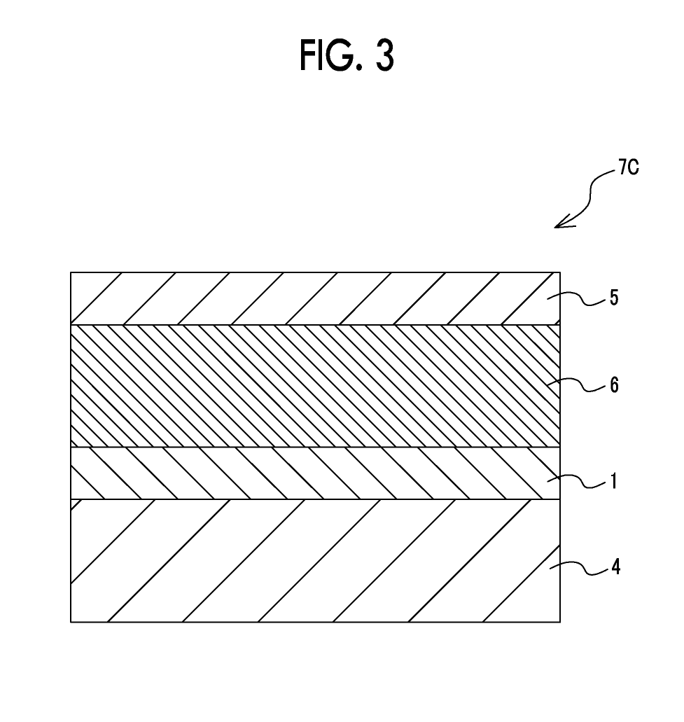

FIG. 1 is a schematic cross-sectional view showing an example of the present exemplary embodiment of the electrophotographic photoreceptor. FIGS. 2 and 3 are each a schematic cross-sectional view showing another example of the electrophotographic photoreceptor according to the present exemplary embodiment.

An electrophotographic photoreceptor 7A shown in FIG. 1 is a so-called function separating type photoreceptor (or a lamination type photoreceptor) having a structure in which an undercoat layer 1 is provided on a conductive substrate 4, and a charge generating layer 2, a charge transport layer 3, and a protective layer 5 are sequentially formed thereon. In the electrophotographic photoreceptor 7A, a photosensitive layer is composed of the charge generating layer 2 and the charge transport layer 3.

An electrophotographic photoreceptor 7B shown in FIG. 2 is a function separating type photoreceptor similar to the electrophotographic photoreceptor 7A shown in FIG. 1, in which the functions are separated to a charge generating layer 2 and a charge transport layer 3.

The electrophotographic photoreceptor 7B shown in FIG. 2 has a structure in which an undercoat layer 1 is provided on the conductive substrate 4, and a charge transport layer 3, a charge generating layer 2, and a protective layer 5 are sequentially formed thereon. In the electrophotographic photoreceptor 7B, the photosensitive layer is composed of the charge transport layer 3 and the charge generating layer 2.

An electrophotographic photoreceptor 7C shown in FIG. 3 includes a charge generating material and a charge transporting material in the same layer (the single layer type photosensitive layer 6). The electrophotographic photoreceptor 7C shown in FIG. 3 has a structure in which an undercoat layer 1 is provided on the conductive substrate 4, and a single layer type photosensitive layer 6 and a protective layer 5 are sequentially formed thereon.

Furthermore, in the electrophotographic photoreceptors 7A, 7B, and 7C shown in FIGS. 1, 2, and 3, a protective layer 5 is the outermost surface layer arranged farthest from the conductive substrate 4, and the outermost surface layer has the constitution as described above.

Further, in the electrophotographic photoreceptors shown in FIGS. 1, 2, and 3, the undercoat layer 1 may be provided or may not be provided.

Each of the elements will be explained below based on electrophotographic photoreceptor 7A shown in FIG. 1 as a representative example. Further, the explanations of the symbols are omitted.

Conductive Substrate

Examples of the conductive substrate include metal plates, metal drums, and metal belts containing metals (such as aluminum, copper, zinc, chromium, nickel, molybdenum, vanadium, indium, gold, andplatinum), and alloys thereof (such as stainless steel). Further, other examples of the conductive substrate include papers, resin films, and belts which are coated, deposited, or laminated with a conductive compound (such as a conductive polymer and indium oxide), a metal (such as aluminum, palladium, and gold), or alloys thereof. The term “conductive” means that the volume resistivity is less than 10¹³ Ωcm.

When the electrophotographic photoreceptor is used in a laser printer, the surface of the conductive substrate is preferably roughened so as to have a centerline average roughness (Ra) of 0.04 μm to 0.5 μm sequentially to prevent interference fringes which are formed when irradiated by laser light. Further, when an incoherent light is used as a light source, surface roughening for preventing interference fringes is not particularly necessary, but occurrence of defects due to the irregularities on the surface of the conductive substrate is prevented, which is thus suitable for achieving a longer service life.

Examples of the method for surface roughening include wet honing in which an abrasive suspended in water is blown onto a conductive substrate, centerless grinding in which a support is continuously ground by pressing a conductive substrate onto a rotating grind stone, and anodic oxidation treatment.

Other examples of the method for surface roughening include a method for surface roughening by forming a layer of a resin in which conductive or semiconductive particles are dispersed on the surface of a conductive substrate so that the surface roughening is achieved by the particles dispersed in the layer, without roughing the surface of the conductive substrate.

In the surface roughening treatment by anodic oxidation, an oxide film is formed on the surface of a conductive substrate by anodic oxidation in which a metal (for example, aluminum) conductive substrate as an anode is anodized in an electrolyte solution. Examples of the electrolyte solution include a sulfuric acid solution and an oxalic acid solution. However, the porous anodic oxide film formed by anodic oxidation without modification is chemically active, easily contaminated and has a large resistance variation depending on the environment. Therefore, it is preferable to conduct a sealing treatment in which fine pores of the anodic oxide film are sealed by cubical expansion caused by a hydration in pressurized water vapor or boiled water (to which a metallic salt such as a nickel salt may be added) to transform the anodic oxide into a more stable hydrated oxide.

The film thickness of the anodic oxide film is preferably from 0.3 μm to 15 μm. When the thickness of the anodic oxide film is within the above range, a barrier property against injection tends to be exerted and an increase in the residual potential due to the repeated use tends to be prevented.

The conductive substrate may be subjected to a treatment with an acidic aqueous solution or a boehmite treatment.

The treatment with an acidic treatment solution is carried out as follows. First, an acidic treatment solution including phosphoric acid, chromic acid, and hydrofluoric acid is prepared. The mixing ratio of phosphoric acid, chromic acid, and hydrofluoric acid in the acidic treatment solution is, for example, from 10% by weight to 11% by weight of phosphoric acid, from 3% by weight to 5% by weight of chromic acid, and from 0.5% by weight to 2% by weight of hydrofluoric acid. The concentration of the total acid components is preferably in the range of 13.5% by weight to 18% by weight. The treatment temperature is, for example, preferably from 42° C. to 48° C. The film thickness of the film is preferably from 0.3 μm to 15 μm.

The boehmite treatment is carried out by immersing the substrate in pure water at a temperature of 90° C. to 100° C. for 5 minutes to 60 minutes, or by bringing it into contact with heated water vapor at a temperature of 90° C. to 120° C. for 5 minutes to 60 minutes. The film thickness is preferably from 0.1 μm to 5 μm. The film may further be subjected to an anodic oxidation treatment using an electrolyte solution which sparingly dissolves the film, such as adipic acid, boric acid, borate, phosphate, phthalate, maleate, benzoate, tartrate, and citrate solutions.

Undercoat Layer

The undercoat layer is, for example, a layer including inorganic particles and a binder resin.

Examples of the inorganic particles include inorganic particles having powder resistance (volume resistivity) of about 10² Ωcm to 10¹¹ Ωcm.

Among these, as the inorganic particles having the above resistance values above, metal oxide particles such as tin oxide particles, titanium oxide particles, zinc oxide particles, and zirconium oxide particles are preferable, and zinc oxide particles are more preferable.

The specific surface area of the inorganic particles as measured by a BET method is, for example, preferably 10 m²/g or more.

The volume average particle diameter of the inorganic particles is, for example, preferably from 50 nm to 2000 nm, and more preferably from 60 nm to 1000 nm.

The content of the inorganic particles is, for example, preferably from 10% by weight to 80% by weight, and more preferably from 40% by weight to 80% by weight, based on the binder resin.

The inorganic particles may be the ones which have been subjected to a surface treatment. The inorganic particles which have been subjected to different surface treatments or have different particle diameters may be used in combination of two or more kinds.

Examples of the surface treatment agent include a silane coupling agent, a titanate coupling agent, an aluminum coupling agent, and a surfactant. Particularly, the silane coupling agent is preferable, and a silane coupling agent having an amino group is more preferable.

Examples of the silane coupling agent having an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

These silane coupling agents may be used as a mixture of two or more kinds thereof. For example, a silane coupling agent having an amino group and another silane coupling agent may be used in combination. Other examples of the silane coupling agent include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any one of known methods, and may be either a dry method or a wet method.

The amount of the surface treatment agent for treatment is, for example, preferably from 0.5% by weight to 10% by weight, based on the inorganic particles.

Here, inorganic particles and an electron acceptive compound (acceptor compound) are preferably included in the undercoat layer from the viewpoint of superiority in long-term stability of electrical characteristics and carrier blocking property.

Examples of the electron acceptive compound include electron transporting materials such as quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; and diphenoquinone compounds such as 3,3′,5,5′-tetra-t-butyldiphenoquinone.

Particularly, as the electron acceptive compound, compounds having an anthraquinone structure are preferable. As the electron acceptive compounds having an anthraquinone structure, hydroxyanthraquinone compounds, aminoanthraquinone compounds, aminohydroxyanthraquinone compounds, and the like are preferable, and specifically, anthraquinone, alizarin, quinizarin, anthrarufin, purpurin, and the like are preferable.

The electron acceptive compound may be included as dispersed along with the inorganic particles in the undercoat layer, or may be included as attached to the surface of the inorganic particles.

Examples of the method of attaching the electron acceptive compound to the surface of the inorganic particles include a dry method and a wet method.

The dry method is a method for attaching an electron acceptive compound to the surface of the inorganic particles, in which the electron acceptive compound is added dropwise to the inorganic particles or sprayed thereto together with dry air or nitrogen gas, either directly or in the form of a solution in which the electron acceptive compound is dissolved in an organic solvent, while the inorganic particles are stirred with a mixer or the like having a high shearing force. The addition or spraying of the electron acceptive compound is preferably carried out at a temperature not higher than the boiling point of the solvent. After the addition or spraying of the electron acceptive compound, the inorganic particles may further be subjected to baking at a temperature of 100° C. or higher. The baking may be carried out at any temperature and timing without limitation, by which desired electrophotographic characteristics may be obtained.

The wet method is a method for attaching an electron acceptive compound to the surface of the inorganic particles, in which the inorganic particles are dispersed in a solvent by means of stirring, ultrasonic wave, a sand mill, an attritor, a ball mill, or the like, then the electron acceptive compound is added and the mixture is further stirred or dispersed, and thereafter, the solvent is removed. As a method for removing the solvent, the solvent is removed by filtration or distillation. After removing the solvent, the particles may further be subjected to baking at a temperature of 100° C. or higher. The baking may be carried out at any temperature and timing without limitation, in which desired electrophotographic characteristics may be obtained. In the wet method, the moisture contained in the inorganic particles may be removed prior to adding the electron acceptive compound, and examples of a method for removing the moisture include a method for removing the moisture by stirring and heating the inorganic particles in a solvent or by azeotropic removal with the solvent.

Furthermore, the attachment of the electron acceptive compound may be carried out before or after the inorganic particles are subjected to a surface treatment using a surface treatment agent, and the attachment of the electron acceptive compound may be carried out at the same time with the surface treatment using a surface treatment agent.

The content of the electron acceptive compound is, for example, preferably from 0.01% by weight to 20% by weight, and more preferably from 0.01% by weight to 10% by weight, based on the inorganic particles.

Examples of the binder resin used in the undercoat layer include known materials, such as well-known polymeric compounds such as acetal resins (for example, polyvinylbutyral), polyvinyl alcohol resins, polyvinyl acetal resins, casein resins, polyamide resins, cellulose resins, gelatins, polyurethane resins, polyester resins, unsaturated polyether resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenol resins, phenol-formaldehyde resins, melamine resins, urethane resins, alkyd resins, and epoxy resins; zirconium chelate compounds; titanium chelate compounds; aluminum chelate compounds; titaniumalkoxide compounds; organic titanium compounds; and silane coupling agents.

Other examples of the binder resin used in the undercoat layer include charge transporting resins having charge transporting groups, and conductive resins (for example, polyaniline).

Among these, as the binder resin used in the undercoat layer, a resin which is insoluble in a coating solvent of an upper layer is suitable, and particularly, thermosetting resins such as urea resins, phenol resins, phenol-formaldehyde resins, melamine resins, urethane resins, unsaturated polyester resins, alkyd resins, and epoxy resins; and resins obtained by a reaction of a curing agent and at least one kind of resin selected from the group consisting of polyamide resins, polyester resins, polyether resins, methacrylic resins, acrylic resins, polyvinyl alcohol resins, and polyvinyl acetal are suitable.

In the case where these binder resins are used in combination of two or more kinds thereof, the mixing ratio is set as appropriate.

Various additives may be used for the undercoat layer to improve electrical characteristics, environmental stability, or image quality.

Examples of the additives include known materials such as the polycyclic condensed type or azo type of the electron transporting pigments, zirconium chelate compounds, titanium chelate compounds, aluminum chelate compounds, titanium alkoxide compounds, organic titanium compounds, and silane coupling agents. A silane coupling agent, which is used for surface treatment of inorganic particles as described above, may also be added to the undercoat layer as an additive.

Examples of the silane coupling agent as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethylacetoacetate, zirconium triethanolamine, acetylacetonate zirconium butoxide, ethylacetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetranormalbutyl titanate, butyl titanate dimer, tetra(2-ethylhexyl) titanate, titanium acetyl acetonate, polytitaniumacetyl acetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxy aluminum diisopropylate, aluminum butylate, diethylacetoacetate aluminum diisopropylate, and aluminum tris(ethylacetoacetate).

These additives may be used singly, or as a mixture or a polycondensate of two or more kinds thereof.

The Vickers hardness of the undercoat layer is preferably 35 or more.

The surface roughness of the undercoat layer (ten point height of irregularities) is adjusted in the range of from (¼) nλ to (½)λ, in which λ represents the wavelength of the laser for exposure and n represents a refractive index of the upper layer, in order to prevent a moire image.

Resin particles and the like may be added in the undercoat layer in order to adjust the surface roughness. Examples of the resin particles include silicone resin particles and crosslinked polymethyl methacrylate resin particles. In addition, the surface of the undercoat layer may be polished in order to adjust the surface roughness. Examples of the polishing method include buffing grinding, a sandblasting treatment, wet honing, and a grinding treatment.

The formation of the undercoat layer is not particularly limited, and well-known forming methods are used. However, the formation of the undercoat layer is carried out by, for example, forming a coating film of a coating liquid for forming an undercoat layer, the coating liquid being obtained by adding the components above to a solvent, and drying the coating film, followed by heating, as desired.

Examples of the solvent for forming the coating liquid for forming the undercoat layer include alcohol solvents, aromatic hydrocarbon solvents, hydrocarbon halide solvents, ketone solvents, ketone alcohol solvents, ether solvents, and ester solvents.

Examples of these solvents include ordinary organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of a method for dispersing inorganic particles in preparing the coating liquid for forming an undercoat layer include known methods such as methods using a roll mill, a ball mill, a vibration ball mill, an attritor, a sand mill, a colloid mill, a paint shaker, and the like.

Further, as a method for coating the coating liquid for forming an undercoat layer onto a conductive substrate include ordinary methods such as a blade coating method, a wire bar coating method, a spraying method, a dip coating method, a bead coating method, an air knife coating method, and a curtain coating method.

The film thickness of the undercoat layer is set to a range of, for example, preferably 15 μm or more, and more preferably from 20 μm to 50 μm.

Intermediate Layer

Although not shown in the figures, an intermediate layer may be provided between the undercoat layer and the photosensitive layer.

The intermediate layer is, for example, a layer including a resin. Examples of the resin used in the intermediate layer include polymeric compounds such as acetal resins (for example polyvinylbutyral), polyvinyl alcohol resins, polyvinyl acetal resins, casein resins, polyamide resins, cellulose resins, gelatins, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer including an organic metal compound. Examples of the organic metal compound used in the intermediate layer include organic metal compounds containing a metal atom such as zirconium, titanium, aluminum, manganese, and silicon.

These compounds used in the intermediate layer may be used singly or as a mixture or a polycondensate of plural compounds.

Among these, a layer containing an organometallic compound containing a zirconium atom or a silicon atom is preferable.

The formation of the intermediate layer is not particularly limited, and well-known forming methods are used. However, the formation of the intermediate layer is carried out, for example, by forming a coating film of a coating liquid for forming an intermediate layer, the coating liquid being obtained by adding the components above to a solvent, and drying the coating film, followed by heating, as desired.

As a coating method for forming an intermediate layer, ordinary methods such as a dip coating method, an extrusion coating method, a wire bar coating method, a spraying method, a blade coating method, a knife coating method, and a curtain coating method are used.

The film thickness of the intermediate layer is set to, for example, preferably from 0.1 μm to 3 μm. Further, the intermediate layer may be used as an undercoat layer.

Charge Generating Layer

The charge generating layer is, for example, a layer including a charge generating material and a binder resin. Further, the charge generating layer may be a layer in which a charge generating material is deposited. The layer in which the charge generating material is deposited is suitable for a case where a non-interfering light source such as a light emitting diode (LED) and an organic electro-luminescence (EL) image array is used.

Examples of the charge generating material include azo pigments such as bisazo and trisazo pigments; condensed aromatic pigments such as dibromoanthanthrone pigments; perylene pigments; pyrrolopyrrole pigments; phthalocyanine pigments; zinc oxides; and trigonal selenium.

Among these, in order to corresponding to laser exposure in the near-infrared region, it is preferable to use metal or nonmetal phthalocyanine pigments as the charge generating material, and specifically, hydroxygallium phthalocyanine disclosed in JP-A-5-263007, JP-A-5-279591, and the like; chlorogallium phthalocyanine disclosed in JP-A-5-98181 and the like; dichlorotin phthalocyanine disclosed in JP-A-5-140472, JP-A-5-140473, and the like; and titanyl phthalocyanine disclosed in JP-A-4-189873 and the like are more preferable.

On the other hand, in order to corresponding to laser exposure in the near-ultraviolet region, as the charge generating material, condensed aromatic pigments such as dibromoanthanthrone; thioindigo pigments; porphyrazine compounds; zinc oxides; trigonal selenium; bisazo pigments disclosed in JP-A-2004-78147 and JP-A-2005-181992; and the like are preferable.

In the case of using non-interfering light sources such as LED having a light emitting center wavelength at 450 nm to 780 nm and organic EL image arrays, the above charge generating materials may be used, but from the viewpoint of resolution, when a photosensitive layer is used as a thin film having a thickness of 20 μm or less, the electric field intensity in the photosensitive layer increases, and thus, a decrease in charging by charge injection from a substrate, that is image defects such as so-called a black spots are easily generated. This becomes apparent when a charge generating material easily causing generation of dark currents as a p-type semiconductor such as trigonal selenium and phthalocyanine pigment is used.

In this regard, in the case where a n-type semiconductor such as condensed aromatic pigments, perylene pigments, azo pigments is used as a charge generating material, dark currents are not easily generated, and image defects called as a black spot may be prevented even when used as a thin film. Examples of the n-type charge generating material include the compounds (CG-1) to (CG-27) in paragraph Nos. [0288] to [0291] of JP-A-2012-155282, but are not limited thereto.

In addition, determination of n-type ones may be conducted as follows: by employing a time-of-flight method commonly used, with the polarity of photocurrents, a charge generating material where electrons that are easily flown out than holes as a carrier is determined as an n-type one.

The binder resin used in the charge generating layer may be selected from a wide range of insulating resins, and further, the binder resin may be selected from organic photoconductive polymers such as poly-N-vinyl carbazole, polyvinyl anthracene, polyvinyl pyrene, and polysilane.

Examples of the binder resin include polyvinyl butyral resins, polyarylate resins (polycondensates of bisphenols and aromatic divalent carboxylic acid or the like), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. The term “insulating” means that the volume resistivity is 10¹³ Ωcm or more.

These binder resins may be used singly or as a mixture of two or more kinds thereof.

Furthermore, the blending ratio of the charge generating material and the binder resin is preferably in the range of 10:1 to 1:10 by weight ratio.

In addition, well-known additives may be included in the charge generating layer.

The formation of the charge generating layer is not particularly limited, and well-known forming methods are used. However, the formation of the charge generating layer is carried out by, for example, forming a coating film of a coating liquid for forming a charge generating layer, the coating liquid being obtained by adding the components above to a solvent, and drying the coating film, followed by heating, as desired. Further, the formation may also be carried out by deposition of a charge generating material. The formation of charge generating layer by deposition is particularly suitable for a case of using a condensed aromatic pigment or a perylene pigment as a charge generating material.

Examples of the solvent used for the preparation of coating liquid for forming a charge generating layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene. These solvents may be used singly or as a mixture two or more kinds thereof.

For a method for dispersing particles (for example charge generating materials) in the coating liquid for forming a charge generating layer, for example, a media dispersing machine such as a ball mill, a vibrating ball mill, an attritor, a sand mill, and a horizontal sand mill, or a medialess dispersing machine such as a stirrer, an ultrasonic dispersing machine, a roll mill, and a high-pressure homogenizer is used. Examples of the high-pressure homogenizer include a collision system in which the particles are dispersed by causing the dispersion to collide against liquid or against walls under a high pressure, and a penetration system in which the particles are dispersed by causing the dispersion to penetrate through a fine flow path under a high pressure.

In addition, the average particle diameter of the charge generating materials in the coating liquid for forming a charge generating layer during the dispersion is effectively 0.5 μm or less, preferably 0.3 μm or less, and more preferably 0.15 μm or less.

Examples of a method for coating the coating liquid for forming a charge generating layer onto the undercoat layer (or an intermediate layer) include ordinary methods such as a blade coating method, a wire bar coating method, a spraying method, a dip coating method, a bead coating method, an air knife coating method, and a curtain coating method.

The film thickness of the charge generating layer is set to a range of, for example, preferably from 0.1 μm to 5.0 μm, and more preferably from 0.2 μm to 2.0 μm.

Charge Transport Layer

The charge transport layer is, for example, a layer including a charge transporting material and a binder resin. The charge transport layer may be a layer including a polymeric charge transporting material.

Examples of the charge transporting material include electron transporting compounds, such as quinone compounds such as p-benzoquinone, chloranil, bromanil, and anthraquinone; tetracyanoquinodimethane compounds; fluorenone compounds such as 2,4,7-trinitro fluorenone; xanthone compounds; benzophenone compounds; cyanovinyl compounds; and ethylene compounds. Other examples of the charge transporting material include hole transport compounds such as triarylamine compounds, benzidine compounds, arylalkane compounds, aryl substituted ethylene compounds, stilbene compounds, anthracene compounds, and hydrazone compounds. These charge transporting materials may be used alone or in combination of two or more kinds thereof, but are not limited thereto.

The charge transporting material is preferably a triaryl amine derivative represented by the following structural formula (a-1) and a benzidine derivative represented by the following structural formula (a-2) from the viewpoint of charge mobility.

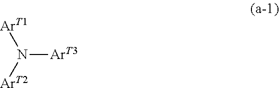

In the structural formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}), and R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituents of each of the above groups include a halogen atom, an alkyl group having 1 to 5 carbon atoms, an alkoxy group having 1 to 5 carbon atoms. Other examples of the substituents of each of the above groups include substituted amino groups substituted with an alkyl group having 1 to 3 carbon atoms.

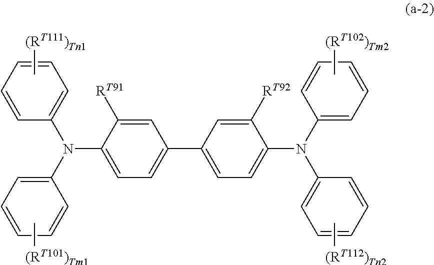

In the structural formula (a-2), R^{T91} and R^{T92} each independently represent a hydrogen atom, a halogen atom, an alkyl group having 1 to 5 carbon atoms, or an alkoxy group having 1 to 5 carbon atoms; R^{T101}, R^{T102}, R^{T111} and R^{T112} each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R^{T12})═C(R^{T13})(R^{T14}) or —CH═CH—CH═C(R^{T15})(R^{T16}); R^{T12}, R^{T13}, R^{T14}, R^{T15} and R^{T16} each independently represent a hydrogen atom, a substituted or unsubstituted alkyl group, or a substituted or unsubstituted aryl group; and Tm1, Tm2, Tn1 and Tn2 each independently represent an integer of 0 to 2.

Examples of the substituents of each of the above groups include a halogen atom, an alkyl group having 1 to 5 carbon atoms, an alkoxy group having 1 to 5 carbon atoms. Other examples of the substituents of each of the above groups include substituted amino groups substituted with an alkyl group having 1 to 3 carbon atoms.

Here, among the triarylamine derivatives represented by the structural formula (a-1) and the benzidine derivatives represented by the structural formula (a-2), triarylamine derivatives having “—C₆H₄—CH═CH—CH═C(R^{T7}) (R^{T8})” and benzidine derivatives having “—CH═CH—CH═C(R^{T15})(R^{T16})” are particularly preferable from the viewpoint of charge mobility.

As the polymeric charge transporting material, known materials having charge transporting properties such as poly-N-vinyl carbazole and polysilane are used. The polyester-based polymeric charge transporting materials disclosed in JP-A-8-176293, JP-A-8-208820, and the like are particularly preferable. Further, the polymeric charge transporting materials may be used singly or in combination with a binder resin.

Examples of the binder resin used in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone-alkyd resins, phenol-formaldehyde resins, styrene-alkyd resins, poly-N-vinyl carbazole, and polysilane. Among these, polycarbonate resins and polyarylate resins are suitable. These binder resins may be used singly or in combination of two or more kinds thereof.

As a binder resin used in the charge transport layer, a polycarbonate is preferably applied. Examples of the polycarbonate include various polycarbonates, but from the viewpoint of the electrical characteristics and the scratch resistance of the protective layer (outermost surface layer), a polycarbonate copolymer having a solubility parameter (hereinafter also referred to as a “SP value” in some cases) as calculated by a Feders method is preferably from 11.40 to 11.75 (preferably from 11.40 to 11.70) (hereinafter also referred to as a “specific polycarbonate copolymer”) is preferable. Details of the specific polycarbonate copolymer are described in Paragraph Nos. [0100] to [0126] of JP-A-2014-056119.

Further, the blending ratio of the charge transporting material to the binder resin is preferably from 10:11 to 1:5 by weight ratio.

In addition, well-known additives may be included in the charge transport layer.

The formation of the charge transport layer is not particularly limited, and well-known forming methods are used. However, the formation of the charge transport layer is carried out by, for example, forming a coating film of a coating liquid for forming a charge transport layer, the coating liquid being obtained by adding the components above to a solvent, and drying the coating film, followed by heating, as desired.

Examples of the solvent used for the coating solution for forming the charge transport layer include ordinary organic solvents, such as aromatic hydrocarbons such as benzene, toluene, xylene, and chlorobenzene; ketones such as acetone and 2-butanone; aliphatic hydrocarbon halides such as methylene chloride, chloroform, and ethylene chloride; and cyclic or straight-chained ethers such as tetrahydrofuran and ethyl ether. These solvents may be used singly or in combination of two or more kinds thereof.

Examples of a method for coating the coating liquid for forming a charge transport layer onto the charge generating layer include ordinary methods such as a blade coating method, a wire bar coating method, a spraying method, a dip coating method, a bead coating method, an air knife coating method, and a curtain coating method.

The film thickness of the charge transport layer is set to a range to preferably 5 μm to 50 μm and more preferably 10 μm to 30 μm.

Protective Layer

The protective layer (outermost surface layer) is the outermost surface layer in the electrophotographic photoreceptor and is composed of a cured film of a composition including a reactive charge transporting material and hydrophobic silica particles. That is, the protective layer includes a polymer or crosslinked product of the reactive charge transporting material, and hydrophobic silica particles.

The protective layer may be composed of a composition further including other additives such as a non-reactive charge transporting material, a compound having an unsaturated bond (unsaturated double bond), and resin particles. That is, the protective layer may include other additives such as a polymer or crosslinked product of the reactive charge transporting material and the compound having an unsaturated bond, hydrophobic silica particles, the resin particle, and the non-reactive charge transporting material.

Furthermore, examples of a method for curing the cured film include radical polymerization by heat, light, radioactive ray, or the like. When the reaction is adjusted so as not to proceed too fast, the mechanical strength and the electrical characteristics of the protective layer (outermost surface layer) are improved and generation of the unevenness or wrinkles of the film is prevented. Therefore, it is preferable to carryout the polymerization under the condition where the generation of radicals occurs relatively slowly. From this viewpoint, thermal polymerization that allows the polymerization speed to be easily adjusted is suitable. That is, the composition for forming a cured film constituting the protective layer (outermost surface layer) preferably includes a thermal radical generator or a derivative thereof.

Reactive Charge Transporting Material

The reactive charge transporting material is selected from well-known materials that are compounds having a charge transporting skeleton and a reactive group in the same molecule. Here, examples of the reactive group include known reactive groups such as a chain polymerizable group, an epoxy group, —OH, —OR [in which R represents an alkyl group], —NH₂, —SH, —COOH, —SiR^{Q1}_{3-Qn} (OR^{Q2})_{Qn} [in which R^{Q1} represents a hydrogen atom, an alkyl group, or substituted or unsubstituted aryl group, R^{Q2} represents a hydrogen atom, an alkyl group, or a trialkylsilyl group, and Qn represents an integer of 1 to 3]. Among these, from the viewpoint of improvement of the electrical characteristics and the scratch resistance of the protective layer (outermost surface layer), the chain polymerizable group is preferable.

The chain polymerizable group is preferably a functional group capable of causing radical polymerization, and examples thereof include functional groups having a group containing at least a carbon double bond. Specifically, the chain polymerizable group is not particularly limited as long as it is a functional group capable of causing radical polymerization, and examples thereof include a functional group containing at least a carbon double bond. Specific examples thereof include groups containing at least one selected from a vinyl group, a vinyl ether group, a vinyl thioether group, a vinyl phenyl group (styryl group), an acryloyl group, a methacryloyl group, and derivatives thereof. Among these, due to superior reactivity, a group containing at least one selected from a vinyl group, a vinyl phenyl group (styryl group), an acryloyl group, a methacryloyl group, and derivatives thereof is preferable as the chain polymerizable functional group.

Furthermore, the charge transporting skeleton is not particularly limited as long as it is a known structure in the electrophotographic photoreceptor, it is, for example, a skeleton derived from nitrogen-containing hole transporting compound such as a triarylamine compound, a benzidine compound, and a hydrazone compound, and examples thereof include structures conjugated with nitrogen atoms. Among these, a triarylamine skeleton is preferable.

Here, the reactive charge transporting material may be of either a crosslinked type or a non-crosslinked type, but from the viewpoints of the electrical characteristics and the mechanical strength, the crosslinked type is preferable.

Specifically, the reactive charge transporting material is preferably at least one kind selected from the group consisting of reactive compounds (specific reactive charge transporting materials) represented by the formulae (I) and (II) from the viewpoints of the electrical characteristics and the mechanical strength.

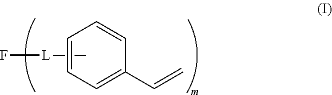

In the formula (I), F represents a charge transporting skeleton.

L represents a divalent linking group including two or more selected from the group consisting of an alkylene group, an alkenylene group, —C(═O)—, —N(R)—, —S—, and —O—. R represents a hydrogen atom, an alkyl group, an aryl group, or an aralkyl group.

m represents an integer of 1 to 8.

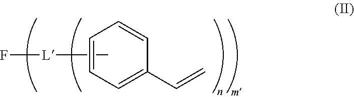

In the formula (II), F represents a charge transporting skeleton.

L′ represents an (n+1)-valent linking group including two or more selected from the group consisting of a trivalent or tetravalent group derived from an alkane or an alkene, an alkylene group, an alkenylene group, —C(═O)—, —N(R)—, —S—, and —O—. R represents a hydrogen atom, an alkyl group, an aryl group, or an aralkyl group. Further, the trivalent or tetravalent group derived from an alkane or an alkene means a group formed by the removal of 3 or 4 hydrogen atoms from an alkane or an alkene. The same shall apply hereinafter.

m′ represents an integer of 1 to 6. n represents an integer of 2 or 3.

In the formulae (I) and (II), F represents a charge transporting skeleton, that is, a structure having a charge transporting property, and specific examples thereof include structures having a charge transporting property, such as a phthalocyanine compound, a phorphyrin compound, an azobenzene compound, a triarylamine compound, a benzidine compound, an arylalkane compound, an aryl-substituted ethylene compound, a stilbene compound, an anthracene compound, a hydrazone compound, a quinone compound, and a fluorenone compound.

In the formula (I), examples of the linking group represented by L include:

a divalent linking group having —C(═O)—O— inserted in an alkylene group,

a divalent linking group having —C(═O)—N(R)— inserted in an alkylene group,

a divalent linking group having —C(═O)—S— inserted in an alkylene group,

a divalent linking group having —O— inserted in an alkylene group,

a divalent linking group having —N(R)— inserted in an alkylene group, and

a divalent linking group having —S— inserted in an alkylene group.

Furthermore, the linking group represented by L may have two groups of, —C(═O)—O—, —C(═O)—N(R)—, —C(═O)—S—, —O—, or —S— inserted in an alkylene group.

In the formula (I), specific examples of the linking group represented by L include:

*—(CH₂)ₚ—C(═O)—O—(CH₂)_{q}—,

*—(CH₂)ₚ—O—C(═O)—(CH₂)ᵣ—C(═O)—O—(CH₂)_{q}—,

*—(CH₂)ₚ—C(═O)—N(R)—(CH₂)_{q}—,

*—(CH₂)ₚ—C(═O)—S—(CH₂)_{q}—,

*—(CH₂)ₚ—O—(CH₂)_{q}—,

*—(CH₂)ₚ—N(R)—(CH₂)_{q}—,

*—(CH₂)ₚ—S—(CH₂)_{q}—, and

*—(CH₂)ₚ—O—(CH₂)ᵣ—O—(CH₂)_{q}—.

Here, in the linking group represented by L, p represents 0, or an integer of 1 to 6 (preferably 1 to 5). q represents an integer of 1 to 6 (preferably 1 to 5). r represents an integer of 1 to 6 (preferably 1 to 5).

Furthermore, in the linking group represented by L, “*” represents a site linked to F.

On the other hand, in the formula (II), examples of the linking group represented by L′ include:

an (n+1)-valent linking group having —C(═O)—O— inserted in an alkylene group linked in the branched shape,

an (n+1)-valent linking group having —C(═O)—N(R)— inserted in an alkylene group linked in the branched shape,

an (n+1)-valent linking group having —C(═O)—S— inserted in an alkylene group linked in the branched shape,

an (n+1)-valent linking group having —O— inserted in an alkylene group linked in the branched shape,

an (n+1)-valent linking group having —N(R)— inserted in an alkylene group linked in the branched shape, and

an (n+1)-valent linking group having —S— inserted in an alkylene group linked in the branched shape.

Furthermore, the linkage represented by L′ may have two groups selected from —C(═O)—O—, —C(═O)—N(R)—, —C(═O)—S—, —O—, and —S— in an alkylene group linked in the branched shape.

In the formula (II), specific examples of the linking group represented by L′ include:

*—(CH₂)ₚ—CH[C(═O)—O—(CH₂)_{q}—]₂.

*—(CH₂)ₚ—CH═C[C(═O)—O—(CH₂)_{q}—]₂.

*—(CH₂)ₚ—CH[C(═O)—N(R)—(CH₂)_{q}—]₂.

*—(CH₂)ₚ—CH[C(═O)—S—(CH₂)_{q}—]₂.

*—(CH₂)ₚ—CH[(CH₂)ᵣ—O—(CH₂)_{q}—]₂,

*—(CH₂)—CH═C[(CH₂)ᵣ—O—(CH₂)_{q}—]₂.

*—(CH₂)ₚ—CH[(CH₂)ᵣ—N(R)—(CH₂)_{q}]₂.

*—(CH₂)ₚ—CH[(CH₂)ᵣ—S—(CH₂)_{q}—]₂,

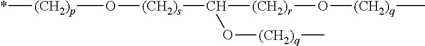

*—(CH₂)ₚ—O—C[(CH₂)ᵣ—O—(CH₂)_{q}—]₃ and

*—(CH₂)ₚ—C(═O)—O—C[(CH₂)ᵣ—O—(CH₂)_{q}—]₃.

Here, in the linking group represented by L′, p represents 0, or an integer of 1 to 6 (preferably 1 to 5). q represents an integer of 1 to 6 (preferably 1 to 5). r represents an integer of 1 to 6 (preferably 1 to 5). s represents an integer of 1 to 6 (preferably 1 to 5).

Further, in the linking group represented by L′, “*” represents a site linked to F.

Among these, in the formula (II), the linking group represented by L′ is preferably:

*—(CH₂)ₚ—CH[C(═O)—O—(CH₂)_{q}—]₂.

*—(CH₂)ₚ—CH═C[C(═O)—O—(CH₂)_{q}—]₂.

*—(CH₂)ₚ—CH[(CH₂)ᵣ—O—(CH₂)_{q}—]₂, or

*—(CH₂)ₚ—CH═C[(CH₂)ᵣ—O—(CH₂)_{q}—]₂.

Specifically, the group (corresponding to a group represented by the formula (IIA-a)) linked to the charge transporting skeleton represented by F of the compound represented by the formula (II) may be a group represented by the following formula (IIA-a1), (IIA-a2), (IIA-a3), or (IIA-a4).

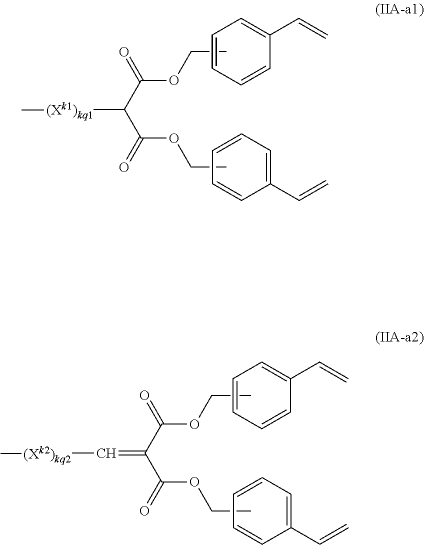

In the formula (IIA-a1) or (IIA-a2), X^{k1} represents a divalent linking group. kq1 represents an integer of 0 or 1. X^{k2} represents a divalent linking group. kq2 represents an integer of 0 or 1.

Here, examples of the divalent linking group represented by X^{k1} and X^{k2} include —(CH₂)ₚ— (provided that p represents an integer of 1 to 6 (preferably 1 to 5)). Examples of the divalent linking group include an alkyloxy group.

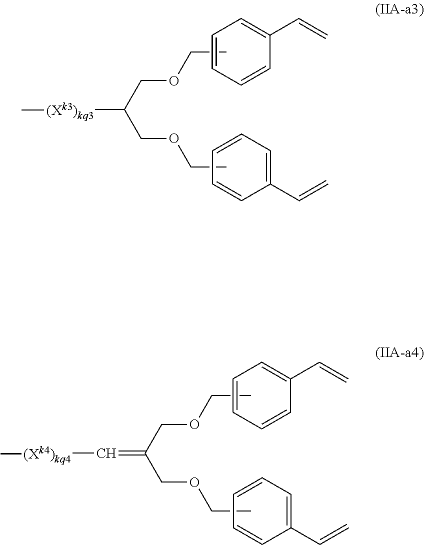

In the formula (IIA-a3) or (IIA-a4), X^{k3} represents a divalent linking group. kq3 represents an integer of 0 or 1. X^{k4} represents a trivalent linking group. kq4 represents an integer of 0 or 1. Here, examples of the divalent linking group represented by X^{k3} and X^{k4} include —(CH₂)ₚ— (provided that p represents an integer of 1 to 6 (preferably 1 to 5)). Examples of the divalent linking group include an alkyloxy group.

In the formulae (I) and (II), in the linking groups represented by L and L′, examples of the alkyl group represented by R of “—N(R)—” include linear or branched alkyl groups having 1 to 5 carbon atoms (preferably 1 to 4 carbon atoms), and specifically, a methyl group, an ethyl group, a propyl group, and a butyl group.

Examples of the aryl group represented by R of “—N(R)—” include aryl groups having 6 to 15 carbon atoms (preferably 6 to 12 carbon atoms), and specifically, a phenyl group, a tolyl group, a xylidyl group, and a naphthyl group.

Examples of the aralkyl group include aralkyl groups having 7 to 15 carbon atoms (preferably 7 to 14 carbon atoms), and specifically, a benzyl group, a phenethyl group, and a biphenylmethylene group.

In the formulae (I) and (II), m preferably represents an integer of 1 to 6.

m′ preferably represents an integer of 1 to 6.

n preferably represents an integer of 2 or 3.

Next, suitable compounds of the reactive compounds represented by the formulae (I) and (II) will be described.

The reactive compounds represented by the formulae (I) and (II) are preferably reactive compounds having a charge transporting skeleton (structure having a charge transporting property) derived from a triarylamine-based compound as F.

Specifically, as the reactive compound represented by the formula (I), at least one compound selected from the reactive compounds represented by the formulae (I-a), (I-b), (I-c), and (I-d) is suitable.

On the other hand, as the reactive compound represented by the formula (II), the reactive compound represented by the formula (II-a) is suitable.

Reactive Compound Represented by Formula (I-a)

The reactive compound represented by the formula (I-a) will be described.

In the case where the reactive compound represented by the formula (I-a) is applied as the specific reactive charge transporting material, the deterioration of the electrical characteristics due to the environmental change is easily prevented. The reason therefor is not clear, but is thought to be as follows.

First, it may be thought that for the reactive compound having a (meth)acryl group used in the related art, the (meth)acryl group is highly hydrophilic with respect to the skeleton site exhibiting the charge transporting performance during the polymerization. As a result, it is thought that a certain kind of layer separation state is formed, and thus, the hopping conduction is disturbed. Therefore, it is thought that the charge transporting film including a polymer or crosslinked product of a (meth)acryl group-containing reactive compound exhibits deterioration of the efficiency in the charge transport, and further, the partial moisture adsorption or the like causes a decrease in the environmental stability.

Meanwhile, the reactive compound represented by the formula (I-a) has a vinyl chain polymerizable group having low hydrophilicity, and further, has several skeletons exhibiting the charge transporting performance in one molecule, and the skeletons are linked to each other with a flexible linking group having no aromatic ring and conjugated bond such as a covalent double bond. It is thought that such a structure promotes efficient charge transporting performance and high strength, and prevents the formation of the layer separation state during the polymerization. As a result, it is thought that the protective layer (outermost surface layer) including the polymer or crosslinked product of the reactive compound represented by the formula (I-a) is excellent in both of the charge transporting performance and the mechanical strength, and further, the environment dependency (temperature and humidity dependency) of the charge transporting performance may be decreased.

As described above, it is thought that if the reactive compound represented by the formula (I-a) is applied, the deterioration of the electrical characteristics due to the environmental change is easily prevented.

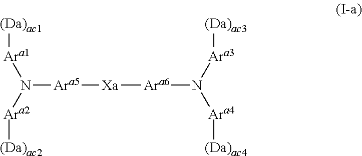

In the formula (I-a), Ar^{a1} to Ar^{a4} each independently represent a substituted or unsubstituted aryl group. Ar^{a5} and Ar^{a6} each independently represent a substituted or unsubstituted arylene group. Xa represents a divalent linking group formed by a combination of the groups selected from an alkylene group, —O—, —S—, and an ester group. Da represents a group represented by the following formula (TA-a). ac1 to ac4 each independently represent an integer of 0 to 2, provided that the total number of Da is 1 or 2.

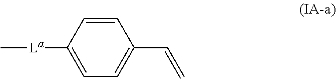

In the formula (IA-a), La is represented by *—(CH₂)ₐₓ—O—CH₂— and represents a divalent linking group linked to a group represented by Ar^{a1} to Ar^{a4} at *. ax represents an integer of 1 or 2.

Hereinafter, the details of the formula (I-a) will be described.

In the formula (I-a), the substituted or unsubstituted aryl groups represented by Ar^{a1} to Ar^{a4} are the same as or different from each other.

Here, examples of the substituents in the substituted aryl group, those other than “Da”, include an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom.

In the formula (I-a), Ar^{a1} to Ar^{a4} are preferably those represented by any one of the following formulae (1) to (7).

Furthermore, the following formulae (1) to (7) are described together with “-(D)_{c}”, which totally refers to “-(Da)_{ac1}” to “-(Da)_{ac1}” that may be linked to each of Ar^{a1} to Ar^{a4}.

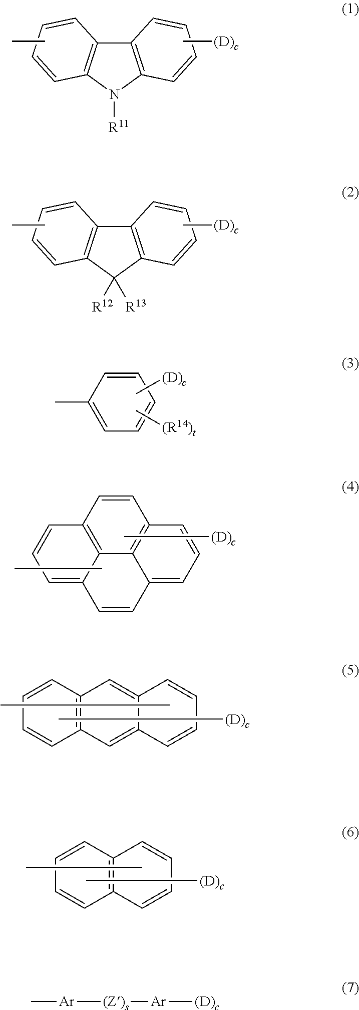

In the structural formulae (1) to (7), R¹¹ represents one selected from a hydrogen atom, an alkyl group having 1 to 4 carbon atoms, a phenyl group substituted with an alkyl group having 1 to 4 carbon atoms or an alkoxy group having 1 to 4 carbon atoms, an unsubstituted phenyl group, and an aralkyl group having 7 to 10 carbon atoms. R¹² and R¹³ each independently represent one selected from the group consisting of a hydrogen atom, an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom. R¹⁴'s each independently represent one selected from the group consisting of an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom. Ar represents a substituted or unsubstituted arylene group. s represents 0 or 1. t represents an integer of 0 to 3. Z′ represents a divalent organic linking group.

Here, in the formula (7), Ar is preferably one represented by the following structural formula (8) or (9).

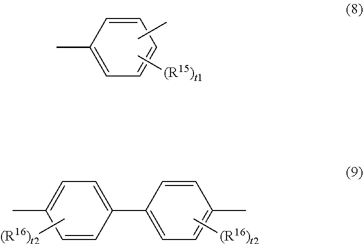

In the structural formulae (8) and (9), R¹⁵ and R¹⁶ each independently represent one selected from the group consisting of an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom, and t1 and t2 each represent an integer of 0 to 3.

Furthermore, in the formula (7), Z′ is preferably one represented by any one of the following structural formulae (10) to (17).

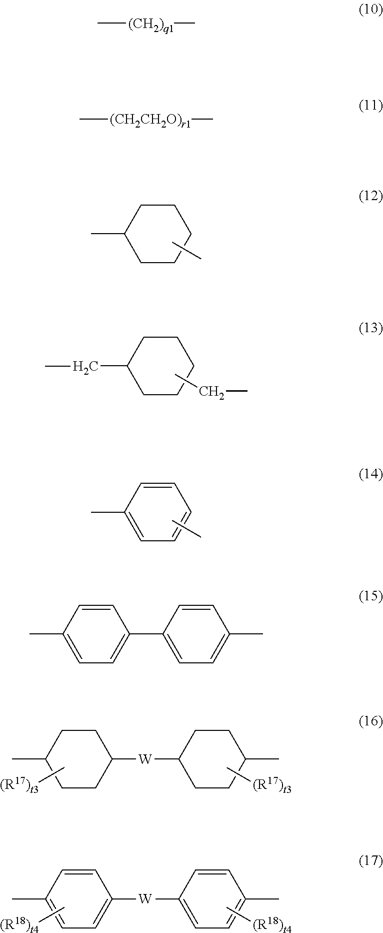

In the structural formulae (10) to (17), R¹⁷ and R¹⁸ each independently represent one selected from the group consisting of an alkyl group having 1 to 4 carbon atoms, an alkoxy group having 1 to 4 carbon atoms, a phenyl group substituted with an alkoxy group having 1 to 4 carbon atoms, an unsubstituted phenyl group, an aralkyl group having 7 to 10 carbon atoms, and a halogen atom. W represents a divalent group. q1 and r1 each independently represent an integer of 1 to 10. t3 and t4 each represent an integer of 0 to 3.

In the structural formulae (16) to (17), W is preferably any one of the divalent groups represented by the following structural formulae (18) to (26), provided that in the formula (25), u represents an integer of 0 to 3.

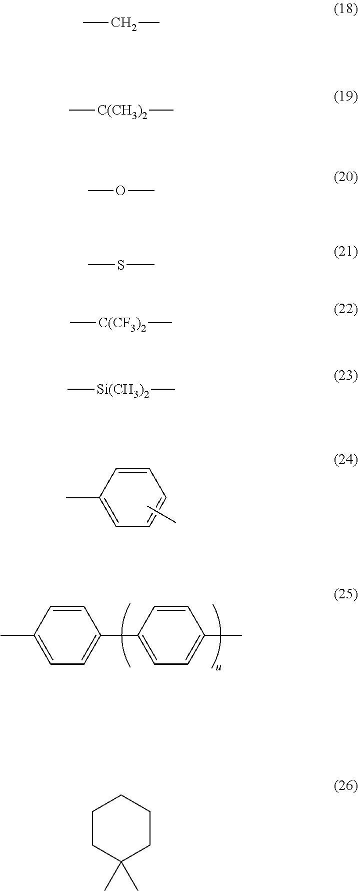

In the formula (I-a), in the substituted or unsubstituted arylene group represented by Ar^{a5} and Ar^{a6}, examples of the arylene group include arylene groups formed by the removal of one hydrogen atom at a desired position from the aryl group exemplified in the description of Ar^{a1} to Ar^{a4}.

Further, examples of the substituent in the substituted arylene group are the same as those exemplified as the substituent other than “Da” in the substituted aryl group in the description of Ar^{a1} to Ar^{a4}.

In the formula (I-a), the divalent linking group represented by Xa is an alkylene group, or a divalent group formed by the combination of the groups selected from an alkylene group, —O—, —S—, and an ester group, and is a linking group not including an aromatic ring and a conjugated bond such as a conjugated double bond.

Specifically, examples of the divalent linking group represented by Xa include an alkylene group having 1 to 10 carbon atoms, as well as a divalent group formed by a combination of an alkylene group having 1 to 10 carbon atoms with a group selected from —O—, —S—, —O—C(═O)—, and —C(═O)—O—.

In addition, when the divalent linking group represented by Xa is an alkylene group, the alkylene group may have a substituent such as alkyl, alkoxy, and halogen atom, and two of these substituents may be bonded to have the structure such as the divalent linking group represented by the structural formula (26) described as the specific examples of W in the structural formulae (16) to (17).

Reactive Compound Represented by Formula (I-b)

The reactive compound represented by the formula (I-b) will be described.

If the reactive compound represented by the formula (I-b) is applied as the specific reactive charge transporting material, the abrasion of the protective layer (outermost surface layer) is prevented, and further, the generation of the uneven concentrations of the image is easily prevented. The reason therefor is not clear, but is thought to be as follows.

First, the bulky charge transporting skeleton and the polymerization site (styryl group) are structurally close to each other to thereby have a rigid structure, whereby it is difficult for polymerization sites to move, residual strain due to a curing reaction easily remains, and the charge transporting skeleton is deformed, and therefore, there occurs a change in the level of highest occupied molecular orbital (HOMO) in charge of carrier transport and as a result, a state where the energy distribution spreads (disorder in energy: large σ) is easily caused.

Meanwhile, through a methylene group or an ether group, it is easy to provide the molecular structure with flexibility and a small σ. Further, the methylene group or the ether group has a small dipole moment, as compared with an ester group, an amide group, or the like, which contributes to a decrease in σ, thereby improving the electrical characteristics. Further, it is thought that by providing the molecular structure with flexibility, the degree of freedom of the movement of the reactive site is increased and the reaction rate is improved, to thereby yield a film having a high strength.

From this viewpoint, a structure where a linking chain having sufficient flexibility is inserted between the charge transporting skeleton and the polymerization site is preferable.

As a result, it is thought that the reactive compound represented by the formula (I-b) has an increased molecular weight of the molecule itself by the curing reaction, to provide a cured material having weight center which is difficult to move, and the styryl group having high degree of freedom. As a result, it is thought that the protective layer (outermost surface layer) including a polymer or crosslinked product of the reactive compound represented by the formula (I-b) has excellent electrical characteristics and high strength.

From the above, if the reactive compound represented by the formula (I-b) is applied, the abrasion of the protective layer (outermost surface layer) is prevented, and further, the generation of the uneven concentrations of the image is easily prevented.

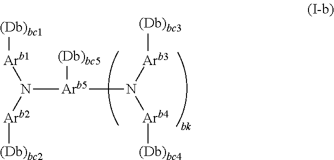

In the formula (I-b), Ar^{b1} to Ar^{b4} each independently represent a substituted or unsubstituted aryl group. Ar^{b5} represents a substituted or unsubstituted aryl group, or a substituted or unsubstituted arylene group. Db represents a group represented by the following formula (IA-b). bc1 to bc5 each independently represent an integer of 0 to 2. bk represents 0 or 1, provided that the total number of Db is 1 or 2.

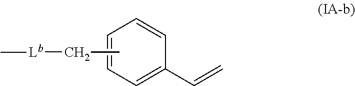

In the formula (IA-b), L^{b} includes a group represented by *—(CH₂)_{bn}—O— and represents a divalent linking group linked to a group represented by Ar^{b1} to Ar^{b5} at *. bn represents an integer of 3 to 6.

Hereinafter, the details of the formula (I-b) will be described.

In the formula (I-b), the substituted or unsubstituted aryl groups represented by Ar^{b1} to Ar^{b4} are the same as the substituted or unsubstituted aryl groups represented by Ar^{a1} to Ar^{a4} in the formula (I-a).

When bk is 0, Ar^{b5} represents a substituted or unsubstituted aryl group, and the substituted or unsubstituted aryl group is the same as the substituted or unsubstituted aryl groups represented by Ar^{a1} to Ar^{a4} in the formula (I-a).

When bk is 1, Ar^{b5} represents a substituted or unsubstituted arylene group, and the substituted or unsubstituted arylene group is the same as the substituted or unsubstituted arylene groups represented by Ar^{a5} and Ar^{a6} in the formula (I-a).

Next, the details of the formula (IA-b) will be described.

In the formula (IA-b), examples of the divalent linking group represented by L^{b} include:

*—(CH₂)_{bp}—O—, and

*—(CH₂)_{bp}—O—(CH₂)_{bq}—O—.

Here, in the linking group represented by L^{b}, by represents an integer of 3 to 6 (preferably 3 to 5). bq represents an integer of 1 to 6 (preferably 1 to 5).

Further, in the linking group represented by L^{b}, “*” represents a site linked to a group represented by Ar^{b1} to Ar^{b5}.

Reactive Compound Represented by Formula (I-c)

The reactive compound represented by the formula (I-c) will be described.

If the reactive compound represented by the formula (I-c) is applied as the specific reactive charge transporting material, it is difficult to generate scratches on the surface even when used repeatedly, and further, deterioration of the image quality is easily prevented. The reason therefor is not clear, but is thought to be as follows.

First, it is thought that film shrinkage accompanying a polymerization reaction or a crosslinking reaction, or aggregation of the charge transporting structure and the structure in the vicinity of a chain polymerizable group occurs when an outermost surface layer including a polymer or crosslinked product of the specific reactive charge transporting material is formed. Therefore, it is thought that when a mechanic load is applied to an electrophotographic photoreceptor surface due to repeated use, the film itself is abraded or the chemical structure in the molecule is cut, whereby the film shrinkage or the aggregation state changes, the electrical characteristics as the electrophotographic photoreceptor changes, and thus, deterioration of the image quality occurs.

On the other hand, it is thought that since the reactive compound represented by the formula (I-c) has a styrene skeleton as the chain polymerizable group, the compatibility with an aryl group which is a main skeleton of the charge transporting material is favorable, and the film shrinkage and the aggregation of the charge transporting structure, and the aggregation of the structure in the vicinity of the reactive group due to the polymerization reaction or the crosslinking reaction are prevented. As a result, it is thought that the electrophotographic photoreceptor including the protective layer (outermost surface layer) including a polymer or crosslinked product of the reactive compound represented by the formula (I-c) suppresses deterioration of the image quality due to the repeated use.

In addition, it is thought that for the reactive compound represented by the formula (I-c), a charge transporting skeleton and a styrene skeleton are linked via a linking group including a specific group such as —C(═O)—, —N(R)—, and —S— to thereby cause the interactions between the specific group and a nitrogen atom in the charge transporting skeleton, and between the specific groups, and the like and as a result, it is also thought that the protective layer (outermost surface layer) including a polymer or crosslinked product of the reactive compound represented by the formula (I-c) has a further improved strength.

From the description above, it is thought that if the reactive compound represented by the formula (I-c) is applied, it is difficult to generate scratches on the surface even when used repeatedly, and further, the deterioration of the image quality is easily prevented.

In addition, it is thought that a specific group such as —C(═O)—, —N(R)—, —S—, and the like causes deterioration of a charge transporting property and deterioration of the image quality under the conditions of high humidity due to its polarity or hydrophilicity, but the reactive compound represented by the formula (I-c) has a styrene skeleton having higher hydrophobicity than (meth)acryl or the like as a chain polymerizable group, and thus, it is not likely to deteriorate the charge transporting property and deterioration of the image quality, such as development of the residual image phenomenon (ghost) caused by the history of the previous cycle.

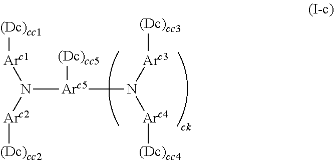

In the formula (I-c), Ar^{c1} to Ar^{c4} each independently represent a substituted or unsubstituted aryl group. Ar^{c5} represents a substituted or unsubstituted aryl group, or a substituted or unsubstituted arylene group. Dc represents a group represented by the following formula (IA-c). cc1 to cc5 each independently represent an integer of 0 to 2. ck represents 0 or 1, provided that the total number of Dc is from 1 to 8.

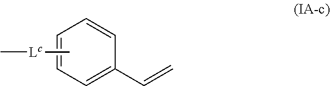

In the formula (IA-c), L^{c} represents a divalent linking group including one or more groups selected from the group consisting of —C(═O)—, —N(R)—, —S—, and a group formed by a combination of —C(═O)—, and —O—, —N(R)—, or —S—. R represents a hydrogen atom, an alkyl group, an aryl group, or an aralkyl group.

Hereinafter, the details of the formula (I-c) will be described.

In the formula (I-c), the substituted or unsubstituted aryl groups represented by Ar^{c1} to Ar^{c4} are the same as the substituted or unsubstituted aryl groups represented by Ar^{a1} to Ar^{a4} in the formula (I-a).

When ck is 0, Ar^{c5} represents a substituted or unsubstituted aryl group, and the substituted or unsubstituted aryl group is the same as the substituted or unsubstituted aryl groups represented by Ar^{a1} to Ar^{a4} in the formula (I-a).

When ck is 1, Ar^{c5} represents a substituted or unsubstituted arylene group, and the substituted or unsubstituted arylene group is the same as the substituted or unsubstituted arylene groups represented by Ar^{a5} and Ar^{a6} in the formula (I-a).

From the viewpoint of obtaining a protective layer (outermost surface layer) having a higher strength, the total number of Dc is preferably 2 or more, and more preferably 4 or more. Generally, if the number of the chain polymerizable groups in one molecule is too large, as the polymerization (crosslinking) reaction proceeds, it is difficult for the molecule to move, the chain polymerization reactivity is decreased, and the ratio of the chain polymerizable groups before the reaction is increased, and thus, the total number of Dc is preferably 7 or less, and more preferably 6 or less.

Next, the details of the formula (IA-c) will be described.

In the formula (IA-c), L^{c} represents a divalent linking group including one or more groups (hereinafter also referred to as “specific linking groups”) selected from the group consisting of —C(═O)—, —N(R)—, —S—, or a group formed by a combination of —C(═O)—, and —O—, —N(R)—, or —S—.

Here, from the viewpoint of a balance of the strength and the polarity (hydrophilicity/hydrophobicity) of the protective layer (outermost surface layer), the specific linking group is, for example, —C(═O)—, —N(R)—, —S—, —C(═O)—O—, —C(═O)—N(R)—, —C(═O)—S—, —O—C(═O)—O—, or —O—C(═O)—N(R)—, preferably —N(R)—, —S—, —C(═O)—O—, —C(═O)—N(H)—, or —C(═O)—O—, and more preferably —C(═O)—O—.

Furthermore, examples of the divalent linking group represented by L^{c} include divalent linking groups formed by the combination of the specific linking group with a residue of saturated hydrocarbon (including linear, branched, or cyclic ones) or aromatic hydrocarbon, and an oxygen atom, and in particular, divalent linking groups formed by the combination of the specific linking group, a residue of a linear saturated hydrocarbon, and an oxygen atom.

The total number of the carbon atoms included in the divalent linking group represented by L^{c} is, for example, from 1 to 20, and preferably from 2 to 10, from the viewpoint of the density of a styrene skeleton in the molecule and the chain polymerization reactivity.

In the formula (IA-c), specific examples of the divalent linking group represented by L° include:

*—(CH₂)_{cp}—C(═O)—O—(CH₂)_{cq}—,

*—(CH₂)ₒₚ—O—C(═O)—(CH₂)_{cr}—C(═O)—O—(CH₂)_{cq}—,

*—(CH₂)ₒₚ—C(═O)—N(R)—(CH₂)_{cq}—,

*—(CH₂)ₒₚ—C(═O)—S—(CH₂)_{cq}—,

*—(CH₂)_{cp}—N(R)—(CH₂)_{cq}—, and

*—(CH₂)_{cp}—S—(CH₂)_{cq}—.

Here, in the linking group represented by L^{c}, cp represents 0, or an integer of 1 to 6 (preferably 1 to 5). cq represents an integer of 1 to 6 (preferably 1 to 5). cr represents an integer of 1 to 6 (preferably 1 to 5).

Furthermore, in the linking group represented by L^{c}, “*” represents a site linked to a group represented by Ar^{c1} to Ar^{c5}.

Among these, in the formula (IA-c), the divalent linking group represented by L° is preferably *—(CH₂)_{cp}—C(═O)—O—CH₂—. That is, the group represented by the formula (IA-c) is preferably a group represented by the following formula (IA-c1), provided that in the formula (IA-c1), cp1 represents an integer of 0 to 4.

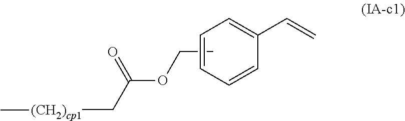

Reactive Compound Represented by Formula (I-d)

The reactive compound represented by the formula (I-d) will be described.

If the reactive compound represented by the formula (I-d) is applied as the specific reactive charge transporting material, the abrasion of the protective layer (outermost surface layer) is prevented, and further, the generation of the uneven concentrations of the image is easily prevented. The reason therefor is not clear, but is thought to be the same as for the reactive compound represented by the formula (I-b).

Particularly, it is thought that since the reactive compound represented by the formula (I-d) has a total number of Dd of 3 to 8, larger than that of the formula (I-b), in the crosslinked product thus formed, a more highly crosslinked structure (crosslinked network) is easily formed, and the abrasion of the protective layer (outermost surface layer) is more easily prevented.

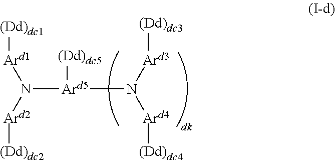

In the formula (I-d), Ar^{d1} to Ar^{d4} each independently represent a substituted or unsubstituted aryl group. Ar^{d5} represents a substituted or unsubstituted aryl group, or a substituted or unsubstituted arylene group. Dd represents a group represented by the following formula (IA-d). dc1 to dc5 each independently represent an integer of 0 to 2. dk represents 0 or 1, provided that the total number of Dd is from 3 to 8.

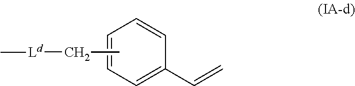

In the formula (IA-d), L^{d} includes a group represented by *—(CH₂)_{dn}—O—, and represents a divalent linking group linked to a group represented by Ar^{d1} to Ar^{d5} at *. do represents an integer of 1 to 6.

Hereinafter, the details of the formula (I-d) will be described.

In the formula (I-d), the substituted or unsubstituted aryl groups represented by Ar^{d1} to Ar^{d4} are the same as the substituted or unsubstituted aryl groups represented by Ar^{a1} to Ar^{a4} in the formula (I-a).

When dk is 0, Ar^{d5} represents a substituted or unsubstituted aryl group, and the substituted or unsubstituted aryl group is the same as the substituted or unsubstituted aryl groups represented by Ar^{a1} to Ar^{a4} in the formula (I-a).

When dk is 1, Ar^{d5} represents a substituted or unsubstituted arylene group, and the substituted or unsubstituted arylene group is the same as the substituted or unsubstituted arylene groups represented by Ar^{a5} and Ar^{a6} in the formula (I-a).

The total number of Dd is preferably 4 or more, from the viewpoint of obtaining a protective layer (outermost surface layer) having a higher strength.

Next, the details of the formula (IA-d) will be described.

In the formula (IA-d), examples of the divalent linking group represented by L^{d} include:

*—(CH₂)_{dp}—O—, and

*—(CH₂)_{dp}—O—(CH₂)_{dq}—O—.

Here, in the linking group represented by L^{d}, dp represents an integer of 1 to 6 (preferably 1 to 5). dq represents an integer of 1 to 6 (preferably 1 to 5).

Furthermore, in the linking group represented by L^{d}, “*” represents a site linked to a group represented by Ar^{d1} to Ar^{d5}.

Reactive Compound Represented by Formula (II-a)

The reactive compound represented by the formula (II-a) will be described.

When the reactive compound represented by the formula (II) (in particular, the formula (II-a)) is applied as the specific reactive charge transporting material, the deterioration of the electrical characteristics is easily prevented even when used repeatedly for a long period of time. The reason therefor is not clear, but is thought to be as follows.

First, the reactive compound represented by the formula (II) (in particular, the formula (II-a)) is a compound having 2 or 3 chain polymerizable reactive groups (styrene groups) via one linking group from the charge transporting skeleton.

As a result, it is thought that the reactive compound represented by the formula (II) (in particular, the formula (II-a)) hardly causes strain in the charge transporting skeleton when polymerized or crosslinked by the presence of the linking group while maintaining high curing degrees and number of crosslinked moieties, thus making it easy to obtain a high curing degree and excellent charge transporting performance.

Furthermore, the charge transporting compound having a (meth)acryl group, which has been used in the related art, easily causes strain as described above, the reactive site has high hydrophilicity, and the charge transporting site has high hydrophobicity, and as a result, a microscopic phase separation (microphase separation) easily occurs. However, it is thought that the reactive compound represented by the formula (II) (in particular, the formula (II-a)) has not only a styrene group as a reactive group, but also a structure having a linking group that hardly causes strain in the charge transporting skeleton when cured (crosslinked), the reactive site and the charge transporting site are both hydrophobic, whereby the phase separation hardly occurs, and as a result, efficient charge transporting performance and high strength are promoted. As a result, it is thought that the protective layer (outermost surface layer) including the polymer or crosslinked product of the reactive compound represented by the formula (II) (in particular, the formula (II-a)) has excellent mechanical strength as well as superior charge transporting performance (electrical characteristics).

From the description above, if the reactive compound represented by the formula (II) (in particular, the formula (II-a)) is applied, it is thought that the deterioration of the electrical characteristics even when used repeatedly for a long period of time is easily prevented.

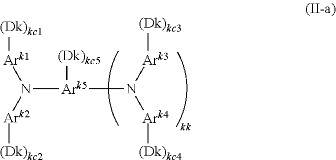

In the formula (II-a), Ar^{k1} to Ar^{k4} each independently represent a substituted or unsubstituted aryl group. Ar^{k5} represents a substituted or unsubstituted aryl group, or a substituted or unsubstituted arylene group. Dk represents a group represented by the following formula (IIA-a). kc1 to kc5 each independently represent an integer of 0 to 2. kk represents 0 or 1, provided that the total number of Dk is from 1 to 8.

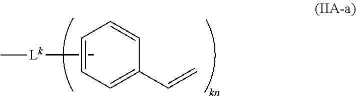

In the formula (IIA-a), L^{k} represents a (kn+1)-valent linking group including two or more selected from the group consisting of a trivalent or tetravalent group derived from an alkane or an alkene, and an alkylene group, an alkenylene group, —C(═O)—, —N(R)—, —S—, and —O—. R represents a hydrogen atom, an alkyl group, an aryl group, or an aralkyl group. kn represents an integer of 2 or 3.

Hereinafter, the details of the formula (II-a) will be described.

In the formula (II-a), the substituted or unsubstituted aryl groups represented by Ar^{k1} to Ar^{k4} are the same as the substituted or unsubstituted aryl groups represented by Ar^{a1} to Ar^{a4} in the formula (I-a).

When kk is 0, Ar^{k5} represents a substituted or unsubstituted aryl group, and the substituted or unsubstituted aryl group is the same as the substituted or unsubstituted aryl groups represented by Ar^{a1} to Ar^{a4} in the formula (I-a).

When kk is i, Ar^{k5} represents a substituted or unsubstituted arylene group, and the substituted or unsubstituted arylene group is the same as the substituted or unsubstituted arylene groups represented by Ar^{a5} and Ar^{a6} in the formula (I-a).

From the viewpoint of obtaining a protective layer (outermost surface layer) having a higher strength, the total number of Dk is preferably 2 or more, and more preferably 4 or more. Generally, if the number of the chain polymerizable groups in one molecule is too large, as the polymerization (crosslinking) reaction proceeds, it is difficult for the molecule to move, the chain polymerization reactivity is decreased, and the ratio of the chain polymerizable groups before the reaction is increased. For this reason, the total number of Dc is preferably 7 or less, and more preferably 6 or less.

Next, the details of the formula (IIA-a) will be described.

In the formula (IIA-a), the (kn+1)-valent linking group represented by L^{k} is the same as, for example, the (n+1)-valent linking group represented by L′ in the formula (II).

Next, the specific examples of the specific reactive charge transporting material are shown.

Specifically, specific examples of the charge transporting skeleton F (for example, a site corresponding to the skeleton excluding Da in the formula (I-a) or Dk in the formula (II-a)) of the formulae (I) and (II), and specific examples of the functional group linked to the charge transporting skeleton F (for example, the site corresponding to Da in the formula (I-a) or Dk in the formula (II-a)), as well as specific examples of the reactive compounds represented by the formulae (I) and (II) are shown below, but are not limited thereto.

Furthermore, the “*” moiety of the specific examples of the charge transporting skeleton F of the formulae (I) and (II) means that the “*” moiety of the functional group linked to the charge transporting skeleton F is linked.

That is, for example, the exemplary compound (I-b)-1 is shown as a specific example of the charge transporting skeleton F: (M1)-1 and a specific example of the functional group: (R2)-1, but the specific structures are shown as the following structures.

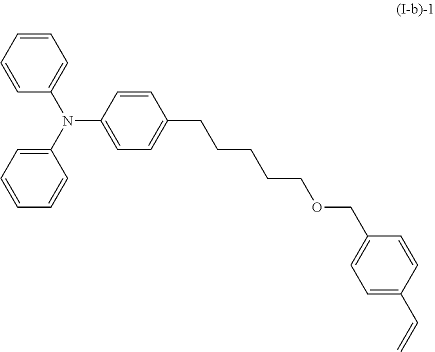 [SMILES: C=Cc1ccc(COCCCCCc2ccc(N(c3ccccc3)c3ccccc3)cc2)cc1]

First, specific examples of the charge transporting skeleton F are shown below.

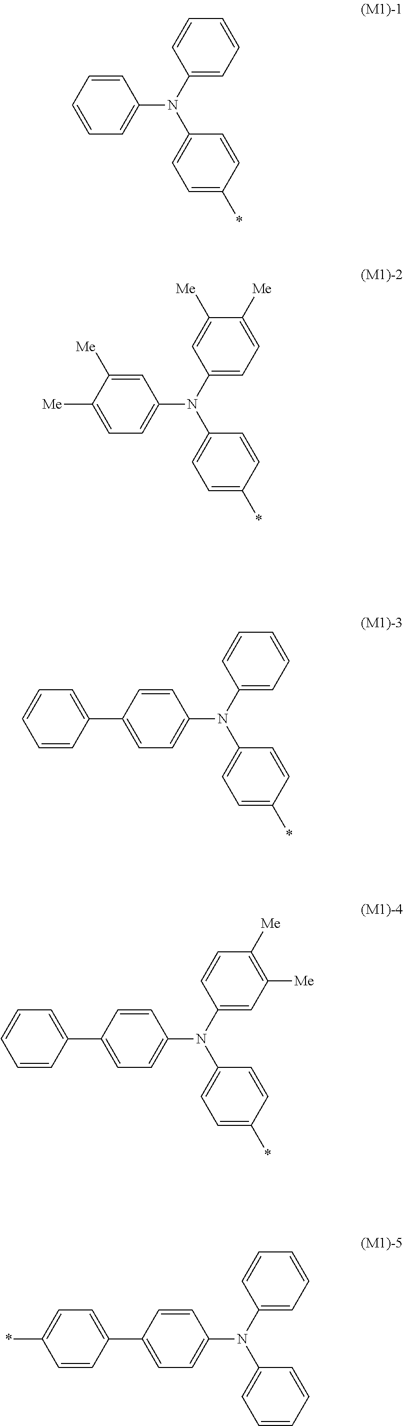 [SMILES: *c1ccc(N(c2ccccc2)c2ccccc2)cc1 ; *c1ccc(N(c2ccc(C)c(C)c2)c2ccc(C)c(C)c2)cc1 ; *c1ccc(N(c2ccccc2)c2ccc(-c3ccccc3)cc2)cc1 ; *c1ccc(N(c2ccc(-c3ccccc3)cc2)c2ccc(C)c(C)c2)cc1 ; *c1ccc(-c2ccc(N(c3ccccc3)c3ccccc3)cc2)cc1]

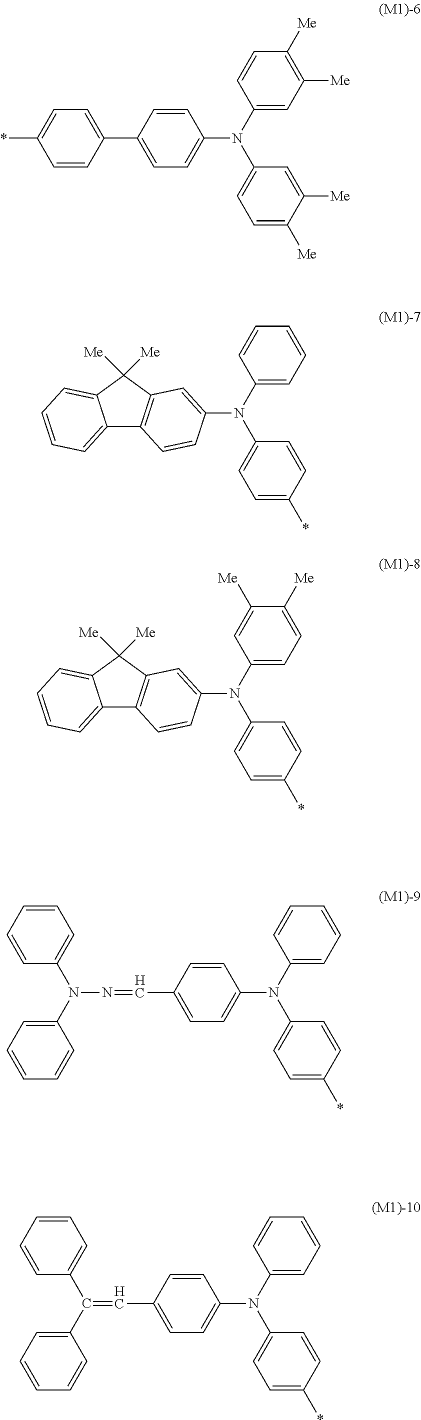 [SMILES: *c1ccc(-c2ccc(N(c3ccc(C)c(C)c3)c3ccc(C)c(C)c3)cc2)cc1 ; *c1ccc(N(c2ccccc2)c2ccc3c(c2)C(C)(C)c2ccccc2-3)cc1 ; *c1ccc(N(c2ccc(C)c(C)c2)c2ccc3c(c2)C(C)(C)c2ccccc2-3)cc1 ; *c1ccc(N(c2ccccc2)c2ccc(C=NN(c3ccccc3)c3ccccc3)cc2)cc1 ; *c1ccc(N(c2ccccc2)c2ccc(C=C(c3ccccc3)c3ccccc3)cc2)cc1]

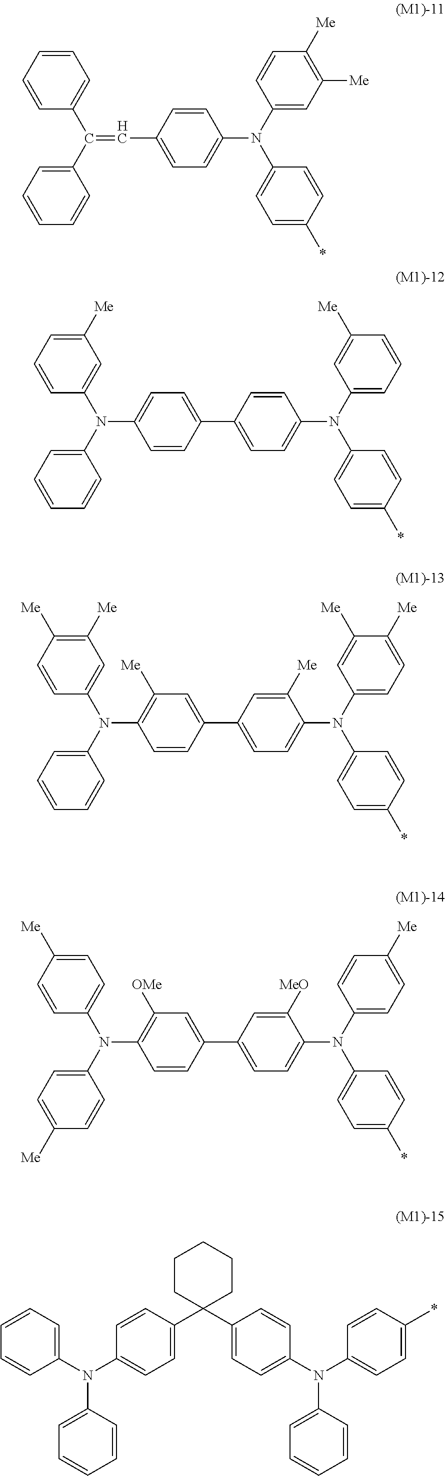 [SMILES: *c1ccc(N(c2ccc(C=C(c3ccccc3)c3ccccc3)cc2)c2ccc(C)c(C)c2)cc1 ; *c1ccc(N(c2ccc(-c3ccc(N(c4ccccc4)c4cccc(C)c4)cc3)cc2)c2cccc(C)c2)cc1 ; *c1ccc(N(c2ccc(C)c(C)c2)c2ccc(-c3ccc(N(c4ccccc4)c4ccc(C)c(C)c4)c(C)c3)cc2C)cc1 ; *c1ccc(N(c2ccc(C)cc2)c2ccc(-c3ccc(N(c4ccc(C)cc4)c4ccc(C)cc4)c(OC)c3)cc2OC)cc1 ; *c1ccc(N(c2ccccc2)c2ccc(C3(c4ccc(N(c5ccccc5)c5ccccc5)cc4)CCCCC3)cc2)cc1]

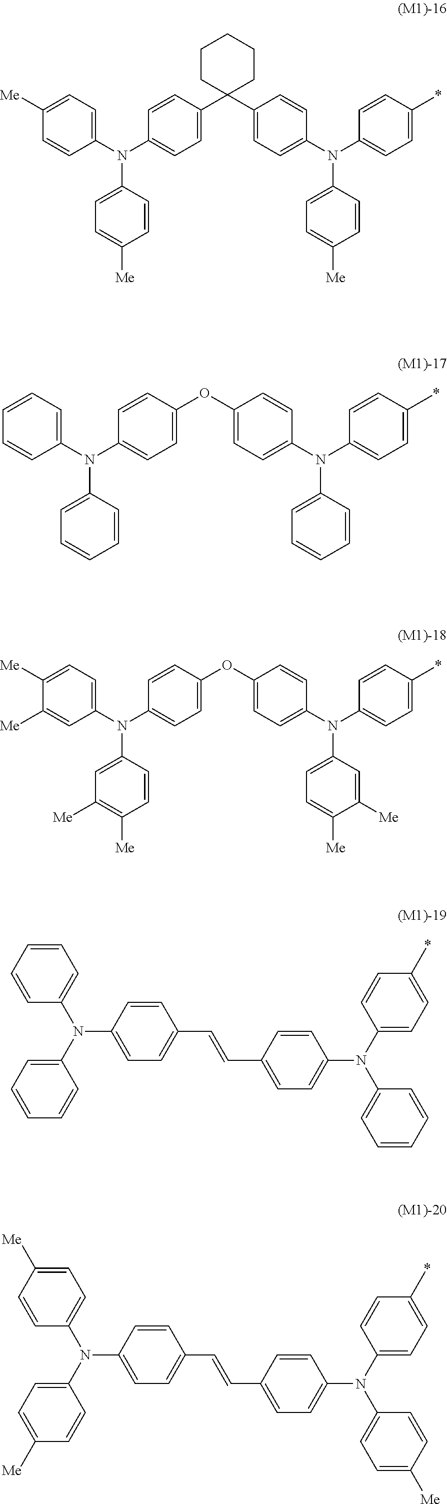 [SMILES: *c1ccc(N(c2ccc(C)cc2)c2ccc(C3(c4ccc(N(c5ccc(C)cc5)c5ccc(C)cc5)cc4)CCCCC3)cc2)cc1 ; *c1ccc(N(c2ccccc2)c2ccc(Oc3ccc(N(c4ccccc4)c4ccccc4)cc3)cc2)cc1 ; *c1ccc(N(c2ccc(Oc3ccc(N(c4ccc(C)c(C)c4)c4ccc(C)c(C)c4)cc3)cc2)c2ccc(C)c(C)c2)cc1 ; *c1ccc(N(c2ccccc2)c2ccc(/C=C/c3ccc(N(c4ccccc4)c4ccccc4)cc3)cc2)cc1 ; *c1ccc(N(c2ccc(C)cc2)c2ccc(/C=C/c3ccc(N(c4ccc(C)cc4)c4ccc(C)cc4)cc3)cc2)cc1]

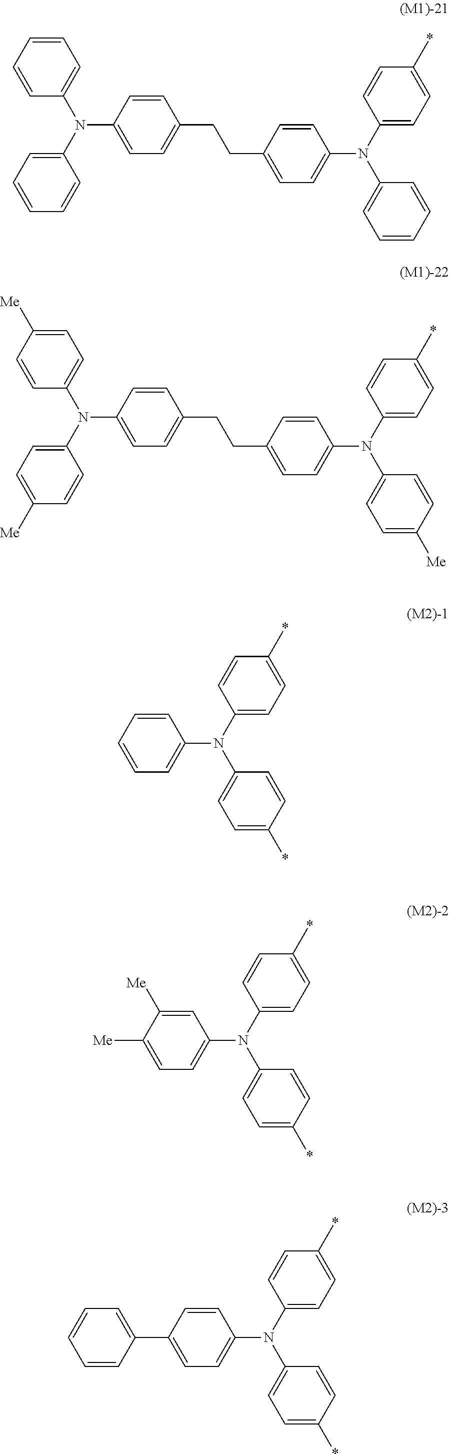 [SMILES: *c1ccc(N(c2ccccc2)c2ccc(CCc3ccc(N(c4ccccc4)c4ccccc4)cc3)cc2)cc1 ; *c1ccc(N(c2ccc(C)cc2)c2ccc(CCc3ccc(N(c4ccc(C)cc4)c4ccc(C)cc4)cc3)cc2)cc1 ; *c1ccc(N(c2ccccc2)c2ccc(*)cc2)cc1 ; *c1ccc(N(c2ccc(*)cc2)c2ccc(C)c(C)c2)cc1 ; *c1ccc(N(c2ccc(*)cc2)c2ccc(-c3ccccc3)cc2)cc1]

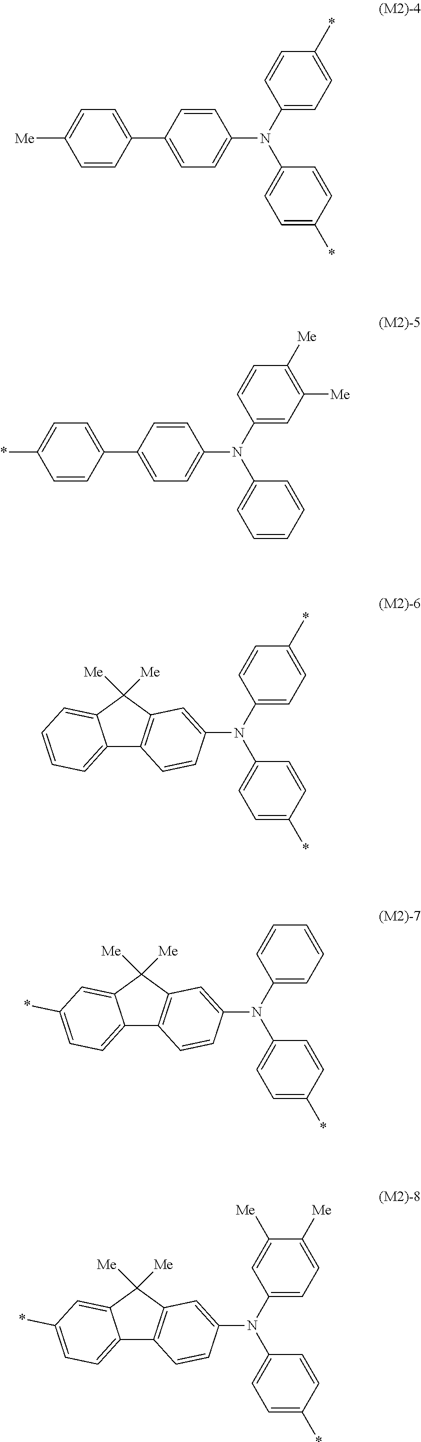 [SMILES: *c1ccc(N(c2ccc(*)cc2)c2ccc(-c3ccc(C)cc3)cc2)cc1 ; *c1ccc(-c2ccc(N(c3ccccc3)c3ccc(C)c(C)c3)cc2)cc1 ; *c1ccc(N(c2ccc(*)cc2)c2ccc3c(c2)C(C)(C)c2ccccc2-3)cc1 ; *c1ccc(N(c2ccccc2)c2ccc3c(c2)C(C)(C)c2cc(*)ccc2-3)cc1 ; *c1ccc(N(c2ccc(C)c(C)c2)c2ccc3c(c2)C(C)(C)c2cc(*)ccc2-3)cc1]

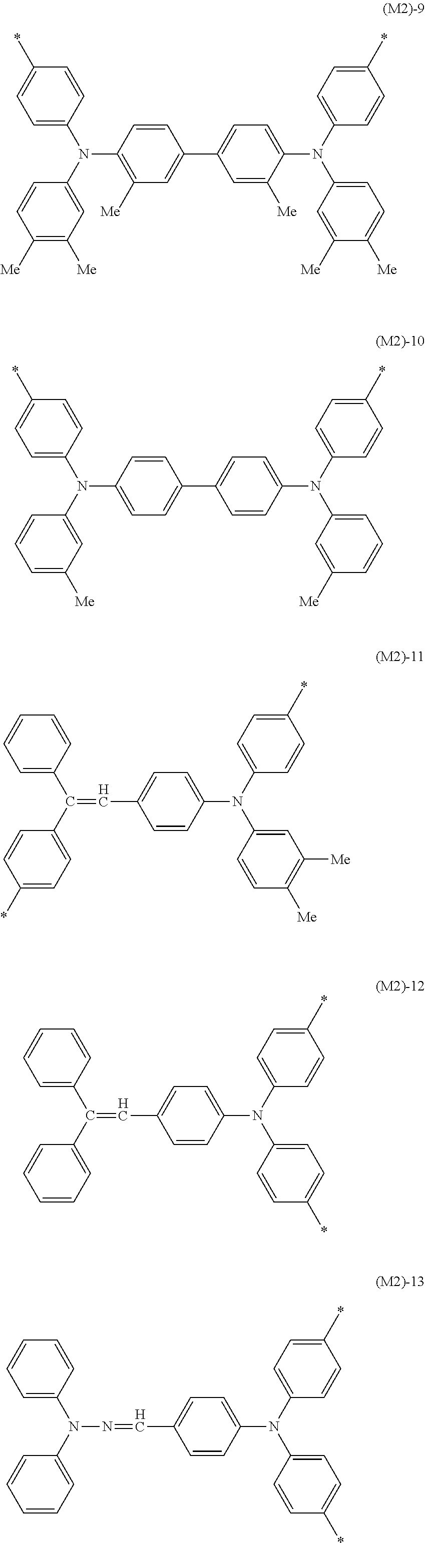 [SMILES: *c1ccc(N(c2ccc(C)c(C)c2)c2ccc(-c3ccc(N(c4ccc(*)cc4)c4ccc(C)c(C)c4)c(C)c3)cc2C)cc1 ; *c1ccc(N(c2ccc(-c3ccc(N(c4ccc(*)cc4)c4cccc(C)c4)cc3)cc2)c2cccc(C)c2)cc1 ; *c1ccc(C(=Cc2ccc(N(c3ccc(*)cc3)c3ccc(C)c(C)c3)cc2)c2ccccc2)cc1 ; *c1ccc(N(c2ccc(*)cc2)c2ccc(C=C(c3ccccc3)c3ccccc3)cc2)cc1 ; *c1ccc(N(c2ccc(*)cc2)c2ccc(C=NN(c3ccccc3)c3ccccc3)cc2)cc1]

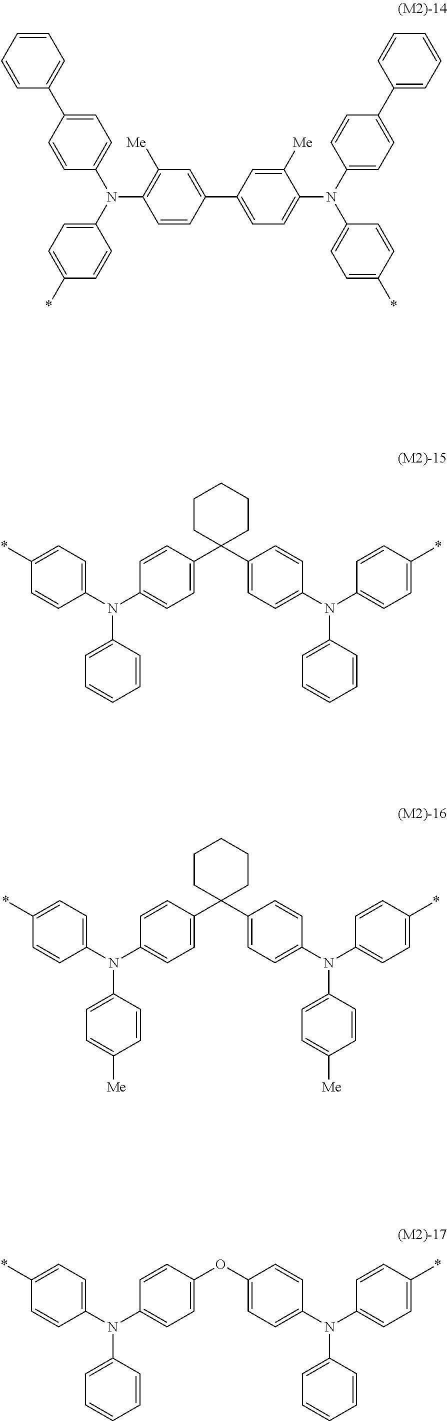 [SMILES: *c1ccc(N(c2ccc(-c3ccccc3)cc2)c2ccc(-c3ccc(N(c4ccc(*)cc4)c4ccc(-c5ccccc5)cc4)c(C)c3)cc2C)cc1 ; *c1ccc(N(c2ccccc2)c2ccc(C3(c4ccc(N(c5ccccc5)c5ccc(*)cc5)cc4)CCCCC3)cc2)cc1 ; *c1ccc(N(c2ccc(C)cc2)c2ccc(C3(c4ccc(N(c5ccc(*)cc5)c5ccc(C)cc5)cc4)CCCCC3)cc2)cc1 ; *c1ccc(N(c2ccccc2)c2ccc(Oc3ccc(N(c4ccccc4)c4ccc(*)cc4)cc3)cc2)cc1]

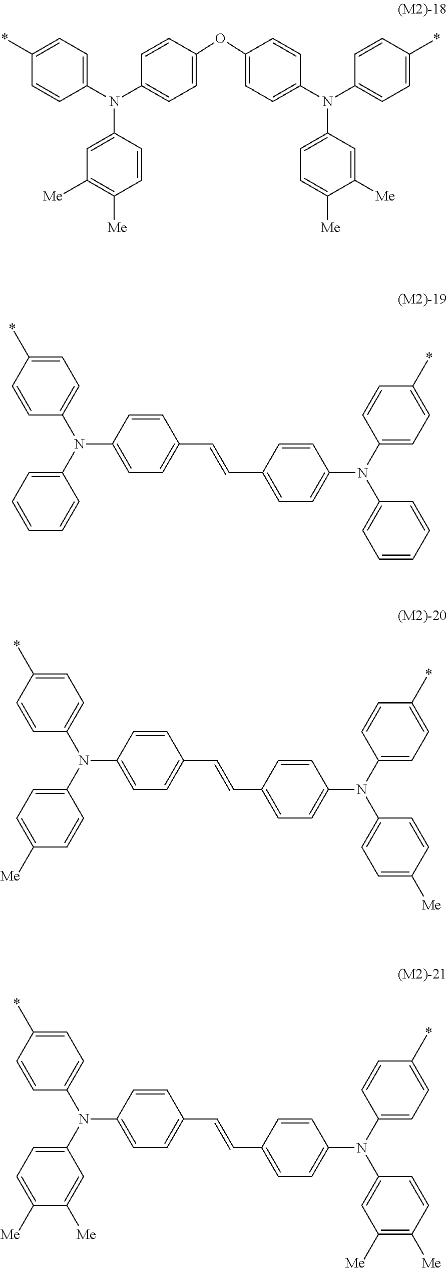 [SMILES: *c1ccc(N(c2ccc(Oc3ccc(N(c4ccc(*)cc4)c4ccc(C)c(C)c4)cc3)cc2)c2ccc(C)c(C)c2)cc1 ; *c1ccc(N(c2ccccc2)c2ccc(/C=C/c3ccc(N(c4ccccc4)c4ccc(*)cc4)cc3)cc2)cc1 ; *c1ccc(N(c2ccc(C)cc2)c2ccc(/C=C/c3ccc(N(c4ccc(*)cc4)c4ccc(C)cc4)cc3)cc2)cc1 ; *c1ccc(N(c2ccc(/C=C/c3ccc(N(c4ccc(*)cc4)c4ccc(C)c(C)c4)cc3)cc2)c2ccc(C)c(C)c2)cc1]

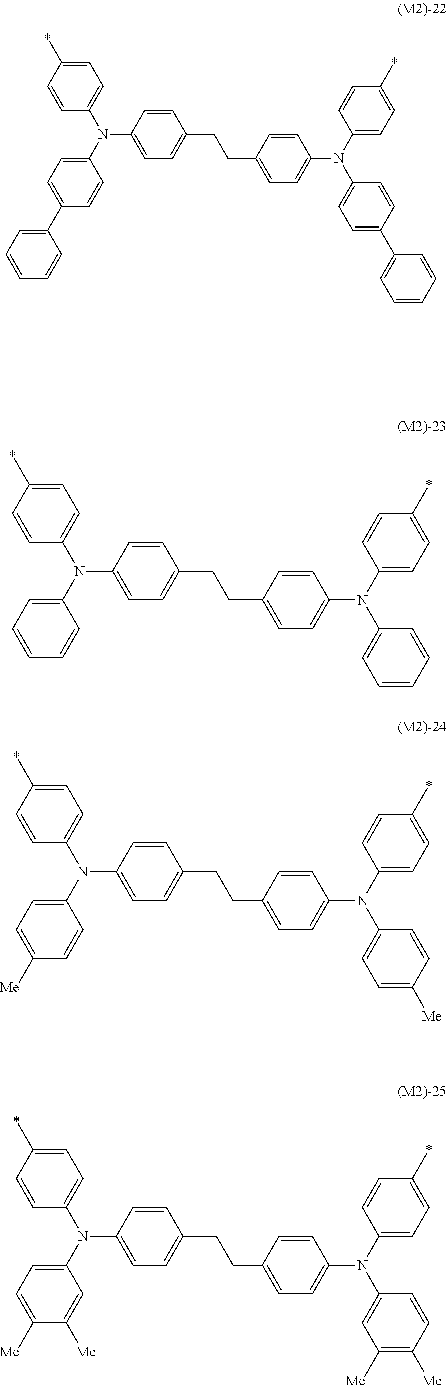 [SMILES: *c1ccc(N(c2ccc(CCc3ccc(N(c4ccc(*)cc4)c4ccc(-c5ccccc5)cc4)cc3)cc2)c2ccc(-c3ccccc3)cc2)cc1 ; *c1ccc(N(c2ccccc2)c2ccc(CCc3ccc(N(c4ccccc4)c4ccc(*)cc4)cc3)cc2)cc1 ; *c1ccc(N(c2ccc(C)cc2)c2ccc(CCc3ccc(N(c4ccc(*)cc4)c4ccc(C)cc4)cc3)cc2)cc1 ; *c1ccc(N(c2ccc(CCc3ccc(N(c4ccc(*)cc4)c4ccc(C)c(C)c4)cc3)cc2)c2ccc(C)c(C)c2)cc1]

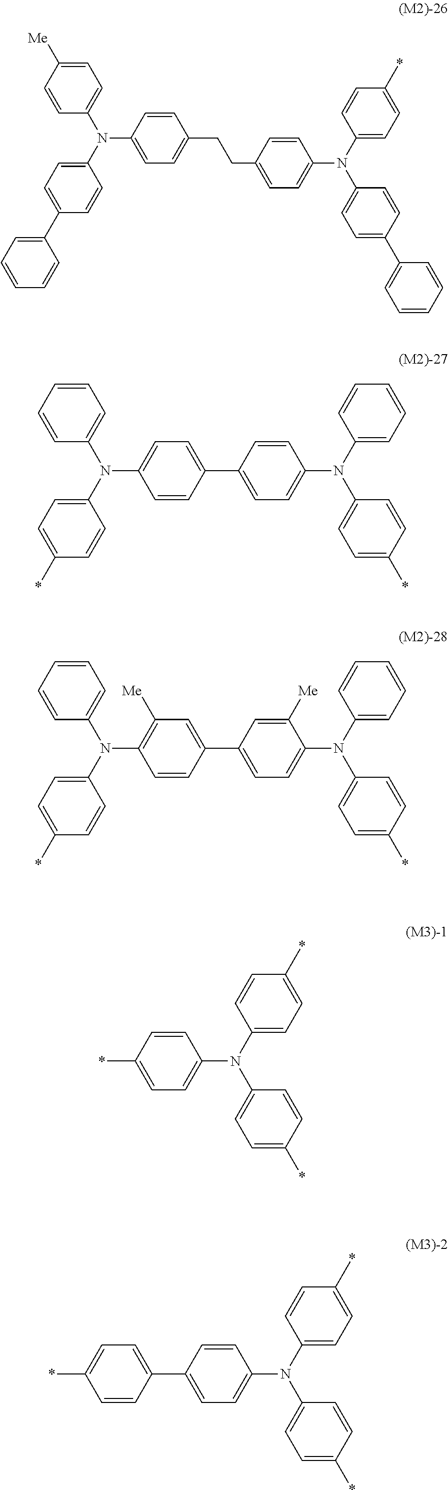 [SMILES: *c1ccc(N(c2ccc(CCc3ccc(N(c4ccc(C)cc4)c4ccc(-c5ccccc5)cc4)cc3)cc2)c2ccc(-c3ccccc3)cc2)cc1 ; *c1ccc(N(c2ccccc2)c2ccc(-c3ccc(N(c4ccccc4)c4ccc(*)cc4)cc3)cc2)cc1 ; *c1ccc(N(c2ccccc2)c2ccc(-c3ccc(N(c4ccccc4)c4ccc(*)cc4)c(C)c3)cc2C)cc1 ; *c1ccc(N(c2ccc(*)cc2)c2ccc(*)cc2)cc1 ; *c1ccc(-c2ccc(N(c3ccc(*)cc3)c3ccc(*)cc3)cc2)cc1]

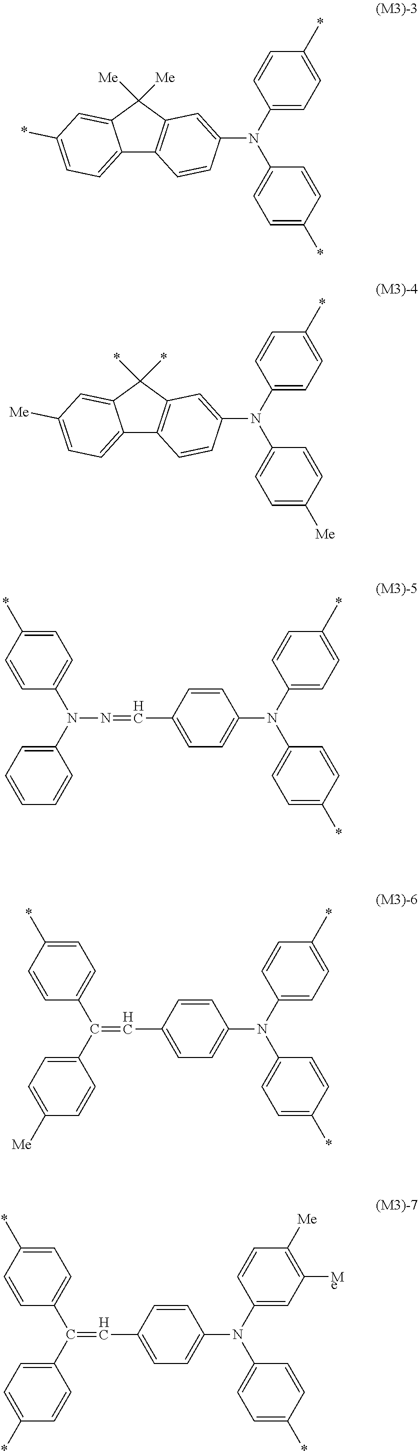 [SMILES: *c1ccc(N(c2ccc(*)cc2)c2ccc3c(c2)C(C)(C)c2cc(*)ccc2-3)cc1 ; *c1ccc(N(c2ccc(C)cc2)c2ccc3c(c2)C(*)(*)c2cc(C)ccc2-3)cc1 ; *c1ccc(N(N=Cc2ccc(N(c3ccc(*)cc3)c3ccc(*)cc3)cc2)c2ccccc2)cc1 ; *c1ccc(C(=Cc2ccc(N(c3ccc(*)cc3)c3ccc(*)cc3)cc2)c2ccc(C)cc2)cc1 ; *c1ccc(C(=Cc2ccc(N(c3ccc(*)cc3)c3ccc(C)c(C)c3)cc2)c2ccc(*)cc2)cc1]

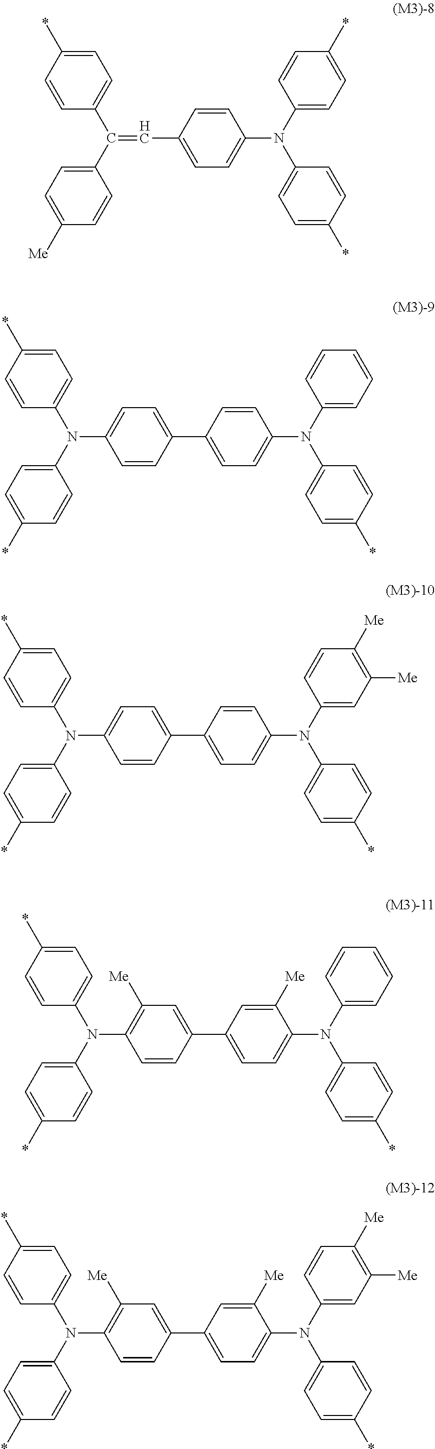 [SMILES: *c1ccc(C(=Cc2ccc(N(c3ccc(*)cc3)c3ccc(*)cc3)cc2)c2ccc(C)cc2)cc1 ; *c1ccc(N(c2ccccc2)c2ccc(-c3ccc(N(c4ccc(*)cc4)c4ccc(*)cc4)cc3)cc2)cc1 ; *c1ccc(N(c2ccc(*)cc2)c2ccc(-c3ccc(N(c4ccc(*)cc4)c4ccc(C)c(C)c4)cc3)cc2)cc1 ; *c1ccc(N(c2ccccc2)c2ccc(-c3ccc(N(c4ccc(*)cc4)c4ccc(*)cc4)c(C)c3)cc2C)cc1 ; *c1ccc(N(c2ccc(*)cc2)c2ccc(-c3ccc(N(c4ccc(*)cc4)c4ccc(C)c(C)c4)c(C)c3)cc2C)cc1]

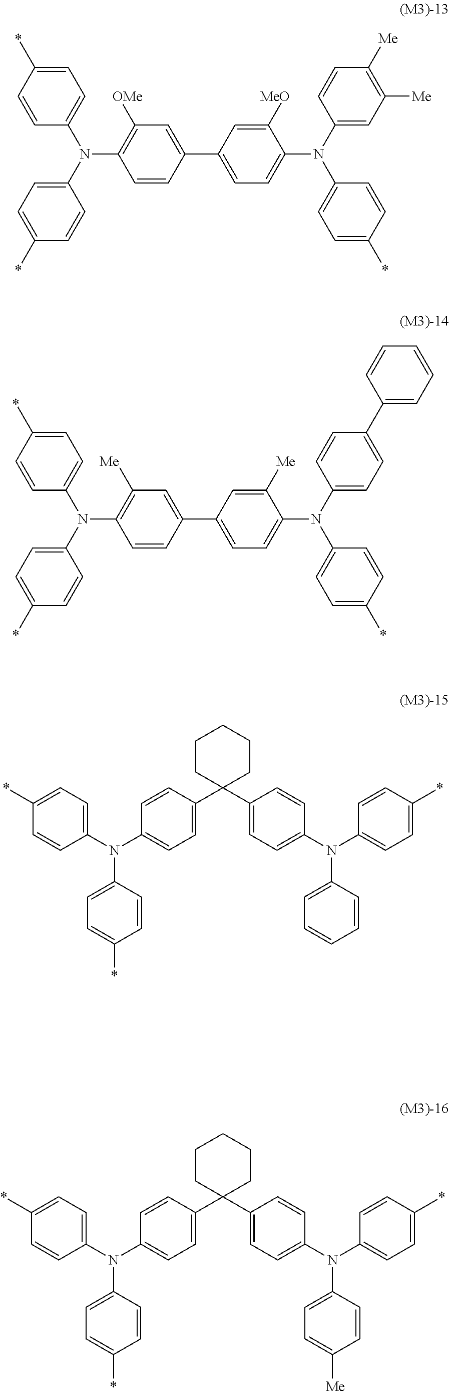 [SMILES: *c1ccc(N(c2ccc(*)cc2)c2ccc(-c3ccc(N(c4ccc(*)cc4)c4ccc(C)c(C)c4)c(OC)c3)cc2OC)cc1 ; *c1ccc(N(c2ccc(*)cc2)c2ccc(-c3ccc(N(c4ccc(*)cc4)c4ccc(-c5ccccc5)cc4)c(C)c3)cc2C)cc1 ; *c1ccc(N(c2ccccc2)c2ccc(C3(c4ccc(N(c5ccc(*)cc5)c5ccc(*)cc5)cc4)CCCCC3)cc2)cc1 ; *c1ccc(N(c2ccc(*)cc2)c2ccc(C3(c4ccc(N(c5ccc(*)cc5)c5ccc(C)cc5)cc4)CCCCC3)cc2)cc1]

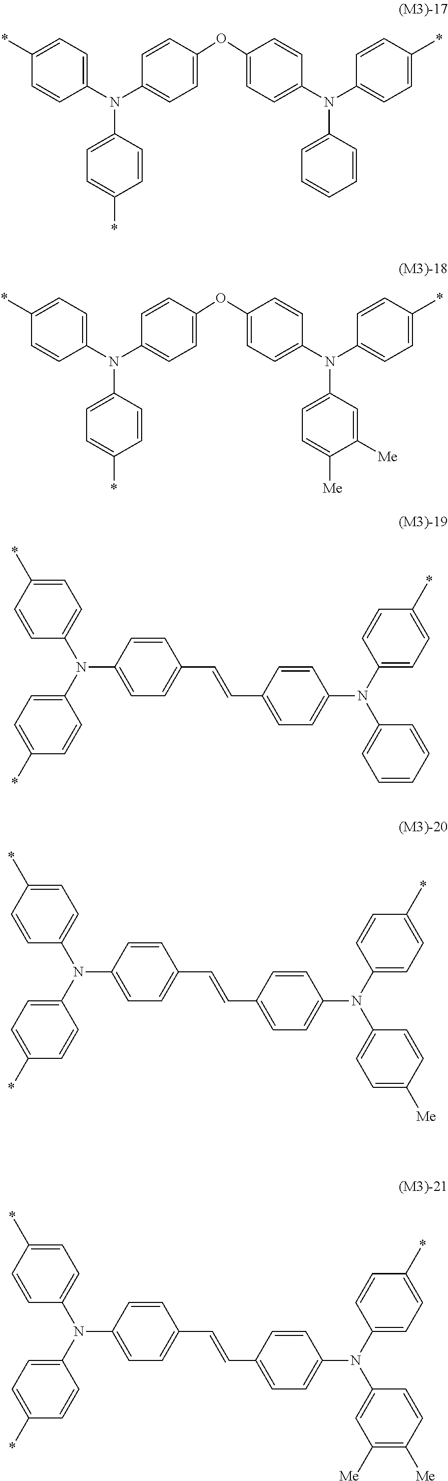 [SMILES: *c1ccc(N(c2ccccc2)c2ccc(Oc3ccc(N(c4ccc(*)cc4)c4ccc(*)cc4)cc3)cc2)cc1 ; *c1ccc(N(c2ccc(*)cc2)c2ccc(Oc3ccc(N(c4ccc(*)cc4)c4ccc(C)c(C)c4)cc3)cc2)cc1 ; *c1ccc(N(c2ccccc2)c2ccc(/C=C/c3ccc(N(c4ccc(*)cc4)c4ccc(*)cc4)cc3)cc2)cc1 ; *c1ccc(N(c2ccc(*)cc2)c2ccc(/C=C/c3ccc(N(c4ccc(*)cc4)c4ccc(C)cc4)cc3)cc2)cc1 ; *c1ccc(N(c2ccc(*)cc2)c2ccc(/C=C/c3ccc(N(c4ccc(*)cc4)c4ccc(C)c(C)c4)cc3)cc2)cc1]

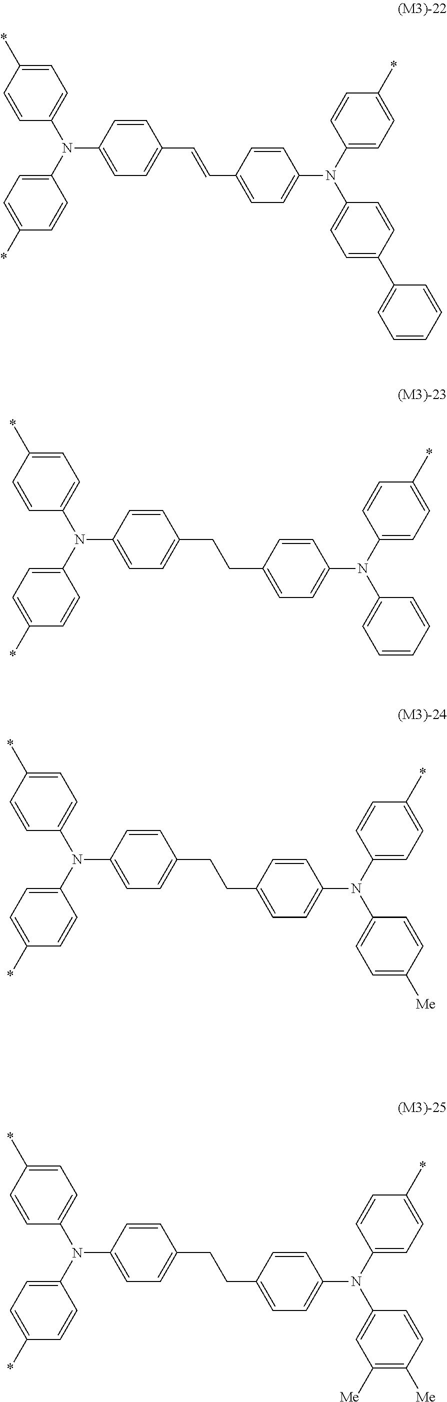 [SMILES: *c1ccc(N(c2ccc(*)cc2)c2ccc(/C=C/c3ccc(N(c4ccc(*)cc4)c4ccc(-c5ccccc5)cc4)cc3)cc2)cc1 ; *c1ccc(N(c2ccccc2)c2ccc(CCc3ccc(N(c4ccc(*)cc4)c4ccc(*)cc4)cc3)cc2)cc1 ; *c1ccc(N(c2ccc(*)cc2)c2ccc(CCc3ccc(N(c4ccc(*)cc4)c4ccc(C)cc4)cc3)cc2)cc1 ; *c1ccc(N(c2ccc(*)cc2)c2ccc(CCc3ccc(N(c4ccc(*)cc4)c4ccc(C)c(C)c4)cc3)cc2)cc1]

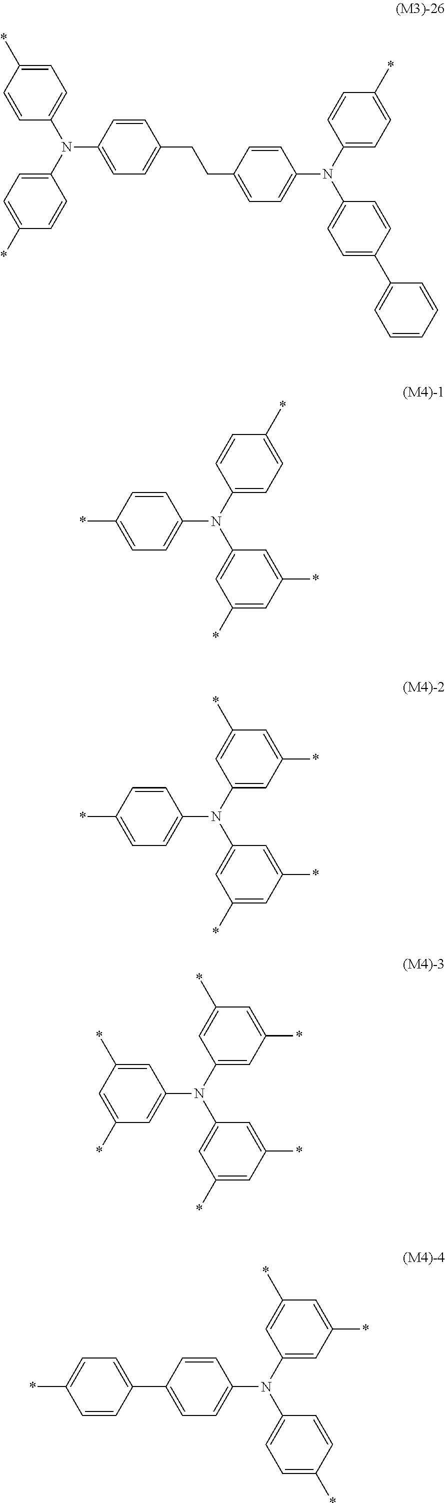 [SMILES: *c1ccc(N(c2ccc(*)cc2)c2ccc(CCc3ccc(N(c4ccc(*)cc4)c4ccc(-c5ccccc5)cc4)cc3)cc2)cc1 ; *c1ccc(N(c2ccc(*)cc2)c2cc(*)cc(*)c2)cc1 ; *c1ccc(N(c2cc(*)cc(*)c2)c2cc(*)cc(*)c2)cc1 ; *c1cc(*)cc(N(c2cc(*)cc(*)c2)c2cc(*)cc(*)c2)c1 ; *c1ccc(-c2ccc(N(c3ccc(*)cc3)c3cc(*)cc(*)c3)cc2)cc1]

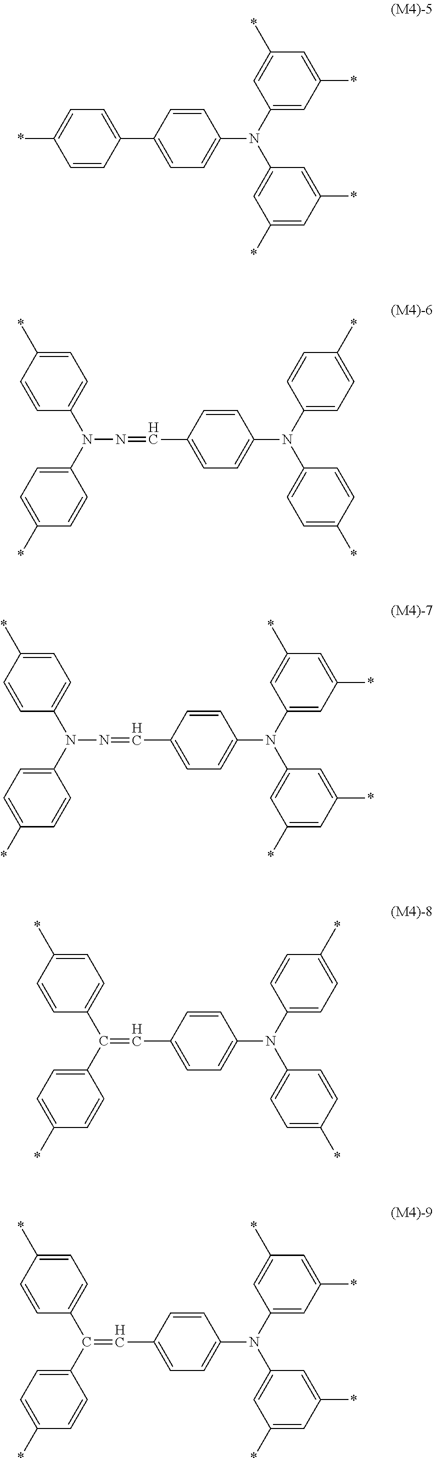 [SMILES: *c1ccc(-c2ccc(N(c3cc(*)cc(*)c3)c3cc(*)cc(*)c3)cc2)cc1 ; *c1ccc(N(N=Cc2ccc(N(c3ccc(*)cc3)c3ccc(*)cc3)cc2)c2ccc(*)cc2)cc1 ; *c1ccc(N(N=Cc2ccc(N(c3cc(*)cc(*)c3)c3cc(*)cc(*)c3)cc2)c2ccc(*)cc2)cc1 ; *c1ccc(C(=Cc2ccc(N(c3ccc(*)cc3)c3ccc(*)cc3)cc2)c2ccc(*)cc2)cc1 ; *c1ccc(C(=Cc2ccc(N(c3cc(*)cc(*)c3)c3cc(*)cc(*)c3)cc2)c2ccc(*)cc2)cc1]

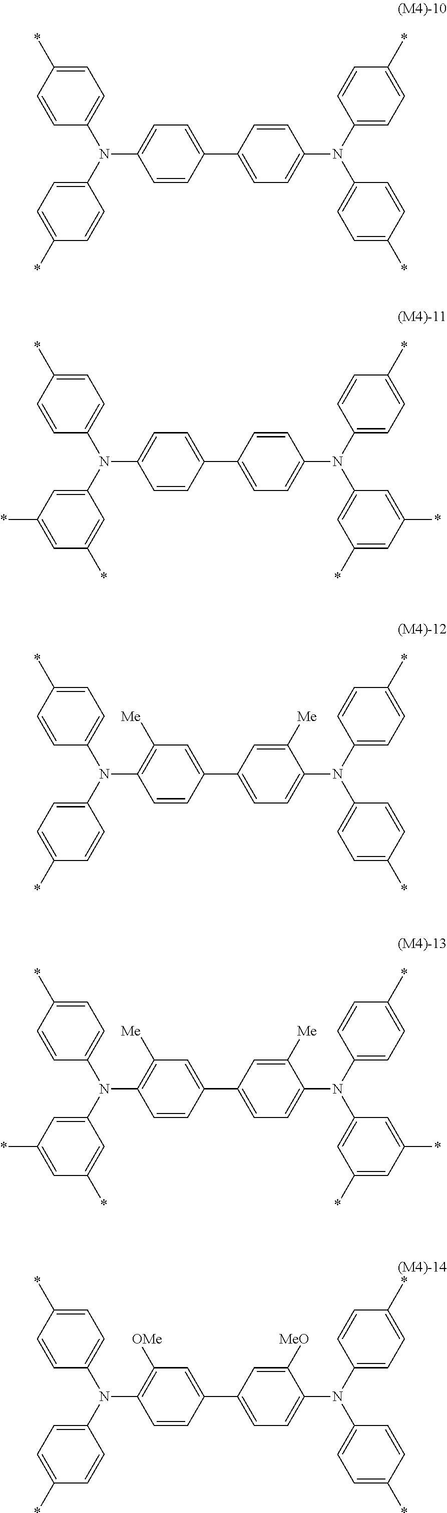 [SMILES: *c1ccc(N(c2ccc(*)cc2)c2ccc(-c3ccc(N(c4ccc(*)cc4)c4ccc(*)cc4)cc3)cc2)cc1 ; *c1ccc(N(c2ccc(-c3ccc(N(c4ccc(*)cc4)c4cc(*)cc(*)c4)cc3)cc2)c2cc(*)cc(*)c2)cc1 ; *c1ccc(N(c2ccc(*)cc2)c2ccc(-c3ccc(N(c4ccc(*)cc4)c4ccc(*)cc4)c(C)c3)cc2C)cc1 ; *c1ccc(N(c2cc(*)cc(*)c2)c2ccc(-c3ccc(N(c4ccc(*)cc4)c4cc(*)cc(*)c4)c(C)c3)cc2C)cc1 ; *c1ccc(N(c2ccc(*)cc2)c2ccc(-c3ccc(N(c4ccc(*)cc4)c4ccc(*)cc4)c(OC)c3)cc2OC)cc1]

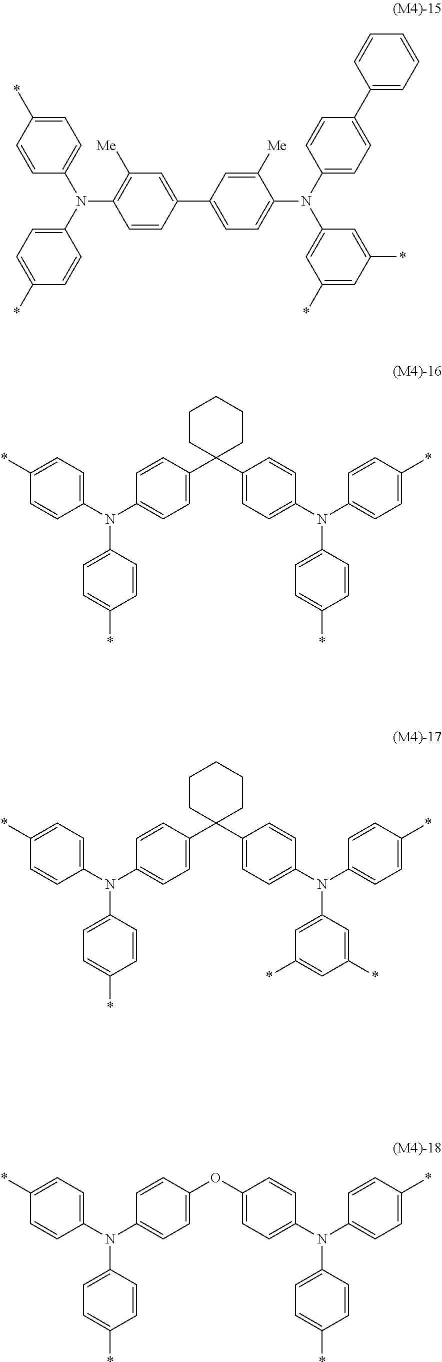 [SMILES: *c1ccc(N(c2ccc(*)cc2)c2ccc(-c3ccc(N(c4ccc(-c5ccccc5)cc4)c4cc(*)cc(*)c4)c(C)c3)cc2C)cc1 ; *c1ccc(N(c2ccc(*)cc2)c2ccc(C3(c4ccc(N(c5ccc(*)cc5)c5ccc(*)cc5)cc4)CCCCC3)cc2)cc1 ; *c1ccc(N(c2ccc(*)cc2)c2ccc(C3(c4ccc(N(c5ccc(*)cc5)c5cc(*)cc(*)c5)cc4)CCCCC3)cc2)cc1 ; *c1ccc(N(c2ccc(*)cc2)c2ccc(Oc3ccc(N(c4ccc(*)cc4)c4ccc(*)cc4)cc3)cc2)cc1]

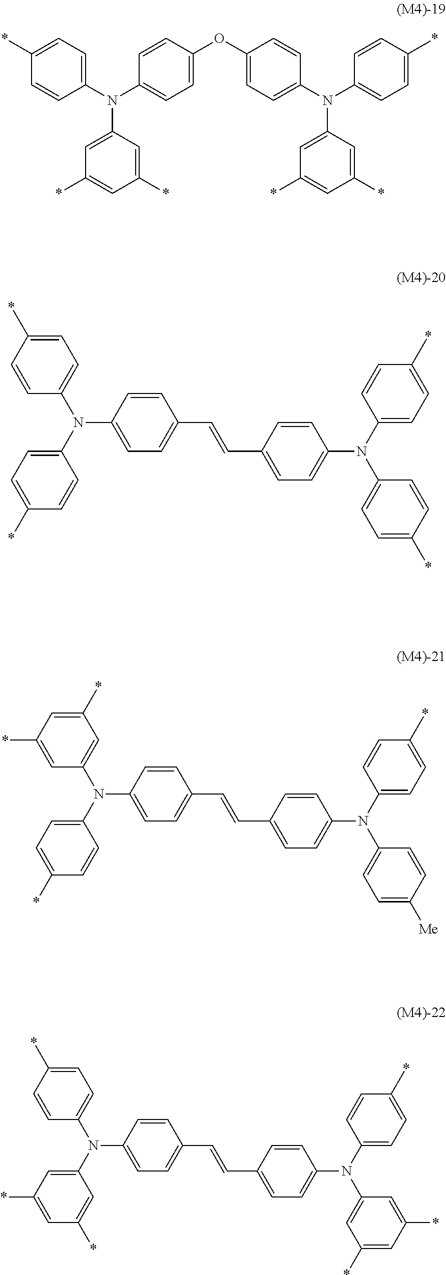 [SMILES: *c1ccc(N(c2ccc(Oc3ccc(N(c4ccc(*)cc4)c4cc(*)cc(*)c4)cc3)cc2)c2cc(*)cc(*)c2)cc1 ; *c1ccc(N(c2ccc(*)cc2)c2ccc(/C=C/c3ccc(N(c4ccc(*)cc4)c4ccc(*)cc4)cc3)cc2)cc1 ; *c1ccc(N(c2ccc(C)cc2)c2ccc(/C=C/c3ccc(N(c4ccc(*)cc4)c4cc(*)cc(*)c4)cc3)cc2)cc1 ; *c1ccc(N(c2ccc(/C=C/c3ccc(N(c4ccc(*)cc4)c4cc(*)cc(*)c4)cc3)cc2)c2cc(*)cc(*)c2)cc1]

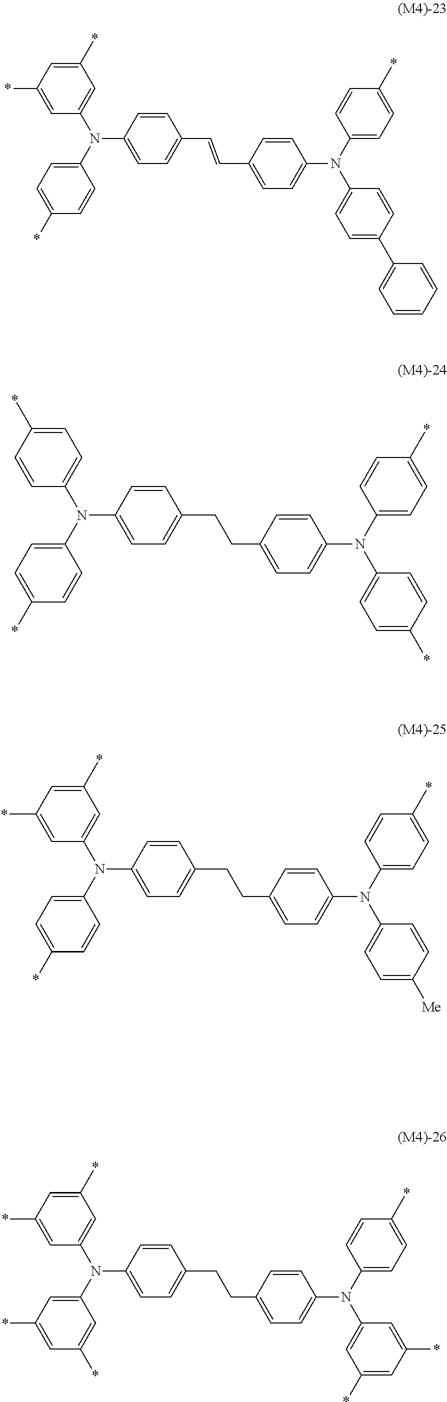 [SMILES: *c1ccc(N(c2ccc(/C=C/c3ccc(N(c4ccc(*)cc4)c4cc(*)cc(*)c4)cc3)cc2)c2ccc(-c3ccccc3)cc2)cc1 ; *c1ccc(N(c2ccc(*)cc2)c2ccc(CCc3ccc(N(c4ccc(*)cc4)c4ccc(*)cc4)cc3)cc2)cc1 ; *c1ccc(N(c2ccc(C)cc2)c2ccc(CCc3ccc(N(c4ccc(*)cc4)c4cc(*)cc(*)c4)cc3)cc2)cc1 ; *c1ccc(N(c2ccc(CCc3ccc(N(c4cc(*)cc(*)c4)c4cc(*)cc(*)c4)cc3)cc2)c2cc(*)cc(*)c2)cc1]

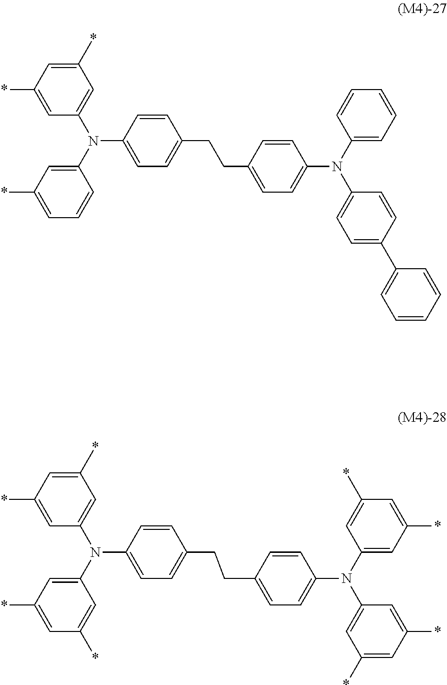 [SMILES: *c1cccc(N(c2ccc(CCc3ccc(N(c4ccccc4)c4ccc(-c5ccccc5)cc4)cc3)cc2)c2cc(*)cc(*)c2)c1 ; *c1cc(*)cc(N(c2ccc(CCc3ccc(N(c4cc(*)cc(*)c4)c4cc(*)cc(*)c4)cc3)cc2)c2cc(*)cc(*)c2)c1]

Next, specific examples of the functional group bonded to the charge transporting skeleton F are shown.

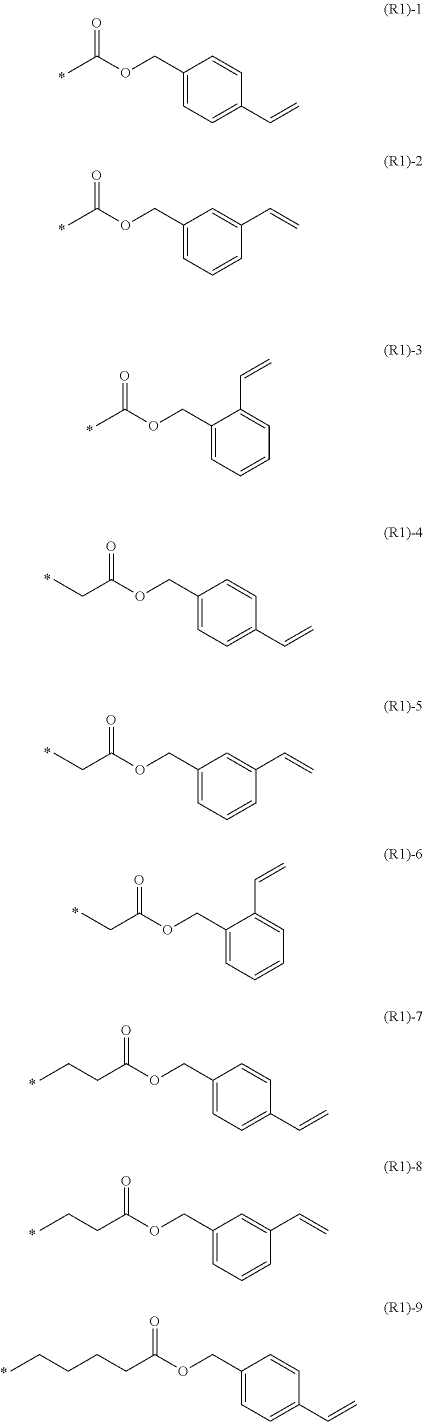

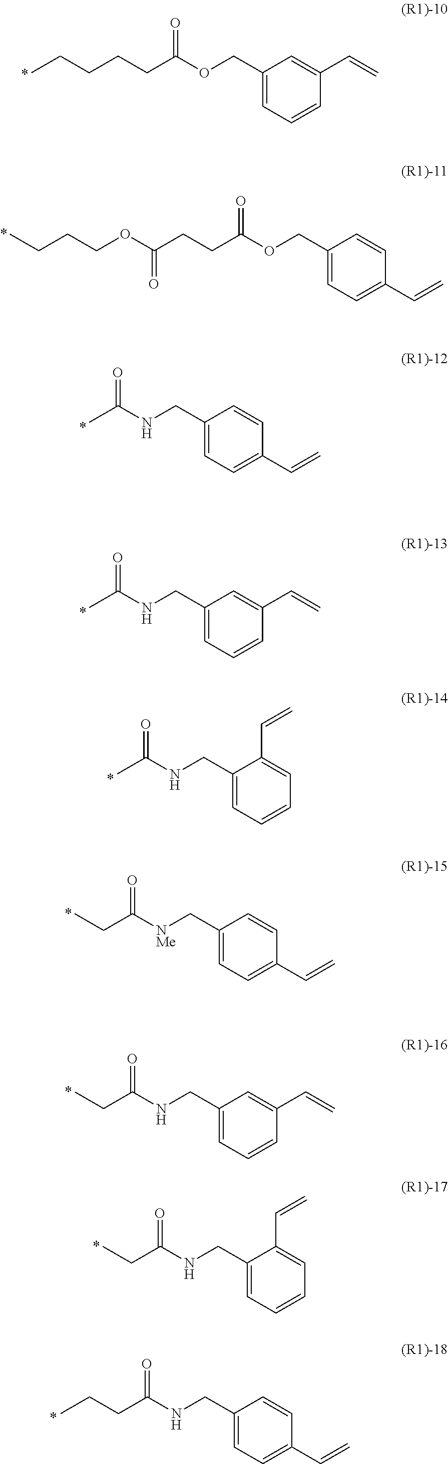

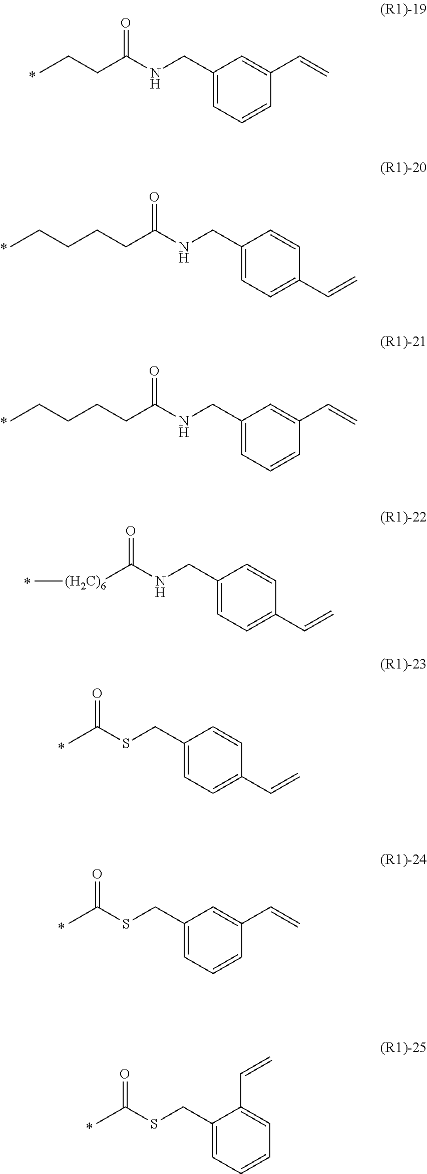

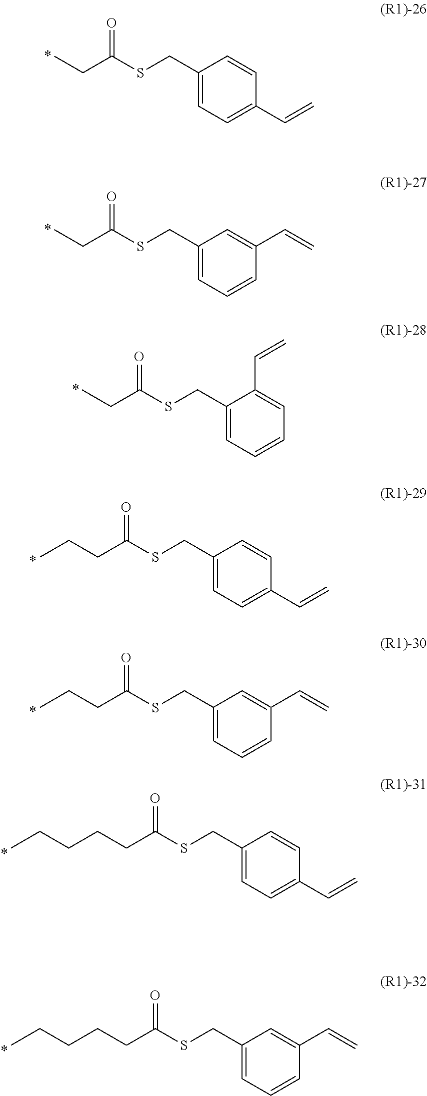

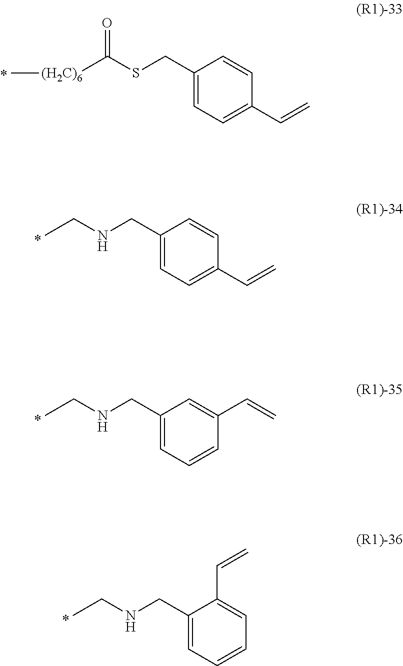

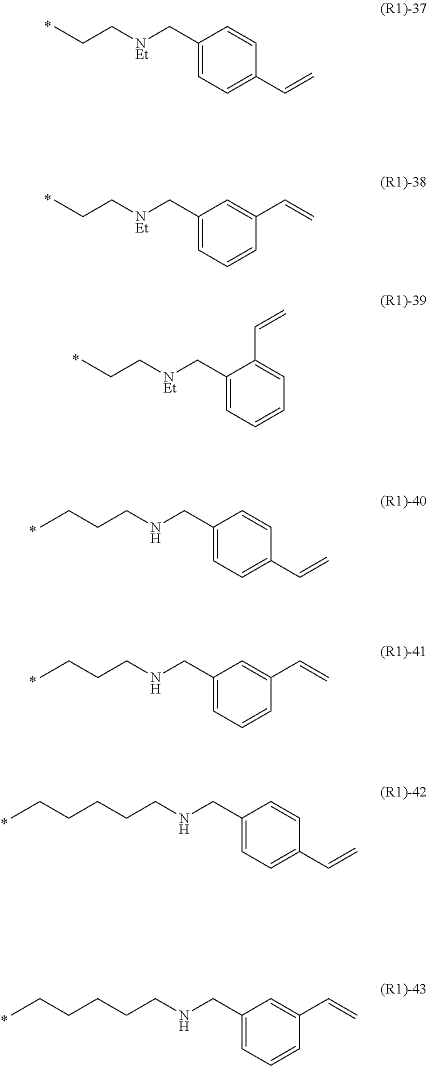

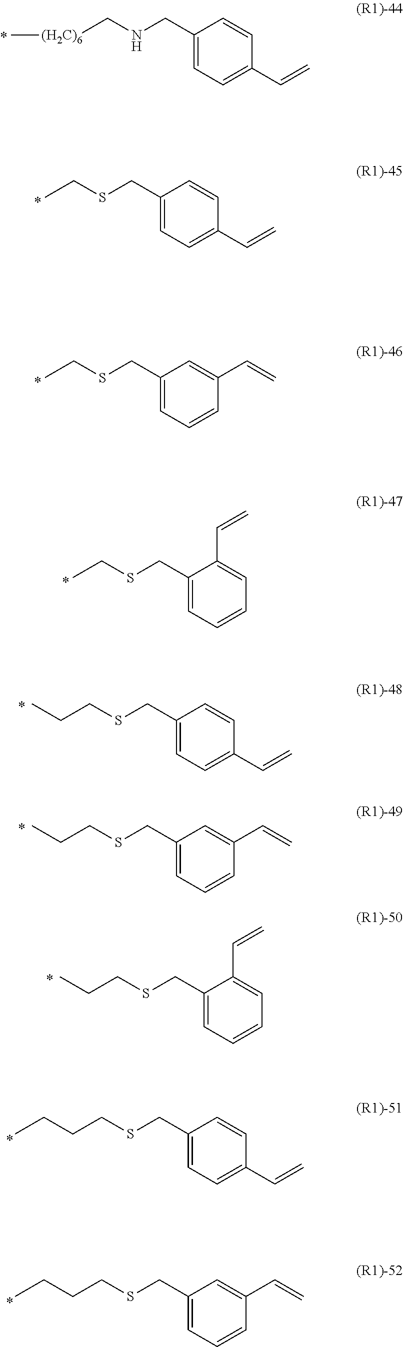

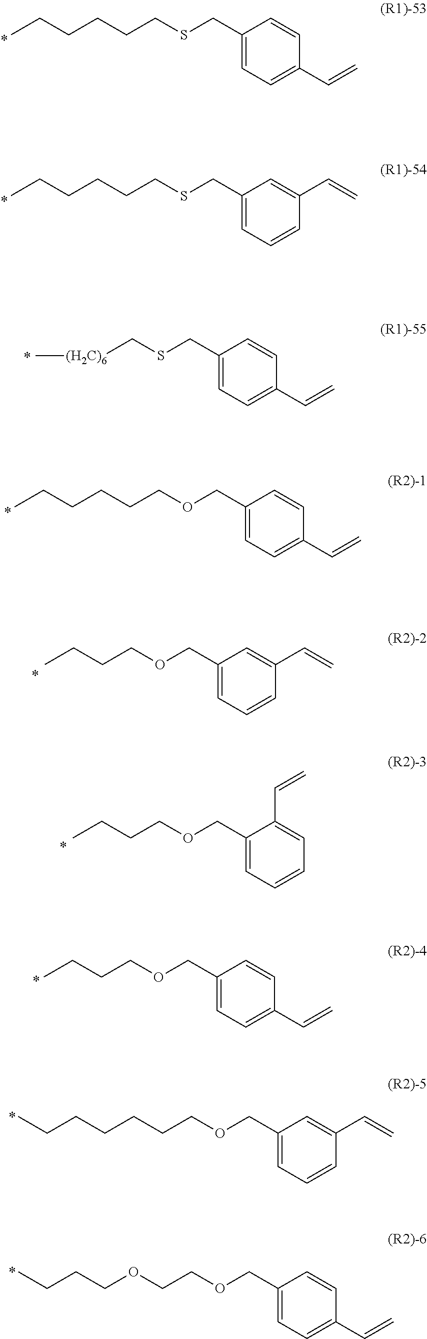

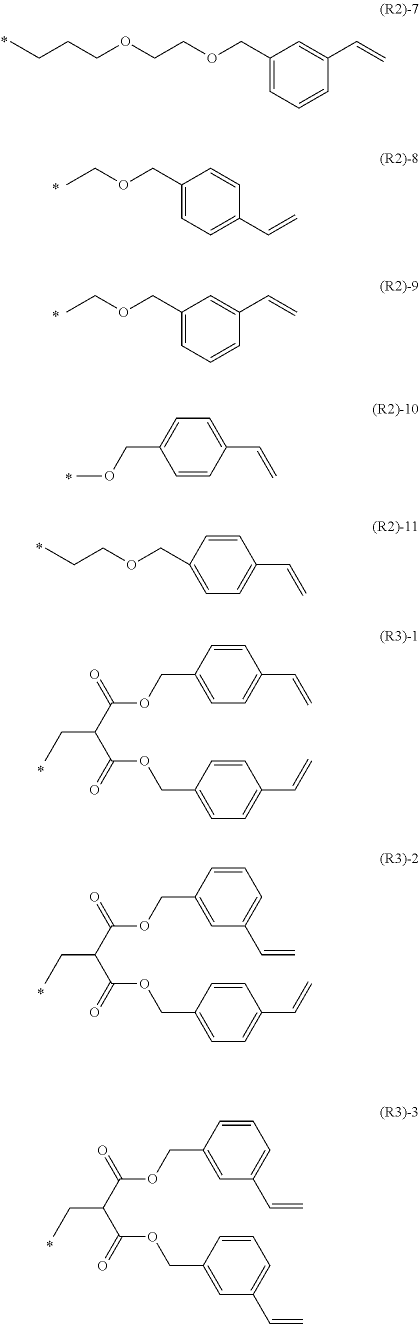

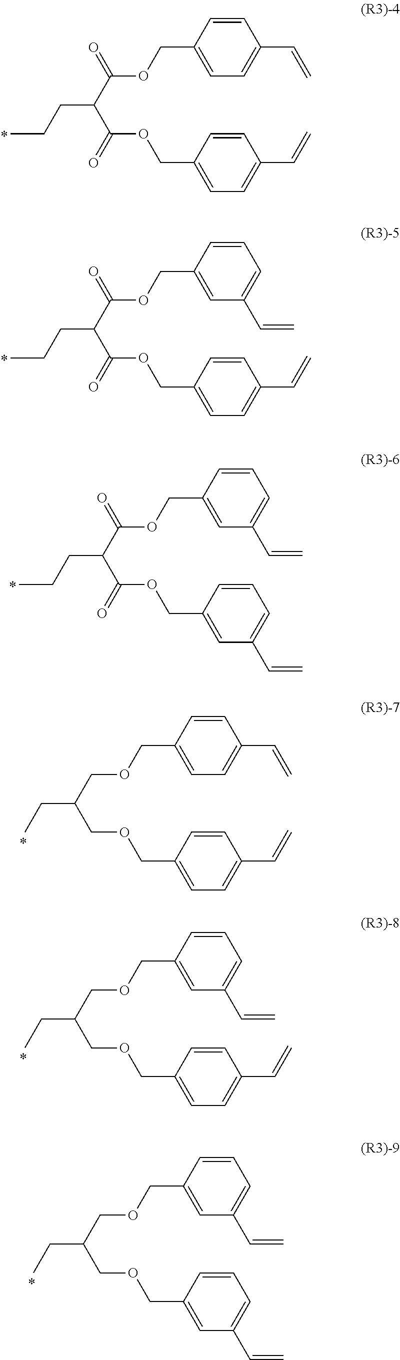

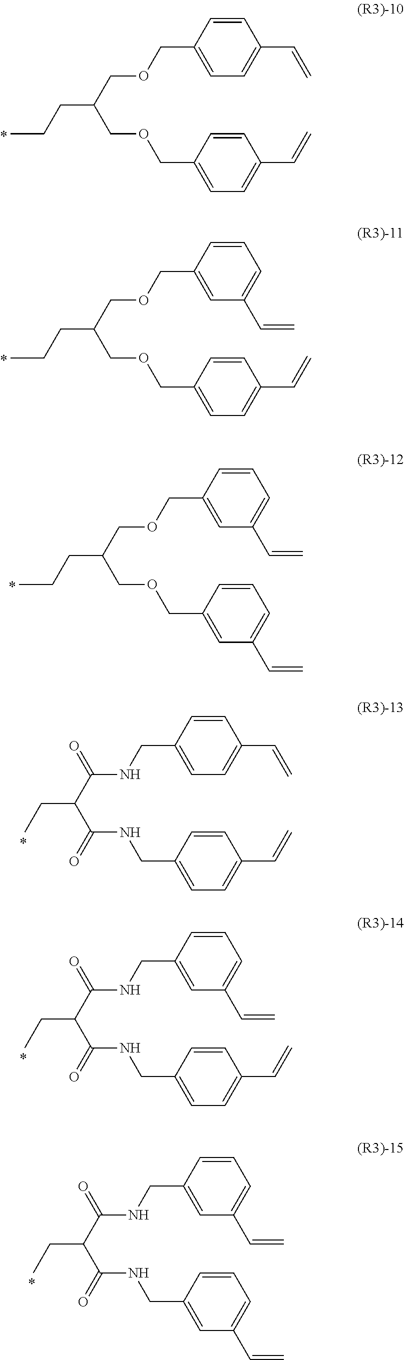

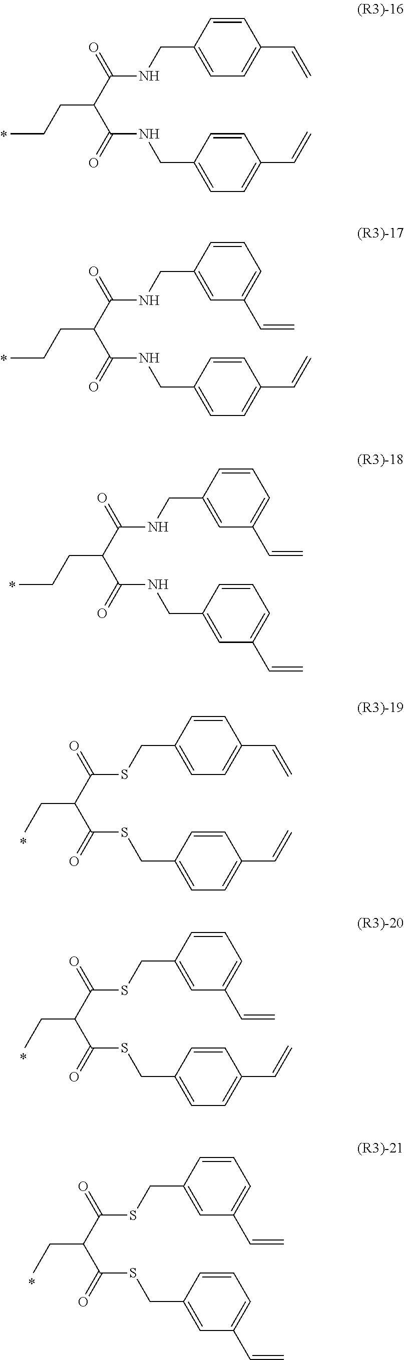

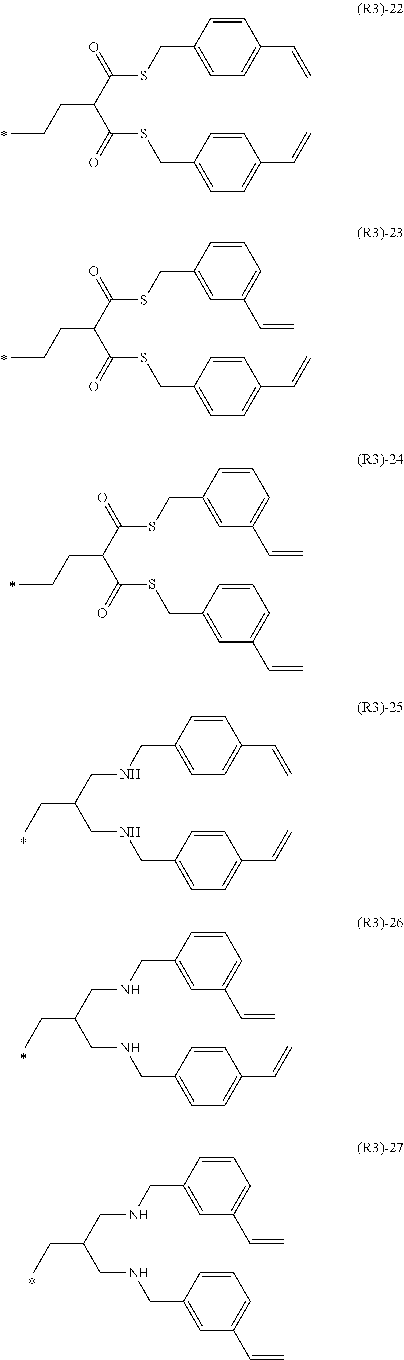

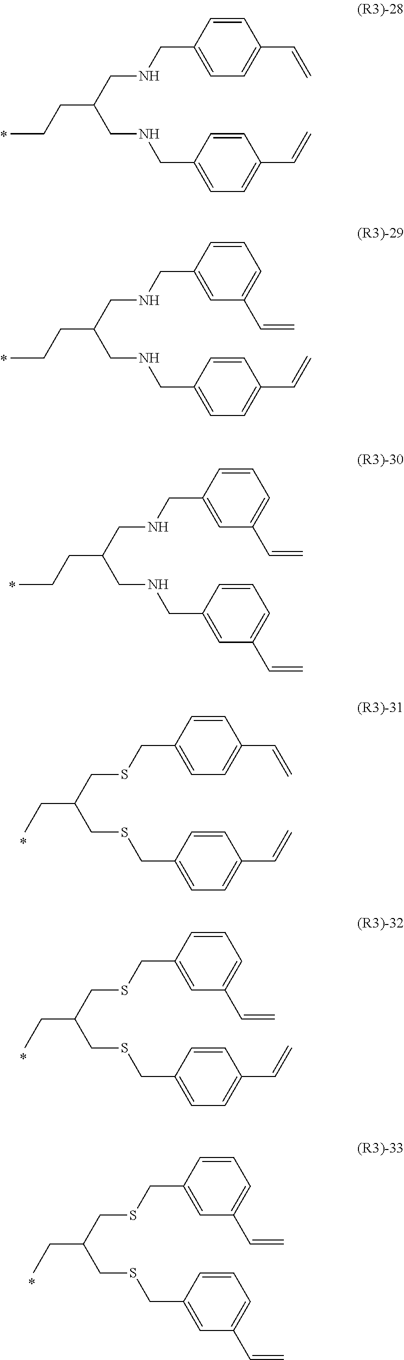

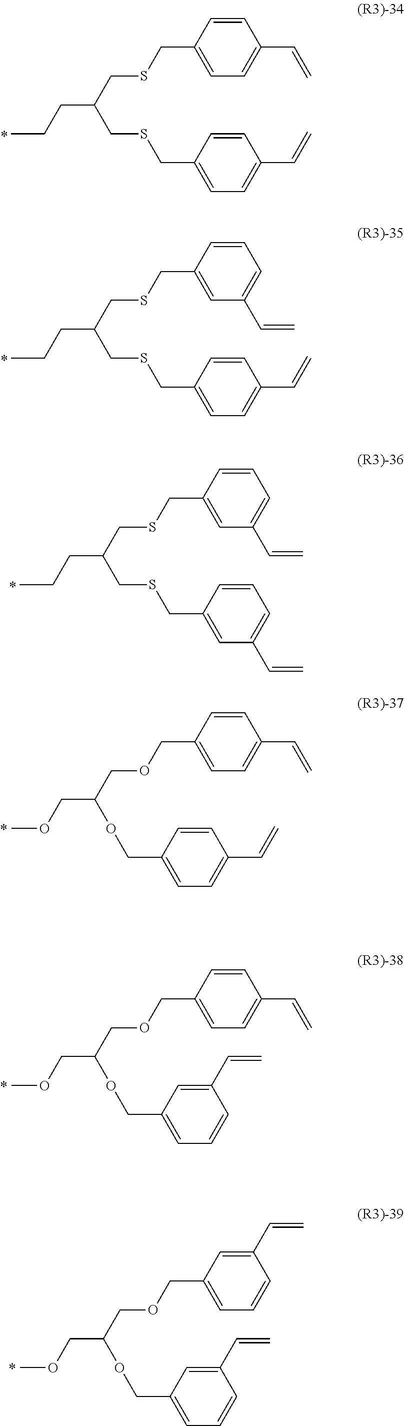

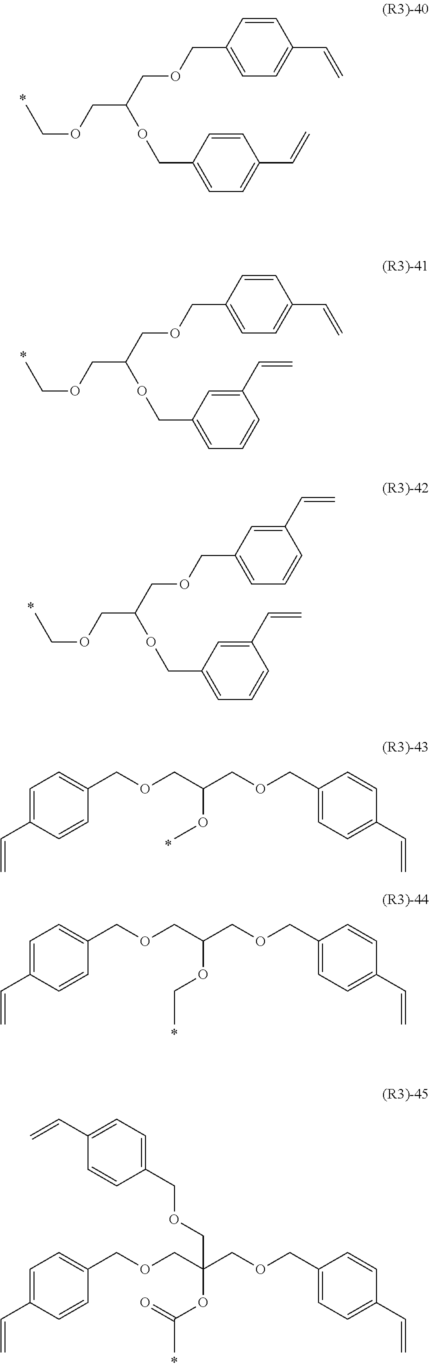

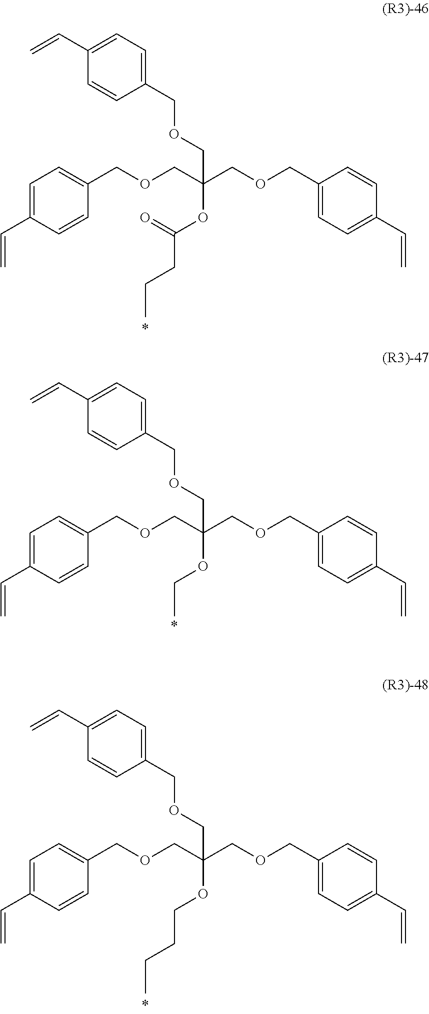 [SMILES: C=Cc1ccc(COCC(COCc2ccc(C=C)cc2)(COCc2ccc(C=C)cc2)OC(=O)CCC)cc1 ; C=Cc1ccc(COCC(COCc2ccc(C=C)cc2)(COCc2ccc(C=C)cc2)OCC)cc1 ; C=Cc1ccc(COCC(COCc2ccc(C=C)cc2)(COCc2ccc(C=C)cc2)OCCCC)cc1]

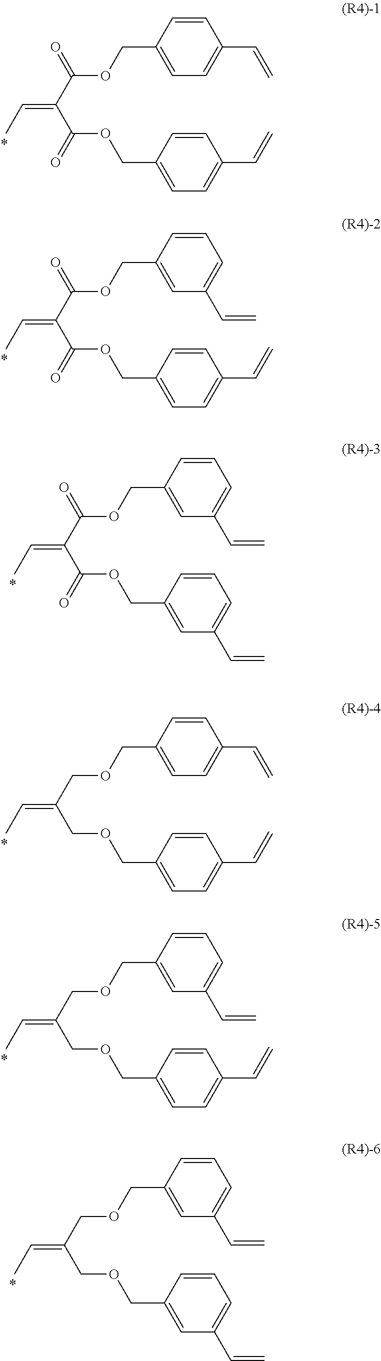

Next, specific examples of the compound represented by the formula (I), specifically the formula (I-a) are shown.

Specific Examples of Formula (I) [Formula (I-a)]

| Exemplary | Charge transporting | Functional |
|---|---|---|
| compound | skeleton F | group |
| (I-a)-1 | (M1)-15 | (R2)-8 |
| (I-a)-2 | (M1)-15 | (R2)-9 |
| (I-a)-3 | (M1)-15 | (R2)-10 |
| (I-a)-4 | (M1)-16 | (R2)-8 |
| (I-a)-5 | (M1)-17 | (R2)-8 |
| (I-a)-6 | (M1)-17 | (R2)-9 |
| (I-a)-7 | (M1)-17 | (R2)-10 |
| (I-a)-8 | (M1)-18 | (R2)-8 |
| (I-a)-9 | (M1)-18 | (R2)-9 |
| (I-a)-10 | (M1)-18 | (R2)-10 |
| (I-a)-11 | (M1)-19 | (R2)-8 |
| (I-a)-12 | (M1)-21 | (R2)-8 |
| (I-a)-13 | (M1)-22 | (R2)-8 |
| (I-a)-14 | (M2)-15 | (R2)-8 |
| (I-a)-15 | (M2)-15 | (R2)-9 |
| (I-a)-16 | (M2)-15 | (R2)-10 |
| (I-a)-17 | (M2)-16 | (R2)-8 |
| (I-a)-18 | (M2)-17 | (R2)-8 |
| (I-a)-19 | (M2)-23 | (R2)-8 |
| (I-a)-20 | (M2)-23 | (R2)-9 |
| (I-a)-21 | (M2)-23 | (R2)-10 |
| (I-a)-22 | (M2)-24 | (R2)-8 |
| (I-a)-23 | (M2)-24 | (R2)-9 |
| (I-a)-24 | (M2)-24 | (R2)-10 |
| (I-a)-25 | (M2)-25 | (R2)-8 |
| (I-a)-26 | (M2)-25 | (R2)-9 |
| (I-a)-27 | (M2)-25 | (R2)-10 |
| (I-a)-28 | (M2)-26 | (R2)-8 |
| (I-a)-29 | (M2)-26 | (R2)-9 |
| (I-a)-30 | (M2)-26 | (R2)-10 |
| (I-a)-31 | (M2)-21 | (R2)-11 |

Next, specific examples of the compound represented by the formula (I), specifically the formula (I-b), are shown.

Specific Examples of Formula (I) [Formula (I-b)]

| Exemplary | Charge transporting | Functional |
|---|---|---|
| compound | skeleton F | group |
| (I-b)-1 | (M1)-1 | (R2)-1 |
| (I-b)-2 | (M1)-1 | (R2)-2 |
| (I-b)-3 | (M1)-1 | (R2)-4 |
| (I-b)-4 | (M1)-2 | (R2)-5 |
| (I-b)-5 | (M1)-2 | (R2)-7 |
| (I-b)-6 | (M1)-4 | (R2)-3 |
| (I-b)-7 | (M1)-4 | (R2)-5 |
| (I-b)-8 | (M1)-5 | (R2)-6 |
| (I-b)-9 | (M1)-8 | (R2)-4 |
| (I-b)-10 | (M1)-16 | (R2)-5 |
| (I-b)-11 | (M1)-20 | (R2)-1 |
| (I-b)-12 | (M1)-22 | (R2)-1 |
| (I-b)-13 | (M2)-2 | (R2)-1 |
| (I-b)-14 | (M2)-2 | (R2)-3 |
| (I-b)-15 | (M2)-2 | (R2)-4 |
| (I-b)-16 | (M2)-6 | (R2)-4 |
| (I-b)-17 | (M2)-6 | (R2)-5 |
| (I-b)-18 | (M2)-6 | (R2)-6 |
| (I-b)-19 | (M2)-10 | (R2)-4 |
| (I-b)-20 | (M2)-10 | (R2)-5 |
| (I-b)-21 | (M2)-13 | (R2)-1 |
| (I-b)-22 | (M2)-13 | (R2)-3 |
| (I-b)-23 | (M2)-13 | (R2)-4 |
| (I-b)-24 | (M2)-13 | (R2)-5 |
| (I-b)-25 | (M2)-13 | (R2)-6 |
| (I-b)-26 | (M2)-16 | (R2)-4 |
| (I-b)-27 | (M2)-21 | (R2)-5 |
| (I-b)-28 | (M2)-25 | (R2)-4 |
| (I-b)-29 | (M2)-25 | (R2)-5 |
| (I-b)-30 | (M2)-25 | (R2)-7 |
| (I-b)-31 | (M2)-13 | (R2)-4 |

Next, specific examples of the compound represented by the formula (I), specifically the formula (I-c), are shown.

Specific Examples of Formula (I) [Formula (I-c)]

| Exemplary | Charge transporting | Functional |
|---|---|---|
| compound | skeleton F | group |
| (I-c)-1 | (M1)-1 | (R1)-1 |
| (I-c)-2 | (M1)-1 | (R1)-2 |
| (I-c)-3 | (M1)-1 | (R1)-4 |
| (I-c)-4 | (M1)-2 | (R1)-5 |
| (I-c)-5 | (M1)-2 | (R1)-7 |
| (I-c)-6 | (M1)-4 | (R1)-3 |
| (I-c)-7 | (M1)-4 | (R1)-7 |
| (I-c)-8 | (M1)-7 | (R1)-6 |
| (I-c)-9 | (M1)-11 | (R1)-4 |
| (I-c)-10 | (M1)-15 | (R1)-5 |
| (I-c)-11 | (M1)-22 | (R1)-5 |
| (I-c)-12 | (M1)-22 | (R1)-1 |
| (I-c)-13 | (M2)-2 | (R1)-1 |
| (I-c)-14 | (M2)-2 | (R1)-3 |
| (I-c)-15 | (M2)-2 | (R1)-7 |
| (I-c)-16 | (M2)-3 | (R1)-4 |
| (I-c)-17 | (M2)-3 | (R1)-7 |
| (I-c)-18 | (M2)-5 | (R1)-6 |
| (I-c)-19 | (M2)-10 | (R1)-4 |
| (I-c)-20 | (M2)-10 | (R1)-5 |
| (I-c)-21 | (M2)-13 | (R1)-1 |
| (I-c)-22 | (M2)-13 | (R1)-3 |
| (I-c)-23 | (M2)-13 | (R1)-7 |
| (I-c)-24 | (M2)-16 | (R1)-5 |
| (I-c)-25 | (M2)-23 | (R1)-7 |
| (I-c)-26 | (M2)-23 | (R1)-4 |
| (I-c)-27 | (M2)-25 | (R1)-7 |
| (I-c)-28 | (M2)-25 | (R1)-4 |
| (I-c)-29 | (M2)-26 | (R1)-5 |
| (I-c)-30 | (M2)-26 | (R1)-7 |

Specific Examples of Formula (I) [Formula (I-c)]

| Exemplary | Charge transporting | Functional |
|---|---|---|
| compound | skeleton F | group |
| (I-c)-31 | (M3)-1 | (R1)-2 |
| (I-c)-32 | (M3)-1 | (R1)-7 |
| (I-c)-33 | (M3)-5 | (R1)-2 |
| (I-c)-34 | (M3)-7 | (R1)-4 |
| (I-c)-35 | (M3)-7 | (R1)-2 |
| (I-c)-36 | (M3)-19 | (R1)-4 |
| (I-c)-37 | (M3)-26 | (R1)-1 |
| (I-c)-38 | (M3)-26 | (R1)-3 |
| (I-c)-39 | (M4)-3 | (R1)-3 |
| (I-c)-40 | (M4)-3 | (R1)-4 |
| (I-c)-41 | (M4)-8 | (R1)-5 |
| (I-c)-42 | (M4)-8 | (R1)-6 |
| (I-c)-43 | (M4)-12 | (R1)-7 |
| (I-c)-44 | (M4)-12 | (R1)-4 |
| (I-c)-45 | (M4)-12 | (R1)-2 |
| (I-c)-46 | (M4)-12 | (R1)-11 |
| (I-c)-47 | (M4)-16 | (R1)-3 |
| (I-c)-48 | (M4)-16 | (R1)-4 |
| (I-c)-49 | (M4)-20 | (R1)-1 |
| (I-c)-50 | (M4)-20 | (R1)-4 |
| (I-c)-51 | (M4)-20 | (R1)-7 |
| (I-c)-52 | (M4)-24 | (R1)-4 |
| (I-c)-53 | (M4)-24 | (R1)-7 |
| (I-c)-54 | (M4)-24 | (R1)-3 |
| (I-c)-55 | (M4)-24 | (R1)-5 |
| (I-c)-56 | (M4)-25 | (R1)-1 |
| (I-c)-57 | (M4)-26 | (R1)-3 |
| (I-c)-58 | (M4)-28 | (R1)-4 |
| (I-c)-59 | (M4)-28 | (R1)-5 |
| (I-c)-60 | (M4)-28 | (R1)-6 |

Specific Examples of Formula (I) [Formula (I-c)]

| Exemplary | Charge transporting | Functional |
|---|---|---|
| compound | skeleton F | group |
| (I-c)-61 | (M1)-1 | (R1)-15 |
| (I-c)-62 | (M1)-1 | (R1)-27 |
| (I-c)-63 | (M1)-1 | (R1)-37 |
| (I-c)-64 | (M1)-2 | (R1)-52 |
| (I-c)-65 | (M1)-2 | (R1)-18 |
| (I-c)-66 | (M1)-4 | (R1)-31 |
| (I-c)-67 | (M1)-4 | (R1)-44 |
| (I-c)-68 | (M1)-7 | (R1)-45 |
| (I-c)-69 | (M1)-11 | (R1)-45 |
| (I-c)-70 | (M1)-15 | (R1)-45 |
| (I-c)-71 | (M1)-21 | (R1)-15 |
| (I-c)-72 | (M1)-22 | (R1)-15 |
| (I-c)-73 | (M2)-2 | (R1)-15 |
| (I-c)-74 | (M2)-2 | (R1)-27 |
| (I-c)-75 | (M2)-2 | (R1)-37 |
| (I-c)-76 | (M2)-3 | (R1)-52 |
| (I-c)-77 | (M2)-3 | (R1)-18 |
| (I-c)-78 | (M2)-5 | (R1)-31 |
| (I-c)-79 | (M2)-10 | (R1)-44 |
| (I-c)-80 | (M2)-10 | (R1)-45 |
| (I-c)-81 | (M2)-13 | (R1)-45 |
| (I-c)-82 | (M2)-13 | (R1)-46 |
| (I-c)-83 | (M2)-13 | (R1)-15 |
| (I-c)-84 | (M2)-16 | (R1)-15 |
| (I-c)-85 | (M2)-23 | (R1)-27 |
| (I-c)-86 | (M2)-23 | (R1)-37 |
| (I-c)-87 | (M2)-25 | (R1)-52 |
| (I-c)-88 | (M2)-25 | (R1)-18 |
| (I-c)-89 | (M2)-26 | (R1)-31 |
| (I-c)-90 | (M2)-26 | (R1)-44 |

Specific Examples of Formula (I) [Formula (I-c)]

| Exemplary | Charge transporting | Functional |
|---|---|---|
| compound | skeleton F | group |
| (I-c)-91 | (M3)-1 | (R1)-15 |
| (I-c)-92 | (M3)-1 | (R1)-27 |
| (I-c)-93 | (M3)-5 | (R1)-37 |
| (I-c)-94 | (M3)-7 | (R1)-52 |
| (I-c)-95 | (M3)-7 | (R1)-18 |
| (I-c)-96 | (M3)-19 | (R1)-31 |
| (I-c)-97 | (M3)-26 | (R1)-44 |
| (I-c)-98 | (M3)-26 | (R1)-45 |
| (I-c)-99 | (M4)-3 | (R1)-45 |
| (I-c)-100 | (M4)-3 | (R1)-46 |
| (I-c)-101 | (M4)-8 | (R1)-15 |
| (I-c)-102 | (M4)-8 | (R1)-16 |
| (I-c)-103 | (M4)-12 | (R1)-15 |
| (I-c)-104 | (M4)-12 | (R1)-27 |
| (I-c)-105 | (M4)-12 | (R1)-37 |
| (I-c)-106 | (M4)-12 | (R1)-52 |
| (I-c)-107 | (M4)-16 | (R1)-18 |
| (I-c)-108 | (M4)-16 | (R1)-31 |
| (I-c)-109 | (M4)-20 | (R1)-44 |
| (I-c)-110 | (M4)-20 | (R1)-45 |
| (I-c)-111 | (M4)-20 | (R1)-46 |
| (I-c)-112 | (M4)-24 | (R1)-45 |
| (I-c)-113 | (M4)-24 | (R1)-15 |
| (I-c)-114 | (M4)-24 | (R1)-16 |
| (I-c)-115 | (M4)-24 | (R1)-27 |
| (I-c)-116 | (M4)-25 | (R1)-37 |
| (I-c)-117 | (M4)-26 | (R1)-52 |
| (I-c)-118 | (M4)-28 | (R1)-18 |
| (I-c)-119 | (M4)-28 | (R1)-31 |
| (I-c)-120 | (M4)-28 | (R1)-44 |
| (I-c)-121 | (M2)-26 | (R1)-4 |

Next, specific examples of the compound represented by the formula (I), specifically the formula (I-d) are shown.

Specific Examples of Formula (I) [Formula (I-d)]

| Exemplary | Charge transporting | Functional |
|---|---|---|
| compound | skeleton F | group |
| (I-d)-1 | (M3)-1 | (R2)-2 |
| (I-d)-2 | (M3)-1 | (R2)-7 |
| (I-d)-3 | (M3)-2 | (R2)-2 |
| (I-d)-4 | (M3)-2 | (R2)-4 |
| (I-d)-5 | (M3)-3 | (R2)-2 |
| (I-d)-6 | (M3)-3 | (R2)-4 |
| (I-d)-7 | (M3)-12 | (R2)-1 |
| (I-d)-8 | (M3)-21 | (R2)-3 |
| (I-d)-9 | (M3)-25 | (R2)-3 |
| (I-d)-10 | (M3)-25 | (R2)-4 |
| (I-d)-11 | (M3)-25 | (R2)-5 |
| (I-d)-12 | (M3)-25 | (R2)-6 |
| (I-d)-13 | (M4)-1 | (R2)-7 |
| (I-d)-14 | (M4)-3 | (R2)-4 |
| (I-d)-15 | (M4)-3 | (R2)-2 |
| (I-d)-16 | (M4)-8 | (R2)-1 |
| (I-d)-17 | (M4)-8 | (R2)-3 |
| (I-d)-18 | (M4)-8 | (R2)-4 |
| (I-d)-19 | (M4)-10 | (R2)-1 |
| (I-d)-20 | (M4)-10 | (R2)-4 |
| (I-d)-21 | (M4)-10 | (R2)-7 |
| (I-d)-22 | (M4)-12 | (R2)-4 |
| (I-d)-23 | (M4)-12 | (R2)-1 |
| (I-d)-24 | (M4)-12 | (R2)-3 |
| (I-d)-25 | (M4)-22 | (R2)-4 |
| (I-d)-26 | (M4)-24 | (R2)-1 |
| (I-d)-27 | (M4)-24 | (R2)-3 |
| (I-d)-28 | (M4)-24 | (R2)-4 |
| (I-d)-29 | (M4)-24 | (R2)-5 |
| (I-d)-30 | (M4)-28 | (R2)-6 |

Specific Examples of Formula (I) [Formula (I-d)]

| Exemplary | Charge transporting | Functional |
|---|---|---|
| compound | skeleton F | group |
| (I-d)-31 | (M3)-1 | (R2)-8 |
| (I-d)-32 | (M3)-1 | (R2)-9 |
| (I-d)-33 | (M3)-2 | (R2)-8 |
| (I-d)-34 | (M3)-2 | (R2)-9 |
| (I-d)-35 | (M3)-3 | (R2)-8 |
| (I-d)-36 | (M3)-3 | (R2)-9 |
| (I-d)-37 | (M3)-12 | (R2)-8 |
| (I-d)-38 | (M3)-12 | (R2)-9 |
| (I-d)-39 | (M4)-12 | (R2)-8 |
| (I-d)-40 | (M4)-12 | (R2)-9 |
| (I-d)-41 | (M4)-12 | (R2)-10 |
| (I-d)-42 | (M4)-24 | (R2)-8 |
| (I-d)-43 | (M4)-24 | (R2)-9 |
| (I-d)-44 | (M4)-24 | (R2)-10 |
| (I-d)-45 | (M4)-28 | (R2)-8 |
| (I-d)-46 | (M4)-28 | (R2)-9 |
| (I-d)-47 | (M4)-28 | (R2)-10 |

Next, specific examples of the compound represented by the formula (II), specifically the formula (II-a) are shown.

Specific Examples of Formula (II) [Formula (II-a)]

| Exemplary | Charge transporting | Functional |
|---|---|---|
| compound | skeleton F | group |
| (II)-1 | (M1)-1 | (R3)-1 |
| (II)-2 | (M1)-1 | (R3)-2 |
| (II)-3 | (M1)-1 | (R3)-7 |
| (II)-4 | (M1)-2 | (R3)-1 |
| (II)-5 | (M1)-2 | (R3)-2 |
| (II)-6 | (M1)-2 | (R3)-3 |
| (II)-7 | (M1)-2 | (R3)-5 |
| (II)-8 | (M1)-2 | (R3)-7 |
| (II)-9 | (M1)-2 | (R3)-8 |
| (II)-10 | (M1)-2 | (R3)-10 |
| (II)-11 | (M1)-2 | (R3)-11 |
| (II)-12 | (M1)-4 | (R3)-1 |
| (II)-13 | (M1)-4 | (R3)-2 |
| (II)-14 | (M1)-4 | (R3)-3 |
| (II)-15 | (M1)-4 | (R3)-5 |
| (II)-16 | (M1)-4 | (R3)-7 |
| (II)-17 | (M1)-4 | (R3)-8 |
| (II)-18 | (M1)-8 | (R3)-1 |
| (II)-19 | (M1)-8 | (R3)-2 |
| (II)-20 | (M1)-8 | (R3)-3 |
| (II)-21 | (M1)-8 | (R3)-5 |
| (II)-22 | (M1)-8 | (R3)-7 |
| (II)-23 | (M1)-8 | (R3)-8 |
| (II)-24 | (M1)-11 | (R3)-1 |
| (II)-25 | (M1)-11 | (R3)-3 |
| (II)-26 | (M1)-11 | (R3)-7 |
| (II)-27 | (M1)-11 | (R3)-9 |
| (II)-28 | (M1)-16 | (R3)-4 |
| (II)-29 | (M1)-22 | (R3)-6 |
| (II)-30 | (M1)-22 | (R3)-9 |

Specific Examples of Formula (II) [Formula (II-a)]

| Exemplary | Charge transporting | Functional |
|---|---|---|
| compound | skeleton F | group |
| (II)-31 | (M2)-2 | (R3)-1 |
| (II)-32 | (M2)-2 | (R3)-3 |
| (II)-33 | (M2)-2 | (R3)-7 |
| (II)-34 | (M2)-2 | (B3)-9 |
| (II)-35 | (M2)-3 | (R3)-1 |
| (II)-36 | (M2)-3 | (R3)-2 |
| (II)-37 | (M2)-3 | (R3)-3 |
| (II)-38 | (M2)-3 | (R3)-7 |
| (II)-39 | (M2)-3 | (R3)-8 |
| (II)-40 | (M2)-5 | (R3)-8 |
| (II)-41 | (M2)-5 | (R3)-10 |
| (II)-42 | (M2)-10 | (R3)-1 |
| (II)-43 | (M2)-10 | (R3)-3 |
| (II)-44 | (M2)-10 | (R3)-7 |
| (II)-45 | (M2)-10 | (R3)-9 |
| (II)-46 | (M2)-13 | (R3)-1 |
| (II)-47 | (M2)-13 | (R3)-2 |
| (II)-48 | (M2)-13 | (R3)-3 |
| (II)-49 | (M2)-13 | (R3)-5 |
| (II)-50 | (M2)-13 | (R3)-7 |
| (II)-51 | (M2)-13 | (R3)-8 |
| (II)-52 | (M2)-16 | (R3)-1 |
| (II)-53 | (M2)-16 | (R3)-7 |
| (II)-54 | (M2)-21 | (R3)-1 |
| (II)-55 | (M2)-21 | (R3)-7 |
| (II)-56 | (M2)-25 | (R3)-1 |
| (II)-57 | (M2)-25 | (R3)-3 |
| (II)-58 | (M2)-25 | (R3)-7 |
| (II)-59 | (M2)-25 | (R3)-8 |
| (II)-60 | (M2)-25 | (R3)-9 |

Specific Examples of Formula (II) [Formula (II-a)]

| Exemplary | Charge transporting | Functional |
|---|---|---|
| compound | skeleton F | group |
| (II)-61 | (M3)-1 | (R3)-1 |
| (II)-62 | (M3)-1 | (R3)-2 |
| (II)-63 | (M3)-1 | (R3)-7 |
| (II)-64 | (M3)-1 | (R3)-8 |
| (II)-65 | (M3)-3 | (R3)-1 |
| (II)-66 | (M3)-3 | (R3)-7 |
| (II)-67 | (M3)-7 | (R3)-1 |
| (II)-68 | (M3)-7 | (R3)-2 |
| (II)-69 | (M3)-7 | (R3)-7 |
| (II)-70 | (M3)-7 | (R3)-8 |
| (II)-71 | (M3)-18 | (R3)-5 |
| (II)-72 | (M3)-18 | (R3)-12 |
| (II)-73 | (M3)-25 | (R3)-7 |
| (II)-74 | (M3)-25 | (R3)-8 |
| (II)-75 | (M3)-25 | (R3)-5 |
| (II)-76 | (M3)-25 | (R3)-12 |
| (II)-77 | (M4)-2 | (R3)-1 |
| (II)-78 | (M4)-2 | (R3)-7 |
| (II)-79 | (M4)-4 | (R3)-7 |
| (II)-80 | (M4)-4 | (R3)-8 |
| (II)-81 | (M4)-4 | (R3)-5 |
| (II)-82 | (M4)-4 | (R3)-12 |
| (II)-83 | (M4)-7 | (R3)-1 |
| (II)-84 | (M4)-7 | (R3)-2 |
| (II)-85 | (M4)-7 | (R3)-7 |
| (II)-86 | (M4)-7 | (R3)-8 |
| (II)-87 | (M4)-9 | (R3)-7 |
| (II)-88 | (M4)-9 | (R3)-8 |
| (II)-89 | (M4)-9 | (R3)-5 |
| (II)-90 | (M4)-9 | (R3)-12 |

Specific Examples of Formula (II) [Formula (II-a)]

| Exemplary | Charge transporting | Functional |
|---|---|---|
| compound | skeleton F | group |
| (II)-91 | (M1)-1 | (R3)-13 |
| (II)-92 | (M1)-1 | (R3)-15 |
| (II)-93 | (M1)-1 | (R3)-47 |
| (II)-94 | (M1)-2 | (R3)-13 |
| (II)-95 | (M1)-2 | (R3)-15 |
| (II)-96 | (M1)-2 | (R3)-19 |
| (II)-97 | (M1)-2 | (R3)-21 |
| (II)-98 | (M1)-2 | (R3)-28 |
| (II)-99 | (M1)-2 | (R3)-31 |
| (II)-100 | (M1)-2 | (R3)-33 |
| (II)-101 | (M1)-2 | (R3)-37 |
| (II)-102 | (M1)-2 | (R3)-38 |
| (II)-103 | (M1)-2 | (R3)-43 |
| (II)-104 | (M1)-4 | (R3)-13 |
| (II)-105 | (M1)-4 | (R3)-15 |
| (II)-106 | (M1)-4 | (R3)-43 |
| (II)-107 | (M1)-4 | (R3)-48 |
| (II)-108 | (M1)-8 | (R3)-13 |
| (II)-109 | (M1)-8 | (R3)-15 |
| (II)-110 | (M1)-8 | (R3)-19 |
| (II)-111 | (M1)-8 | (R3)-28 |
| (II)-112 | (M1)-8 | (R3)-31 |
| (II)-113 | (M1)-8 | (R3)-33 |
| (II)-114 | (M1)-11 | (R3)-31 |
| (II)-115 | (M1)-11 | (R3)-33 |
| (II)-116 | (M1)-11 | (R3)-34 |
| (II)-117 | (M1)-11 | (R3)-36 |
| (II)-118 | (M1)-16 | (R3)-13 |
| (II)-119 | (M1)-22 | (R3)-15 |
| (II)-120 | (M1)-22 | (R3)-47 |

Specific Examples of Formula (II) [Formula (II-a)]

| Exemplary | Charge transporting | Functional |
|---|---|---|
| compound | skeleton F | group |
| (II)-121 | (M2)-2 | (R3)-13 |
| (II)-122 | (M2)-2 | (R3)-15 |
| (II)-123 | (M2)-2 | (R3)-14 |
| (II)-124 | (M2)-2 | (R3)-17 |
| (II)-125 | (M2)-3 | (R3)-15 |
| (II)-126 | (M2)-3 | (R3)-19 |
| (II)-127 | (M2)-3 | (R3)-21 |
| (II)-128 | (M2)-3 | (R3)-28 |
| (II)-129 | (M2)-3 | (R3)-31 |
| (II)-130 | (M2)-5 | (R3)-33 |
| (II)-131 | (M2)-5 | (R3)-37 |
| (II)-132 | (M2)-10 | (R3)-38 |
| (II)-133 | (M2)-10 | (R3)-43 |
| (II)-134 | (M2)-10 | (R3)-13 |
| (II)-135 | (M2)-10 | (R3)-15 |
| (II)-136 | (M2)-13 | (R3)-16 |
| (II)-137 | (M2)-13 | (R3)-48 |
| (II)-138 | (M2)-13 | (R3)-13 |
| (II)-139 | (M2)-13 | (R3)-26 |
| (II)-140 | (M2)-13 | (R3)-19 |
| (II)-141 | (M2)-13 | (R3)-28 |
| (II)-142 | (M2)-16 | (R3)-31 |
| (II)-143 | (M2)-16 | (R3)-33 |
| (II)-144 | (M2)-21 | (R3)-33 |
| (II)-145 | (M2)-21 | (R3)-34 |
| (II)-146 | (M2)-25 | (R3)-35 |
| (II)-147 | (M2)-25 | (R3)-36 |
| (II)-148 | (M2)-25 | (R3)-37 |
| (II)-149 | (M2)-25 | (R3)-15 |
| (II)-150 | (M2)-25 | (R3)-47 |
| (II)-151 | (M3)-1 | (R3)-13 |
| (II)-152 | (M3)-1 | (R3)-15 |
| (II)-153 | (M3)-1 | (R3)-14 |
| (II)-154 | (M3)-1 | (R3)-17 |
| (II)-155 | (M3)-3 | (R3)-15 |
| (II)-156 | (M3)-3 | (R3)-19 |
| (II)-157 | (M3)-7 | (R3)-21 |
| (II)-158 | (M3)-7 | (R3)-28 |
| (II)-159 | (M3)-7 | (R3)-31 |
| (II)-160 | (M3)-7 | (R3)-33 |

Specific Examples of Formula (II) [Formula (II-a)]

| Exemplary | Charge transporting | Functional |
|---|---|---|
| compound | skeleton F | group |
| (II)-161 | (M3)-18 | (R3)-37 |
| (II)-162 | (M3)-18 | (R3)-38 |
| (II)-163 | (M3)-25 | (R3)-43 |
| (II)-164 | (M3)-25 | (R3)-13 |
| (II)-165 | (M3)-25 | (R3)-15 |
| (II)-166 | (M3)-25 | (R3)-16 |
| (II)-167 | (M4)-2 | (R3)-48 |
| (II)-168 | (M4)-2 | (R3)-13 |
| (II)-169 | (M4)-4 | (R3)-26 |
| (II)-170 | (M4)-4 | (R3)-19 |
| (II)-171 | (M4)-4 | (R3)-28 |
| (II)-172 | (M4)-4 | (R3)-31 |
| (II)-173 | (M4)-7 | (R3)-32 |
| (II)-174 | (M4)-7 | (R3)-33 |
| (II)-175 | (M4)-7 | (R3)-34 |
| (II)-176 | (M4)-7 | (R3)-35 |
| (II)-177 | (M4)-9 | (R3)-36 |
| (II)-178 | (M4)-9 | (R3)-37 |
| (II)-179 | (M4)-9 | (R3)-15 |
| (II)-180 | (M4)-9 | (R3)-47 |
| (II)-181 | (M1)-8 | (R4)-1 |
| (II)-182 | (M1)-8 | (R4)-2 |
| (II)-183 | (M2)-10 | (R4)-3 |
| (II)-184 | (M2)-10 | (R4)-4 |
| (II)-185 | (M3)-7 | (R4)-5 |
| (II)-186 | (M4)-9 | (R4)-6 |
| (II)-187 | (M2)-10 | (R4)-1 |

The specific reactive charge transporting material (in particular, the reactive compound represented by the formula (I)) is synthesized in the following manner, for example.

That is, the specific reactive charge transporting material is synthesized by, for example, etherification of a carboxylic acid or an alcohol as a precursor, with chloromethylstyrene or the like corresponding thereto.

An example of the synthesis route for the exemplary compound (I-d)-22 of the specific reactive charge transporting material is shown below.

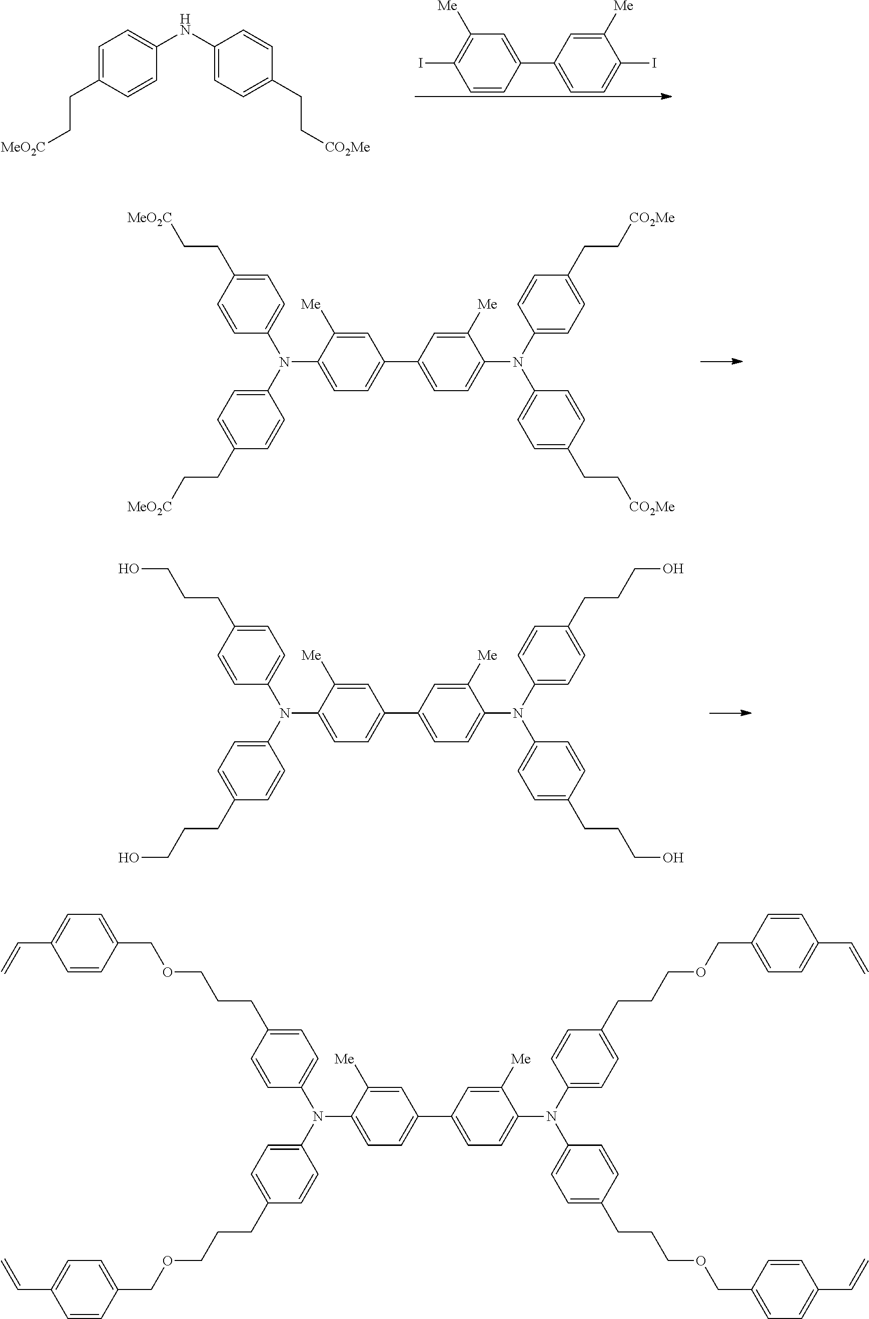 [SMILES: COC(=O)CCc1ccc(Nc2ccc(CCC(=O)OC)cc2)cc1 ; Cc1cc(-c2ccc(I)c(C)c2)ccc1I ; COC(=O)CCc1ccc(N(c2ccc(CCC(=O)OC)cc2)c2ccc(-c3ccc(N(c4ccc(CCC(=O)OC)cc4)c4ccc(CCC(=O)OC)cc4)c(C)c3)cc2C)cc1 ; Cc1cc(-c2ccc(N(c3ccc(CCCO)cc3)c3ccc(CCCO)cc3)c(C)c2)ccc1N(c1ccc(CCCO)cc1)c1ccc(CCCO)cc1 ; C=Cc1ccc(COCCCc2ccc(N(c3ccc(CCCOCc4ccc(C=C)cc4)cc3)c3ccc(-c4ccc(N(c5ccc(CCCOCc6ccc(C=C)cc6)cc5)c5ccc(CCCOCc6ccc(C=C)cc6)cc5)c(C)c4)cc3C)cc2)cc1]

A carboxylic acid of the arylamine compound is obtained by subjecting an ester group of the arylamine compound to hydrolysis using, for example, a basic catalyst (NaOH, K₂CO₃, and the like) or an acidic catalyst (for example, phosphoric acid, sulfuric acid, and the like) as described in Experimental Chemistry Lecture, 4th Ed., Vol. 20, p. 51, or the like.

Here, examples of the solvent include various types of the solvents, and an alcohol solvent such as methanol, ethanol, and ethylene glycol, or a mixture thereof with water may be preferably used.

Incidentally, in the case where the solubility of the arylamine compound is low, methylene chloride, chloroform, toluene, dimethylsulfoxide, ether, tetrahydrofuran, or the like may be added.

The amount of the solvent is not particularly limited, but it may be, for example, from 1 part by weight to 100 parts by weight, and preferably from 2 parts by weight to 50 parts by weight, based on 1 part by weight of the ester group-containing arylamine compound.

The reaction temperature is set to be, for example, in a range of room temperature (for example, 25° C.) to the boiling point of the solvent, and in terms of the reaction rate, preferably 50° C. or higher.

The amount of the catalyst is not particularly limited, but may be, for example, from 0.001 parts by weight to 1 part by weight, and preferably from 0.01 parts by weight to 0.5 parts by weight, based on 1 part by weight of the ester group-containing arylamine compound.

After the hydrolysis reaction, in the case where the hydrolysis is carried out with a basic catalyst, the produced salt is neutralized with an acid (for example, hydrochloric acid) to be free. Further, after sufficiently washing with water, the product is dried and used, or may be, if necessary, purified by recrystallization with a suitable solvent such as methanol, ethanol, toluene, ethyl acetate, and acetone, and then dried and used.

Furthermore, the alcohol form of the arylamine compound is synthesized by reducing an ester group of the arylamine compound to obtain a corresponding alcohol using aluminum lithium hydride, sodium borohydride, or the like as described in, for example, Experimental Chemistry Lecture, 4th Ed., Vol. 20, P. 10, or the like.

For example, in the case of introducing a reactive group with an ester bond, ordinary esterification in which a carboxylic acid of the arylamine compound and hydroxymethylstyrene are dehydrated and condensed using an acid catalyst, or a method in which a carboxylic acid of the arylamine compound and halogenated methylstyrene are condensed using a base such as pyridine, piperidine, triethylamine, dimethylaminopyridine, trimethylamine, DBU, sodium hydride, sodium hydroxide, and potassium hydroxide may be used, but the method using halogenated methylstyrene is suitable since it suppresses by-products.

The halogenated methylstyrene may be added in an amount of 1 equivalent or more, preferably 1.2 equivalents or more, and more preferably 1.5 equivalents or more, based on the acid of the carboxylic acid of the arylamine compound, and the base may be used in an amount of from 0.8 equivalents to 2.0 equivalents, and preferably from 1.0 equivalent to 1.5 equivalents, based on the halogenated methylstyrene.

As the solvent, an aprotic polar solvent such as N-methylpyrrolidone, dimethylsulfoxide, and N,N-dimethylformamide; a ketone solvent such as acetone and methyl ethyl ketone; an ether solvent such as diethyl ether and tetrahydrofuran; an aromatic solvent such as toluene, chlorobenzene, and 1-chloronaphthalene; and the like are effective, and the solvent may be used in an amount in the range of from 1 part by weight to 100 parts by weight, and preferably from 2 parts by weight to 50 parts by weight, based on 1 part by weight of the carboxylic acid of the arylamine compound.

The reaction temperature is not particularly limited. After completion of the reaction, the reaction liquid may be poured into water, extracted with a solvent such as toluene, hexane, and ethyl acetate, washed with water, and if necessary, purified using an adsorbent such as activated carbon, silica gel, porous alumina, and activated white clay.

Furthermore, in the case of introduction with an ether bond, a method in which an alcohol of an arylamine compound and a halogenated methylstyrene are condensed using a base such as pyridine, piperidine, triethylamine, dimethylaminopyridine, trimethylamine, DBU, sodium hydride, sodium hydroxide, and potassium hydroxide may be preferably used.

The halogenated methylstyrene may be added in an amount of 1 equivalent or more, preferably 1.2 equivalents or more, and more preferably 1.5 equivalents or more, based on the alcohol of the arylamine compound, and the base may be used in an amount of from 0.8 equivalents to 2.0 equivalents, and preferably from 1.0 equivalent to 1.5 equivalents, based on the halogenated methylstyrene.

As the solvent, an aprotic polar solvent such as N-methylpyrrolidone, dimethylsulfoxide, and N,N-dimethylformamide; a ketone solvent such as acetone and methyl ethyl ketone; an ether solvent such as diethyl ether and tetrahydrofuran; an aromatic solvent such as toluene, chlorobenzene, and 1-chloronaphthalene; and the like are effective, and the solvent may be used in an amount in the range of from 1 part by weight to 100 parts by weight, and preferably from 2 parts by weight to 50 parts by weight, based on 1 part by weight of the alcohol of the arylamine compound.

The reaction temperature is not particularly limited. After completion of the reaction, the reaction liquid is poured into water, extracted with a solvent such as toluene, hexane, and ethyl acetate, washed with water, and if necessary, purification may be carried out using an adsorbent such as activated carbon, silica gel, porous alumina, and activated white clay.

The specific reactive charge transporting material (in particular, the reactive compound represented by the formula (II)) is synthesized using, for example, the general method for synthesizing an ordinary charge transporting material as shown below (formylation, esterification, etherification, or hydrogenation).
Formylation: a reaction which is suitable for introducing a formyl group into an aromatic compound, a heterocyclic compound, and an alkene, each having an electron donating group. DMF and phosphorous oxytrichloride are generally used and is commonly carried out at a reaction temperature from room temperature (for example, 25° C.) to about 100° C.
Esterification: A condensation reaction of an organic acid with a hydroxyl group-containing compound such as an alcohol and a phenol. A method in which a dehydrating agent coexists or water is excluded from the system to move the equilibrium toward the ester side is preferably used.
Etherification: A Williamson synthesis method in which an alkoxide and an organic halogen compound are condensed is general.
Hydrogenation: A method in which hydrogen is reacted with an unsaturated bond using various catalysts.

The content of the specific reactive charge transporting material (content in the composition) is, for example, from 60% by weight to 95% by weight, and preferably from 65% by weight to 93% by weight, based on the weight of the protective layer 5 (outermost surface layer).

Hydrophobic Silica Particles

The hydrophobic silica particles are silica particles having a hydrophobization-treated surface.

Examples of the silica particles to be subjected to a hydrophobization treatment include wet silica particles (for example, sol-gel silica particles, aqueous colloidal silica particles, and alcoholic silica particles), and dry silica particles (for example fumed silica particles and molten silica particles) I. Among these, as the silica particles, dry silica particles (particularly, fumed silica particles) are preferable, from the viewpoint of improvement of the stability of electrical characteristics and the scratch resistance of a protective layer (outermost surface layer).

Particularly, as the silica particles, hollow silica particles having a low dielectric constant and preventing light scattering (silica particles having pores inside) are preferable, from the viewpoint of improvement of the stability of electrical characteristics and the scratch resistance of a protective layer (outermost surface layer).

Examples of the hydrophobizing agent include a silane coupling agent and a silicone oil.

Examples of the silane coupling agent include organosilicon compounds (for example, a silane compound and a silazane compound) having an alkyl group (for example, a methyl group, an ethyl group, a propyl group, and a butyl group). Specific examples of the silane coupling agent include hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, γ-methacryloxypropyltrimethoxysilane, and vinyltriacetoxysilane.

Examples of the silicone oil include a dimethyl silicone oil, a methylphenyl silicone oil, a chlorophenyl silicone oil, a methylhydrogen silicone oil, an alkyl modified silicone oil, a fluorine modified silicone oil, a polyether modified silicone oil, an alcohol modified silicone oil, an amino modified silicone oil, an epoxy modified silicone oil, an epoxy/polyether modified silicone oil, a phenol modified silicone oil, a carboxyl modified silicone oil, a mercapto modified silicone oil, an acryl or methacryl modified silicone oil, and an α-methylstyrene modified silicone oil.

The hydrophobizing agents may be used singly or in combination of two or more kinds thereof.

The treatment amount of the hydrophobizing agent is preferably from 1 part by weight to 60 parts by weight, more preferably from 5 parts by weight to 40 parts by weight, and still more preferably from 10 parts by weight to 30 parts by weight, based on 100 parts by weight of silica particles, from the viewpoint of improvement of the electrical characteristics and the scratch resistance of the protective layer (outermost surface layer).

The volume average particle diameter of the hydrophobic silica particles is preferably from 50 nm to 150 nm, more preferably from 70 nm to 130 nm, and still more preferably from 80 nm to 100 nm, from the viewpoint of improvement of the electrical characteristics and the scratch resistance of the protective layer (outermost surface layer).

The volume average particle diameter of the hydrophobic silica particles is obtained by observing 100 primary particles of the hydrophobic silica particles on the cross-section of the protective layer (outermost surface layer) by a scanning electron microscope (SEM: S-4100 type, manufactured by Hitachi, Ltd.), and measuring the longest diameter and the shortest diameter per particle by an image analysis of the primary particles, thereby measuring a circle-corresponding diameter from the median value. A 50% diameter (D50v) in a cumulative frequency of circle-corresponding diameters thus obtained is taken as a volume average particle diameter of the hydrophobic silica particles.

The content of the hydrophobic silica particles is preferably from 1% by weight to 50% by weight, and more preferably from 5% by weight to 30% by weight, from the viewpoint of improvement of the electrical characteristics and the scratch resistance of the protective layer (outermost surface layer), based on the protective layer (outermost surface layer) (based on the solid content of protective layer (outermost surface layer)).

Resin Particles

The film constituting the protective layer (outermost surface layer) may include resin particles.

Examples of the resin particles include particles of a polycarbonate resin of a bisphenol A type, a bisphenol Z type, or the like, particles of an insulating resin such as an acrylic resin, a methacrylic resin, a polyarylate resin, a polyester resin, a polyvinyl chloride resin, a polystyrene resin, an acrylonitrile-styrene copolymer resin, an acrylonitrile-butadiene copolymer resin, a polyvinyl acetate resin, a polyvinyl formal resin, a polysulfone resin, a styrene-acryl copolymer, a styrene-butadiene copolymer resin, a vinylidene chloride-acrylonitrile copolymer resin, a vinyl chloride-vinyl acetate-maleic anhydride resin, a silicone resin, a phenol-formaldehyde resin, a polyacrylamide resin, a polyamide resin, chlorinated rubber, and particles of an organic photoconductive polymer such as polyvinyl carbazole, polyvinyl anthracene, and polyvinyl pyrene.

These resin particles may be hollow particles.

Furthermore, as the resin particles, these resin particles may be used singly or as a mixture of two or more kinds thereof.

The film constituting the protective layer (outermost surface layer) may contain fluorine-containing resin particles.

Examples of the fluorine-containing resin particles include particles of a homopolymer of a fluorolefin or a copolymer of two or more kinds of a fluorolefin, or a copolymer of one kind or two or more kinds of a fluorolefin and a non-fluorinated monomer.

Examples of the fluorolefin include perhalolefins such as tetrafluoroethylene (TFE), perfluorovinyl ether, hexafluoropropylene (HFP), and chlorotrifluoroethylene (CTFE), and non-perfluorolefins such as vinylidene fluoride (VdF), trifluoroethylene, and vinyl fluoride, with VdF, TFE, CTFE, HFP, and the like being preferable.

On the other hand, examples of the non-fluorinated monomer include hydrocarbon olefins such as ethylene, propylene, and butene; alkyl vinyl ethers such as cyclohexyl vinyl ether (CHVE), ethyl vinyl ether (EVE), butyl vinyl ether, and methyl vinyl ether; alkenyl vinyl ethers such as polyoxyethylene allyl ether (POEAE), and ethyl allyl ether; reactive α,β-unsaturated group-containing organosilicon compounds such as vinyltrimethoxysilane (VSi), vinyltriethoxysilane, and vinyltris(methoxyethoxy)silane; acrylic esters such as methyl acrylate and ethyl acrylate; methacrylic esters such as methyl methacrylate and ethyl methacrylate; and vinyl esters such as vinyl acetate, vinyl benzoate, and “BEOBA” (trade name, vinyl ester manufactured by Shell Chemical Co., Ltd.), with alkyl vinyl ether, allyl vinyl ether, vinyl ester, and reactive α,β-unsaturated group-containing organosilicon compounds being preferable.

Among these, those having a high degree of fluorination are preferable, and polytetrafluoroethylene (PTFE), a tetrafluoroethylene-hexafluoropropylene copolymer (FEP), a tetrafluoroethylene-perfluoro(alkyl vinyl ether) copolymer (PFA), an ethylene-tetrafluoroethylene copolymer (ETFE), an ethylene-chlorotrifluoroethylene copolymer (ECTFE), and the like are more preferable. Among these, PTFE, FEP, and PFA are particularly preferable.

As the fluorine-containing resin particles, for example, particles (fluorine resin aqueous dispersion) prepared by a method such as emulsion polymerization of fluorinated monomers may be used in the form of dispersion itself or may be used after washing the particles sufficiently with water, and then drying.

The average particle diameter of the fluorine-containing resin particles is preferably from 0.01 μm to 100 and particularly preferably from 0.03 μm to 5 μm.

Furthermore, the average particle diameter of the fluorine-containing resin particles refers to a value measured using a laser diffraction-type particle diameter distribution measurement device LA-700 (manufactured by Horiba, Ltd.).

As the fluorine-containing resin particles, ones that are commercially available may be used, and examples of the PTFE particles include FLUON L173JE (manufactured by Asahi Glass Co., Ltd.), DANIION THV-221 AZ and DANIION 9205 (both manufactured by Sumitomo 3M Limited), and LUBRON L2 and LUBRON L5 (both manufactured by Daikin Industries, Ltd.).

The fluorine-containing resin particles may be those irradiated with laser light having the oscillation wavelength of an ultraviolet ray band. The laser light irradiated to the fluorine-containing resin particles is not particularly limited, and examples thereof include excimer laser. As the excimer laser light, ultraviolet laser light having a wavelength of 400 nm or less, and particularly from 193 nm to 308 nm is suitable. In particular, KrF excimer laser light (wavelength: 248 nm), ArF excimer laser light (wavelength: 193 nm), and the like are preferable. Irradiation of excimer laser light is usually carried out at room temperature (25° C.) in air, but may also be carried out under an oxygen atmosphere.

Moreover, the irradiation condition for excimer laser light depends on the type of a fluorine resin and the required degree of surface modification, but general irradiation conditions are as follows.

Fluence: 50 mJ/cm²/pulse or more

Incident energy: 0.1 J/cm² or more

Number of shots: 100 or less

Particularly suitable irradiation conditions that are commonly used with for KrF excimer laser light and ArF excimer laser light are as follows.

KrF

Fluence: from 100 mJ/cm²/pulse to 500 mJ/cm²/pulse

Incident energy: from 0.2 J/cm² to 2.0 J/cm²

Number of shots: from 1 to 20

ArF

Fluence: from 50 mJ/cm²/pulse to 150 mJ/cm²/pulse

Incident energy: from 0.1 J/cm² to 1.0 J/cm²

Number of shots: from 1 to 20

The content of the fluorine-containing resin particles is preferably from 1% by weight to 20% by weight, and more preferably from 1% by weight to 12% by weight, based on the total solid content of the protective layer (outermost surface layer).

Fluorine-Containing Dispersant

The film constituting the protective layer (outermost surface layer) may further contain a fluorine-containing dispersant in combination with the fluorine-containing resin particles.

The fluorine-containing dispersant is used to disperse the fluorine-containing resin particles in a protective layer (outermost surface layer), and thus, preferably has a surfactant action, that is, it is preferably a substance having a hydrophilic group and a hydrophobic group in the molecule.

Examples of the fluorine-containing dispersant include a resin formed by the polymerization of the following reactive monomers (hereinafter referred to as a “specific resin”). Specific examples thereof include a random or block copolymer of an acrylate having a perfluoroalkyl group with monomer having no fluorine, a methacrylate homopolymer and a random or block copolymer of an acrylate having the perfluoroalkyl group with the monomer having no fluorine, and a random or block copolymer of a methacrylate with the monomer having no fluorine. Further, examples of the acrylate having a perfluoroalkyl group include 2,2,2-trifluoroethyl methacrylate and 2,2,3,3,3-pentafluoropropyl methacrylate.

Furthermore, examples of the monomer having no fluorine include isobutyl acrylate, t-butyl acrylate, isoctyl acrylate, lauryl acrylate, stearyl acrylate, isobornyl acrylate, cyclohexyl acrylate, 2-methoxyethyl acrylate, methoxytriethylene glycol acrylate, 2-ethoxyethyl acrylate, tetrahydrofurfuryl acrylate, benzyl acrylate, ethylcarbitol acrylate, phenoxyethyl acrylate, 2-hydroxyacrylate, 2-hydroxypropyl acrylate, 4-hydroxybutyl acrylate, methoxypolyethylene glycol acrylate, methoxypolyethylene glycol methacrylate, phenoxypolyethylene glycol acrylate, phenoxypolyethylene glycol methacrylate, hydroxyethyl-o-phenylphenol acrylate, and o-phenylphenol glycidyl ether acrylate. Further, other examples thereof include the block or branch polymers disclosed in the specifications of U.S. Pat. No. 5,637,142, Japanese Patent No. 4251662, and the like. Further, in addition, fluorinated surfactants may also be included. Specific examples of the fluorinated surfactant include SURFLON S-611 and SURFLON S-385 (both manufactured by AGC Seimi Chemical Co., Ltd.), FTERGENT 730FL and FTERGENT 750FL (both manufactured by NEOS Co. , Ltd.), PF-636 and PF-6520 (both manufactured by Kitamura Chemicals Co., Ltd.), MEGAFACE EXP, TF-1507, MEGAFACE EXP, and TF-1535 (all manufactured by DIC Corporation), and FC-4430 and FC-4432 (both manufactured by 3M Corporation).

Furthermore, the weight average molecular weight of the specific resin is preferably from 100 to 50000.

The content of the fluorine-containing dispersant is preferably from 0.1% by weight to 1% by weight, and more preferably from 0.2% by weight to 0.5% by weight, based on the total solid content of the protective layer (outermost surface layer).

As a method for attaching the fluorine-containing dispersant to the surface of the fluorine-containing resin particles, the fluorine-containing dispersant may be directly attached on the surface of the fluorine-containing resin particles, or the monomers are adsorbed on the surface of the fluorine-containing resin particles, and then polymerized to form the specific resin on the surface of the fluorine-containing resin particles.

The fluorine-containing dispersant may be used in combination with other surfactants. However, the amount of the fluorine-containing dispersant is preferably extremely little, and the amount of the other surfactants is preferably from 0 part by weight to 0.1 parts by weight, more preferably from 0 part by weight to 0.05 parts by weight, and particularly preferably from 0 part by weight to 0.03 parts by weight, based on 1 part by weight of the fluorine-containing resin particles.

As the other surfactant, nonionic surfactants are preferable, and examples thereof include polyoxyethylene alkyl ethers, polyoxyethylene alkylphenyl ethers, polyoxyethylene alkylesters, sorbitan alkylesters, polyoxyethylene sorbitan alkylesters, glycerin esters, fluorinated surfactants, and derivatives thereof.

Specific examples of the polyoxyethylenes include EMULGEN 707 (manufactured by Kao Corporation), NAROACTY CL-70 and NAROACTY CL-85 (both manufactured by Sanyo Chemical Industries, Ltd.), and LEOCOL TD-120 (manufactured by Lion Corporation).

Compound Having Unsaturated Bond

For the film constituting the protective layer (outermost surface layer), a compound having an unsaturated bond may be used in combination.

The compound having an unsaturated bond may be any one of a monomer, an oligomer, and a polymer, and may not further have a charge transporting skeleton.

Examples of the compound having an unsaturated bond, which has no charge transporting skeleton, include the following compounds.

Examples of the monofunctional monomers include isobutyl acrylate, t-butyl acrylate, isoctyl acrylate, lauryl acrylate, stearyl acrylate, isobornyl acrylate, cyclohexyl acrylate, 2-methoxyethyl acrylate, methoxytriethylene glycol acrylate, 2-ethoxyethyl acrylate, tetrahydrofurfuryl acrylate, benzyl acrylate, ethylcarbitol acrylate, phenoxyethyl acrylate, 2-hydroxyacrylate, 2-hydroxypropyl acrylate, 4-hydroxybutyl acrylate, methoxypolyethylene glycol acrylate, methoxypolyethylene glycol methacrylate, phenoxypolyethylene glycol acrylate, phenoxypolyethylene glycol methacrylate, hydroxyethyl-o-phenylphenol acrylate, o-phenylphenol glycidyl ether acrylate, and styrene.

Examples of the bifunctional monomers include diethylene glycol di(meth)acrylate, polyethylene glycol di(meth)acrylate, polypropylene glycol di(meth)acrylate, neopentyl glycol di(meth)acrylate, 1,6-hexanediol di(meth)acrylate, divinylbenzene, and diallyl phthalate.

Examples of the trifunctional monomers include trimethylol propane tri(meth)acrylate, pentaerythritol tri(meth)acrylate, aliphatic tri(meth)acrylate, and trivinylcyclohexane.

Examples of the tetrafunctional monomers include pentaerythritol tetra(meth)acrylate, ditrimethylol propanetetra(meth)acrylate, and aliphatic tetra(meth)acrylate.

Examples of the pentafunctional or higher functional monomers include (meth)acrylates having a polyester skeleton, a urethane skeleton, and a phosphagen skeleton, in addition to dipentaerythritol penta(meth)acrylate, and dipentaerythritol hexa(meth)acrylate.

In addition, in the compound having an unsaturated bond, examples of the reactive polymer include those disclosed in, for example, JP-A-5-216249, JP-A-5-323630, JP-A-11-52603, JP-A-2000-264961, and JP-A-2005-2291.

In the case where a compound having an unsaturated bond, which has no charge transporting component, is used, the compounds are used singly or as a mixture of two or more kinds thereof.

The content of the compound having an unsaturated bond, which has no charge transporting component, may be 60% by weight or less, preferably 55% by weight or less, and more preferably 50% by weight or less, based on the total solid content of the composition used to form the protective layer (outermost surface layer).

Non-Reactive Charge Transporting Material

For the film constituting the protective layer (outermost surface layer), a non-reactive charge transporting material may be used in combination. The non-reactive charge transporting material has no reactive group, and accordingly, in the case where the non-reactive charge transporting material is used in the protective layer (outermost surface layer), the concentration of the charge transporting component increases, which is thus effective for further improvement of electrical characteristics. In addition, the non-reactive charge transporting material may be added to reduce the crosslinking density, and thus adjust the strength.

As the non-reactive charge transporting material, a known charge transporting material may be used, and specifically, a triarylamine compound, a benzidine compound, an arylalkane compound, an aryl-substituted ethylene compound, a stilbene compound, an anthracene compound, a hydrazone compound, or the like is used.

Among these, from the viewpoint of charge mobility, compatibility, or the like, it is preferable to have a triphenylamine skeleton.

The amount of the non-reactive charge transporting material used is preferably from 0% by weight to 30% by weight, more preferably from 1% by weight to 25% by weight, and even more preferably from 5% by weight to 25% by weight, based on the total solid content in a coating liquid for forming a layer.

Other Additives

For the film constituting the protective layer (outermost surface layer), a mixture with other coupling agents, particularly, fluorine-containing coupling agents may be used for the purpose of further adjusting film formability, flexibility, lubricating property, and adhesiveness. As these compounds, various silane coupling agents and commercially available silicone hard coat agents are used. In addition, a silicon compound or a fluorine-containing compound, which contain a radical polymerizable group, may be used.

Examples of the silane coupling agent include vinyltrichlorosilane, vinyltrimethoxysilane, vinyltriethoxysilane, 3-glycidoxypropylmethyldiethoxysilane, 3-glycidoxypropyltriethoxysilane, 3-glycidoxypropyltrimethoxysilane, 3-aminopropyltriethoxysilane, 3-aminopropyltrimethoxysilane, 3-aminopropylmethyldimethoxysilane, N-2(aminoethyl)-3-aminopropyltriethoxysilane, tetramethoxysilane, methyltrimethoxysilane, and dimethyldimethoxysilane.

Examples of the commercially available hard coat agent include KP-85, X-40-9740, and X-8239 (all manufactured by Shin-Etsu Chemical Co., Ltd.), and AY42-440, AY42-441, and AY49-208 (all manufactured by Dow Corning Toray Co., Ltd.).

In addition, in order to impart water repellency, a fluorine-containing compound such as (tridecafluoro-1,1,2,2-tetrahydrooctyl)triethoxysilane, (3,3,3-trifluoropropyl)trimethoxysilane, 3-(heptafluoroisopropoxy)propyltriethoxysilane, 1H,1H,2H,2H-perfluoroalkyltriethoxysilane, 1H,1H,2H,2H-perfluorodecyltriethoxysilane, and 1H,1H,2H,2H-perfluorooctyltriethoxysilane may be added.

The silane coupling agent may be used in a desired amount, but the amount of the fluorine-containing compound is preferably 0.25 times or less by weight, based on the compound containing no fluorine from the viewpoint of the film formability of the crosslinked film. In addition, a reactive fluorine compound disclosed in JP-A-2001-166510 or the like may be mixed.

Examples of the silicon compound or fluorine-containing compound, which contains a radical polymerizable group, include the compounds described in JP-A-2007-11005.

A deterioration inhibitor is preferably added for the film constituting the protective layer (outermost surface layer). Preferable examples of the deterioration inhibitor include hindered phenol deterioration inhibitors and hindered amine deterioration inhibitors, and known antioxidants such as organic sulfur antioxidants, phosphite antioxidants, dithiocarbamate antioxidants, thiourea antioxidants, benzoimidazole antioxidants, and the like may be used.

The amount of the deterioration inhibitor to be added is preferably 20% by weight or less, and more preferably 10% by weight or less.

Examples of the hindered phenol antioxidant include IRGANOX 1076, IRGANOX 1010, IRGANOX 1098, IRGANOX 245, IRGANOX 1330, IRGANOX 3114, and IRGANOX 1076 (all manufactured by Ciba Japan), and 3,5-di-t-butyl-4-hydroxybiphenyl

Examples of the hindered amine antioxidants include SANOL LS2626, SANOL LS765, SANOL LS770, and SANOL LS744 (all manufactured by Sankyo Lifetech Co., Ltd.), TINUVIN 144 and TINUVIN 622LD (both manufactured by Ciba Japan), and MARK LA57, MARK LA67, MARK LA62, MARK LA68, and MARK LA63 (all manufactured by Adeka Corporation); examples of the thioether antioxidants include SUMILIZER TPS and SUMILIZER TP-D (all manufactured by Sumitomo Chemical Co., Ltd.); and examples of the phosphite antioxidants include MARK 2112, MARK PEP-8, MARK PEP-24G, MARK PEP-36, MARK 329K, and MARK HP-10 (all manufactured by Adeka Corporation).

Conductive particles, organic particles, or inorganic particles may be added for the film constituting the protective layer (outermost surface layer).

Examples of the particles include silicon-containing particles. The silicon-containing particles refer to particles which include silicon as a constitutional element, and specific examples thereof include colloidal silica and silicone particles. The colloidal silica used as the silicon-containing particles is selected from those prepared by dispersing silica having an average particle diameter of preferably from 1 nm to 100 nm, more preferably from 10 nm to 30 nm, in an acidic or alkaline aqueous dispersion or in an organic solvent such as an alcohol, a ketone, and an ester. As the particles, generally commercially available ones may be used.

The solid content of the colloidal silica in the protective layer is not particularly limited, but it is used in an amount in the range of 0.1% by weight to 50% by weight, and preferably from 0.1% by weight to 30% by weight, based on the total solid content of the protective layer.

The silicone particles used as the silicon-containing particles are selected from silicone resin particles, silicone rubber particles, and treated silica particles whose surfaces have been treated with silicone, and commercially available silicone particles may be used.

These silicone particles are spherical, and the average particle diameter is preferably from 1 nm to 500 nm, and more preferably from 10 nm to 100 nm.

The content of the silicone particles in the surface layer is preferably from 0.1% by weight to 30% by weight, and more preferably from 0.5% by weight to 10% by weight, based on the total amount of the total solid content of the protective layer.

In addition, examples of other particles include semiconductive metal oxides such as ZnO—Al₂O₃, SnO₂—Sb₂O₃, In₂O₃—SnO₂, ZnO₂—TiO₂, MO—TiO₂, MgO—Al₂O₃, FeO—TiO₂, TiO₂, SnO₂, In₂O₃, ZnO, and MgO. Further, various known dispersant materials may be used to disperse the particles.

Oils such as a silicone oil may be added for the film constituting the protective layer (outermost surface layer).

Examples of the silicone oil include silicone oils such as dimethylpolysiloxane, diphenylpolysiloxane, and phenylmethylsiloxane; reactive silicone oils such as amino-modified polysiloxane, epoxy-modified polysiloxane, carboxylic-modified polysiloxane, carbinol-modified polysiloxane, methacryl-modified polysiloxane, mercapto-modified polysiloxane, and phenol-modified polysiloxane; cyclic dimethylcyclosiloxanes such as hexamethylcyclotrisiloxane, octamethylcyclotetrasiloxane, decamethylcyclopentasiloxane, and dodecamethylcyclohexasiloxane; cyclic methylphenylcyclosiloxanes such as 1,3,5-trimethyl-1,3,5-triphenylcyclotrisiloxane, 1,3,5,7-tetramethyl-1,3,5,7-tetraphenylcyclotetrasiloxane, and 1,3,5,7,9-pentamethyl-1,3,5,7,9-pentaphenylcyclopentasiloxane; cyclic phenylcyclosiloxanes such as hexaphenylcyclotrisiloxane; fluorine-containing cyclosiloxanes such as 3-(3,3,3-trifluoropropyl)methylcyclotrisiloxane; hydrosilyl group-containing cyclosiloxanes such as a methylhydrosiloxane mixture, pentamethylcyclopentasiloxane, and phenylhydrocyclosiloxane; and vinyl group-containing cyclosiloxanes such as pentavinylpentamethylcyclopentasiloxane.

In order to improve the wettablility of the coating film, a silicone-containing oligomer, a fluorine-containing acryl polymer, a silicone-containing polymer, or the like may be added for the film constituting the protective layer (outermost surface layer).

A metal, a metal oxide, carbon black, or the like may be added for the film constituting the protective layer (outermost surface layer). Examples of the metal include aluminum, zinc, copper, chromium, nickel, silver and stainless steel, and resin particles having any of these metals deposited on the surface thereof. Examples of the metal oxide include zinc oxide, titanium oxide, tin oxide, antimony oxide, indium oxide, bismuth oxide, indium oxide on which tin has been doped, tin oxide having antimony or tantalum doped thereon, and zirconium oxide having antimony doped thereon.

These may be used singly or in combination of two or more kinds thereof. When two or more kinds are used in combination, they may be simply mixed or formed into a solid solution or a fused product. The average particle diameter of the conductive particles is 0.3 μm or less, and particularly preferably 0.1 μm or less.

Composition

The composition used to form a protective layer is preferably prepared as a coating liquid for forming a protective layer, including the respective components dissolved or dispersed in the solvent.

Specific examples of the solvent of the coating liquid for forming a protective layer include singular or mixed solvents of ketones such as methylethyl ketone, methylisobutyl ketone, diisopropyl ketone, diisobutyl ketone, ethyl-n-butyl ketone, di-n-propyl ketone, methyl-n-amyl ketone, methyl-n-butyl ketone, diethyl ketone, and methyl-n-propyl ketone; esters such as isopropyl acetate, isobutyl acetate, ethyl acetate, n-propyl acetate, n-butyl acetate, ethyl isovalerate, isoamyl acetate, isopropyl butyrate, isoamyl propionate, butyl butyrate, amyl acetate, butyl propionate, ethyl propionate, methyl acetate, methyl propionate, and allyl acetate. Further, 0% by weight to 50% by weight of an ether solvent (for example, diethyl ether, dioxane, diisopropyl ether, cyclopentyl methyl ether, and tetrahydrofuran), and an alkylene glycol solvent (for example, 1-methoxy-2-propanol, 1-ethoxy-2-propanol, ethylene glycol monoisopropyl ether, and propylene glycol monomethyl ether acetate) may be mixed for use.

Examples of the method of dispersing the fluorine-containing resin particles in the coating liquid for forming a protective layer include dispersing methods using a media dispersing machine such as a ball mill, a vibrating ball mill, an attritor, a sand mill, and a horizontal sand mill; and a medialess dispersing machine such as a stirrer, an ultrasonic dispersing machine, a roll mill, and a high-pressure homogenizer. Further, examples of the dispersing method as a high-pressure homogenizer include dispersing methods using a collision system in which the particles are dispersed by causing the dispersion to collide against liquid or against walls under a high pressure, and a penetration system in which the particles are dispersed by causing the dispersion to penetrate through a fine flow path under a high pressure.

Moreover, the method for preparing the coating liquid for forming a protective layer is not particularly limited, and the coating liquid for forming a protective layer may be prepared by mixing a charge transporting material, fluorine-containing resin particles, a fluorine-containing dispersant, and if necessary, other components such as a solvent, and using the above-described dispersing machine, or may be prepared by separately preparing two liquids of a mixed liquid A including fluorine-containing resin particles, a fluorine-containing dispersant, and a solvent, and a mixed liquid B including at least a charge transporting material and a solvent, and then mixing the mixed liquids A and B. By mixing the fluorine-containing resin particles and a fluorine-containing dispersant in a solvent, the fluorine-containing dispersant is easily attached to the surface of the fluorine-containing resin particles.

In addition, when the above-described components are reacted with each other to obtain a coating liquid for forming a protective layer, the respective components may be simply mixed and dissolved, but alternatively, the components may be preferably warmed under the conditions of a temperature of from room temperature (20° C.) to 100° C., and more preferably from 30° C. to 80° C., and a time of preferably from 10 minutes to 100 hours, and more preferably from 1 hour to 50 hours. Further, it is also preferable to irradiate ultrasonic waves.

Formation of Protective Layer

The coating liquid for forming a protective layer is coated on a surface to be coated (charge transport layer), by an ordinary method such as a blade coating method, a wire bar coating method, a spraying method, a dip coating method, a bead coating method, an air knife coating method, a curtain coating method, and an ink jet coating method.

Thereafter, light, an electron beam, or heat is applied to the obtained film to induce radical polymerization, and thus, polymerize and cure the coating film.

For the curing method, heat, light, radiation, or the like is used. In the case where curing is carried out using heat and light, a polymerization initiator is not necessarily required, but a photocuring catalyst or a thermal polymerization initiator may be used. As the photocuring catalyst and the thermal polymerization initiator, a known photocuring catalyst or thermal polymerization initiator is used. As the radiation, an electron beam is preferable.

Electron Beam Curing

In the case of using electron beam, the accelerating voltage is preferably 300 kV or less, and most preferably 150 kV or less. Further, the radiation dose is preferably in the range of 1 Mrad to 100 Mrad, and more preferably in the range of 3 Mrad to 50 Mrad. If the accelerating voltage is 300 kV or less, the damage of electron beam irradiation to the photoreceptor characteristics is prevented. Further, if the radiation dose is 1 Mrad or more, the crosslinking is carried out sufficiently, and thus, the radiation dose of 100 Mrad or less prevents deterioration of the photoreceptor.

The irradiation is carried out under an inert gas atmosphere such as nitrogen and argon, at an oxygen concentration of 1000 ppm or less, and preferably 500 ppm or less, and further, heating may be carried out during the irradiation or after the irradiation, at a temperature of 50° C. to 150° C.

Photocuring

As a light source, a high pressure mercury lamp, a low pressure mercury lamp, a metal halide lamp, or the like is used, and a suitable wavelength may be selected by using a filter such as a band-pass filter. Although the irradiation time and the light intensity are arbitrarily selected, for example, the illumination (365 nm) is preferably from 300 mW/cm² to 1000 mW/cm², and for example, in the case of carrying out irradiation with UV light at 600 mW/cm², the duration of the irradiation may be from 5 seconds to 360 seconds.

The irradiation is carried out under an inert gas atmosphere of nitrogen and argon, at an oxygen concentration of 1000 ppm or less, and preferably 500 ppm or less, and heating may be carried out at a temperature from 50° C. to 150° C. during irradiation or after irradiation.

Examples of the photocuring catalyst include an intramolecular cleavage type photocuring catalyst, such as a benzyl ketal photocuring catalyst, an alkylphenone photocuring catalyst, an aminoalkylphenone photocuring catalyst, a phosphine oxide photocuring catalyst, a titanocene photocuring catalyst, and an oxime photocuring catalyst.

More specifically, example of the benzyl ketal photocuring catalyst include 2,2-dimethoxy-1,2-diphenylethan-1-one.

Moreover, examples of the alkylphenone photocuring catalyst include 1-hydroxy-cyclohexyl-phenyl-ketone, 2-hydroxy-2-methyl-1-phenyl-propan-1-one, 1-[4-(2-hydroxyethoxy)-phenyl]-2-hydroxy-2-methyl-1-propan-1-one, 2-hydroxy-1-{4-[4-(2-hydroxy-2-methylpropionyl)-benzyl]phe nyl}-2-methyl-propan-1-one, acetophenone, and 2-phenyl-2-(p-toluenesulfonyloxy)acetophenone.

Examples of the aminoalkylphenone photocuring catalyst include p-dimethylaminoacetophenone, p-dimethylaminopropiophenone, 2-methyl-1-(4-methylthiophenyl)-2-morpholinopropan-1-one, and 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone.

Examples of the phosphine oxide photocuring catalyst include 2,4,6-trimethylbenzoyl-diphenyl phosphinoxide and bis (2,4,6-trimethylbenzoyl)phenyl phosphineoxide.

Examples of the titanocene photocuring catalyst include bis (η5-2,4-cyclopentadien-1-yl)-bis(2,6-difluoro-3-(1H-pyrrol-1-yl)-phenyl)titanium.

Examples of the oxime photocuring catalyst include 1,2-octanedione, 1-[4-(phenylthio)-, 2-(O-benzoyloxime), ethanone, 1-[9-ethyl-6-(2-methylbenzoyl)-9H-carbazol-3-yl]-, 1-(O-acetyloxime).

Examples of the hydrogen abstraction type photocuring catalyst include a benzophenone photocuring catalyst, a thioxanthone photocuring catalyst, a benzyl photocuring catalyst, and a Michler's ketone photocuring catalyst.

More specifically, examples of the benzophenone photocuring catalyst include 2-benzoyl benzoic acid, 2-chlorobenzophenone, 4,4′-dichlorobenzo-phenone, 4-benzoyl-4′-methyldiphenyl sulfide, and p,p′-bisdiethylaminobenzophenone.

Examples of the thioxanthone photocuring catalyst include 2,4-diethylthioxanthen-9-one, 2-chlorothioxanthone, and 2-isopropylthioxanthone.

Example of the benzyl photocuring catalyst include benzyl, (±)-camphor-quinone, and p-anisyl.

These photopolymerization initiators are used singly or in combination of two or more kinds thereof.

Thermal Curing

Examples of the thermal polymerization initiator include thermal radical generators or derivatives thereof, specifically, for example, an azo initiator such as V-30, V-40, V-59, V601, V65, V-70, VF-096, VE-073, Vam-110, and Vam-111 (all manufactured by Wako Pure Chemicals Industries, Ltd.), and OTazo-15, OTazo-30, AIBN, AMBN, ADVN, and ACVA (all manufactured by Otsuka Chemical Co., Ltd.); and Pertetra A, Perhexa HC, Perhexa C, Perhexa V, Perhexa 22, Perhexa MC, Perbutyl H, Percumyl H, Percumyl P, Permenta H, Perocta H, Perbutyl C, Perbutyl D, Perhexyl D, Peroyl IB, Peroyl 355, Peroyl L, Peroyl SA, NYPER BW, NYPER-BMT-K40/M, Peroyl IPP, Peroyl NPP, Peroyl TCP, Peroyl OPP, Peroyl SBP, Percumyl ND, Perocta ND, Perhexyl ND, Perbutyl ND, Perbutyl NHP, Perhexyl PV, Perbutyl PV, Perhexa 250, Perocta O, Perhexyl O, Perbutyl O, Perbutyl L, Perbutyl 355, Perhexyl I, Perbutyl I, Perbutyl E, Perhexa 25Z, Perbutyl A, Perhexyl Z, Perbutyl ZT, and Perbutyl Z (all manufactured by NOF CORPORATION), Kayaketal AM-C55, Trigonox 36-C75, Laurox, Perkadox L-W75, Perkadox CH-50L, Trigonox TMBH, Kaya cumen H, Kaya butyl H-70, Perkadox BC-FF, Kaya hexa AD, Perkadox 14, Kaya butyl C, Kaya butyl D, Kaya hexa YD-E85, Perkadox 12-XL25, Perkadox 12-EB20, Trigonox 22-N70, Trigonox 22-70E, Trigonox D-T50, Trigonox 423-C70, Kaya ester CND-C70, Kaya ester CND-W50, Trigonox 23-C70, Trigonox23-W50N, Trigonox 257-C70, Kaya ester P-70, Kaya ester TMPO-70, Trigonox 121, Kaya ester O, Kaya ester HTP-65W, Kaya ester AN, Trigonox 42, Trigonox F-050, Kaya butyl B, Kaya carbon EH-C70, Kaya carbon EH-W60, Kaya carbon 1-20, Kaya carbon BIC-75, Trigonox 117, and Kayaren 6-70 (all manufactured by Kayaku Akzo), Luperox 610, Luperox 188, Luperox 844, Luperox 259, Luperox 10, Luperox 701, Luperox 11, Luperox 26, Luperox 80, Luperox 7, Luperox 270, Luperox P, Luperox 546, Luperox 554, Luperox 575, Luperox TANPO, Luperox 555, Luperox 570, Luperox TAP, Luperox TBIC, Luperox TBEC, Luperox JW, Luperox TRIC, Luperox TAEC, Luperox DC, Luperox 101, Luperox F, Luperox DI, Luperox 130, Luperox 220, Luperox 230, Luperox 233, and Luperox 531 (all manufactured by ARKEMA Yoshitomi).

Among these, by using an azo polymerization initiator having a molecular weight of 250 or more, a reaction proceeds without unevenness at a low temperature, and thus, it is promoted to form a high-strength film having a suppressed unevenness. More suitably, the molecular weight of the azo polymerization initiator is 250 or more, and still more suitably 300 or more.

Heating is carried out in an inert gas atmosphere such as nitrogen and argon, at an oxygen concentration of 1000 ppm or less, and preferably 500 ppm or less, and furthermore, at a temperature of preferably 50° C. to 170° C., more preferably 70° C. to 150° C., for a period of preferably 10 minutes to 120 minutes, and more preferably 15 minutes to 100 minutes.

The total content of the photocuring catalyst or the thermal polymerization initiator is preferably in the range of 0.1% by weight to 10% by weight, more preferably 0.1% by weight to 8% by weight, and particularly preferably 0.1% by weight to 5% by weight, based on the total solid content of the dissolution liquid for forming a layer.

In addition, it is difficult to attain structural relaxation of the coating film due to crosslinking where the reaction proceeds too quickly, thus, easily causing unevenness and wrinkles of the film. As a result, a curing method by heat, in which generation of radicals occurs relatively slowly is adopted in the present exemplary embodiment.

In particular, by combining specific reactive charge transporting material with curing by heat, the structural relaxation of the coating film is further promoted, and a protective layer (outermost surface layer) having excellent surface properties and states is easily obtained.

The film thickness of the protective layer is set within a range of preferably from 3 μm to 40 μm, and more preferably from 5 μm to 35 μm.

As described above, the configuration of each layer in the function separating type photosensitive layer is described with reference to the electrophotographic photoreceptor shown in FIG. 1, but the same configuration as above may also be employed for each layer in the function separating type electrophotographic photoreceptor shown in FIG. 2. Further, in the case of the single layer type photosensitive layer of the electrophotographic photoreceptor shown in FIG. 3, the following embodiments are preferable.

That is, the single layer type photosensitive layer (charge generating/charge transport layer) is preferably composed of a charge generating material and a charge transporting material, and if necessary, a binder resin and other well-known additives. Further, these materials are the same as the materials described for the charge generating material and the charge transport layer.

Furthermore, the content of the charge generating materials in the single layer type photosensitive layer is preferably from 10% by weight to 85% by weight, and more preferably from 20% by weight to 50% by weight, based on the total solid content. Further, the content of the charge transporting material in the single layer type photosensitive layer is preferably from 5% by weight to 50% by weight, based on the total solid content.

The method for forming the single layer type photosensitive layer is the same as the method for formig a charge generating layer or a charge transport layer.

The film thickness of the single layer type photosensitive layer is, for example, preferably from 5 μm to 50 μm, and more preferably from 10 μm to 40 μm.

Furthermore, for the electrophotographic photoreceptor according to the present exemplary embodiment, an embodiment in which the outermost surface layer is a protective layer is described, but an embodiment in which there is no protective layer is also available.

In the case of a layer configuration having no protective layer, in the electrophotographic photoreceptor shown in FIG. 1, the charge transport layer positioned on the outermost surface in the layer configuration becomes an outermost surface layer. Further, the charge transport layer which becomes the outermost surface layer is composed of a cured film of the specific composition.

Furthermore, in the case of a layer configuration having no protective layer, in the electrophotographic photoreceptor shown in FIG. 3, the single layer type photosensitive layer positioned on the outermost surface in the layer configuration becomes an outermost surface layer. Further, the single layer type photosensitive layer which becomes the outermost surface layer is composed of a cured film of the specific composition. However, the charge generating material is incorporated into the composition.

Image Forming Apparatus (and Process Cartridge)

The image forming apparatus according to the present exemplary embodiment is provided with an electrophotographic photoreceptor, a charging unit that charges the surface of the electrophotographic photoreceptor, an electrostatic latent image forming unit that forms an electrostatic latent image on the surface of the charged electrophotographic photoreceptor, a developing unit that develops the electrostatic latent image formed on the surface of the electrophotographic photoreceptor by a developer including a toner to forma toner image, and a transfer unit that transfers the toner image onto a surface of a recording medium. Further, the electrophotographic photoreceptor according to the present exemplary embodiment is applied as the electrophotographic photoreceptor.

The image forming apparatus according to the present exemplary embodiment may be provided with a supply means that supplies zinc stearate to the surface of the electrophotographic photoreceptor.

Examples of the supply unit include a developing unit accommodating a developer having toner particles and an external additive containing zinc stearate, and a coating unit that coats zinc stearate on the surface of the electrophotographic photoreceptor, which is provided between a transfer unit and a cleaning unit, separated from the developing unit. One or both of these units may be provided. Further, in the case of employing a developing unit storing a developer having toner particles and an external additive including zinc stearate, the developing unit also functions as a supply unit.

As the image forming apparatus according to the present exemplary embodiment, known image forming apparatuses provided with a device including a fixing unit that fixes a toner image transferred to the surface of a recording medium; a direct transfer type device that directly transfers the toner image formed on the surface of the electrophotographic photoreceptor to a recording medium; an intermediate transfer type device that primarily transfers the toner image formed on the surface of an intermediate transfer member, and secondarily transfers the toner image transferred to the surface of the intermediate transfer member to the surface of the recording medium; a device provided with a cleaning unit that cleans the surface of the electrophotographic photoreceptor before charging, after the transfer of the toner image; a device provided with a charge erasing unit that erases charges by irradiating charge erasing light onto the surface of an image holing member before charging, after the transfer of the toner image; a device provided with an electrophotographic photoreceptor heating unit that increases the temperature of the electrophotographic photoreceptor to reduce the relative temperature; and the like are applied.

In the case of the intermediate transfer type device case, for the transfer unit, for example, a configuration in which an intermediate transfer member to the surface of which the toner image is transferred, a first transfer unit that primarily transfers a toner image formed on the surface of an image holding member to the surface of the intermediate transfer member, and a secondary transfer unit that secondarily transfers the toner image transferred to the surface of the intermediate transfer member to the surface of the surface of a recording medium is applied.

The image forming apparatus according to the present exemplary embodiment is any one of a dry development type image forming apparatus and a wet development type (development type using a liquid developer) image forming apparatus.

Furthermore, in the image forming apparatus according to the present exemplary embodiment, for example, a part provided with the electrophotographic photoreceptor may be a cartridge structure (process cartridge) that is detachable from an image forming apparatus. As the process cartridge, for example, a process cartridge including the electrophotographic photoreceptor according to the present exemplary embodiment is suitably used. Further, the process cartridge may include, in addition to the electrophotographic photoreceptor, for example, at least one selected from the group consisting of a charging means, an electrostatic latent image forming unit, a developing unit, and a transfer unit.

Hereinafter, one example of the image forming apparatuses according to the present exemplary embodiment is shown, but the present invention is not limited thereto. Further, the main parts shown in the figures are described, and explanation of the others will be omitted.

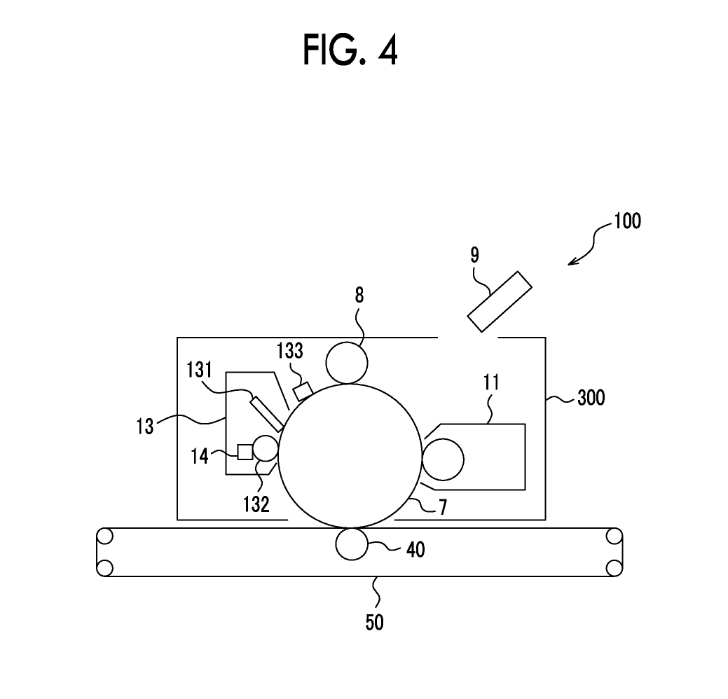

FIG. 4 is a schematic structural view showing an example of the image forming apparatus according to the present exemplary embodiment.

The image forming apparatus 100 according to the present exemplary embodiment is provided with a process cartridge 300 provided with an electrophotographic photoreceptor 7 as shown in FIG. 4, an exposure device 9 (one example of the electrostatic latent image forming unit), a transfer device (primary transfer device), and an intermediate transfer member 50. Further, in the image forming apparatus 100, the exposure device 9 is arranged at a position where the exposure device 9 may radiate light onto the electrophotographic photoreceptor 7 through an opening in the process cartridge 300, and the transfer device 40 is arranged at a position opposite to the electrophotographic photoreceptor 7 by the intermediary of the intermediate transfer member 50. The intermediate transfer member 50 is arranged to contact partially the electrophotographic photoreceptor 7. Further, although not shown in the figure, the apparatus also includes a secondary transfer device that transfers a toner image transferred onto the intermediate transfer member 50 to a recording medium (for example, paper). Further, the intermediate transfer member 50, the transfer device 40 (primary transfer device), and the secondary transfer device (not shown) correspond to an example of the transfer unit.

The process cartridge 300 in FIG. 4 supports, in a housing, the electrophotographic photoreceptor 7, a charging device 8 (one example of the charging unit), a developing device 11 (one example of the developing unit), and a cleaning device 13 (one example of the cleaning unit) as a unit. The cleaning device 13 has a cleaning blade (one example of the cleaning member) 131, and the cleaning blade 131 is arranged so as to be in contact with the surface of the electrophotographic photoreceptor 7. Further, the cleaning member is not an embodiment of the cleaning blade 131, may be a conductive or insulating fibrous member, and may be used singly or in combination with the cleaning blade 131.

Moreover, FIG. 4 shows an example in which a fibrous member 132 (in a roll form) that supplies a lubricant material 14 onto the surface of the photoreceptor 7 is provided, as a supply unit that supplies zinc stearate to the surface of the electrophotographic photoreceptor 7 for an image forming apparatus, but the fibrous member 132 may be arranged, as desired. Further, an example in which a fibrous member 133 (in a flat brush form) assisting in cleaning is provided is also shown, but the fibrous member 133 may be arranged, as desired.

Hereinafter, the respective configurations of the image forming apparatus according to the present exemplary embodiment will be described.

Charging Device

As the charging device 8, for example, used is a contact type charging device using a charging roll, a charging brush, a charging film, a charging rubber blade, a charging tube, or the like, each of which is conductive or semiconductive. Further, known charging devices themselves, such as a non-contact type roller charging device, and a scorotron charging device and a corotron charging device, each using corona discharge are also used.

Exposure Device

The exposure device 9 may be an optical instrument for exposure of the surface of the electrophotographic photoreceptor 7, to rays such as a semiconductor laser ray, an LED ray, and a liquid crystal shutter ray according to an image data. The wavelength of the light source may be a wavelength in the range of the spectral sensitivity wavelengths of the electrophotographic photoreceptor. As the wavelengths of semiconductor lasers, near infrared wavelengths that are laser-emission wavelengths near 780 nm are predominant. However, the wavelength of the laser ray to be used is not limited to such a wavelength, and a laser having an emission wavelength of 600 nm range, or a laser having any emission wavelength in the range of 400 nm to 450 nm may be used as a blue laser. In order to form a color image, it is effective to use a planar light emission type laser light source capable of attaining a multi-beam output.

Developing Device

As the developing device 11, for example, a common developing device, in which a developer is contacted or not contacted for forming an image, may be used. Such a developing device 11 is not particularly limited as long as it has the above-described functions, and may be appropriately selected according to the intended use. Examples thereof include a known developing device in which the single-component or two-component developer is applied to the electrophotographic photoreceptor 7 using a brush or a roller. Among these, the developing device using developing roller retaining developer on the surface thereof is preferable.

The developer used in the developing device 11 may be a single-component developer formed of a toner singly or a two-component developer formed of a toner and a carrier. Further, the toner may be magnetic or non-magnetic. As the developer, known ones may be applied.

Cleaning Device

As the cleaning device 13, a cleaning blade type device provided with the cleaning blade 131 is used.

Further, in addition to the cleaning blade type, a fur brush cleaning type and a type of performing developing and cleaning at once may also be employed.

Transfer Device

Examples of transfer device 40 include known transfer charging devices themselves, such as a contact type transfer charging device using a belt, a roller, a film, a rubber blade, or the like, a scorotron transfer charging device utilizing corona discharge, and a corotron transfer charging device utilizing corona discharge.

Intermediate Transfer Member

As the intermediate transfer member 50, a form of a belt (intermediate transfer belt) composed of polyimide, polyamideimide, polycarbonate, polyarylate, polyester, rubber, or the like, which is imparted with the semiconductivity, is used. In addition, the intermediate transfer member may also take the form of a drum, in addition to the form of a belt.

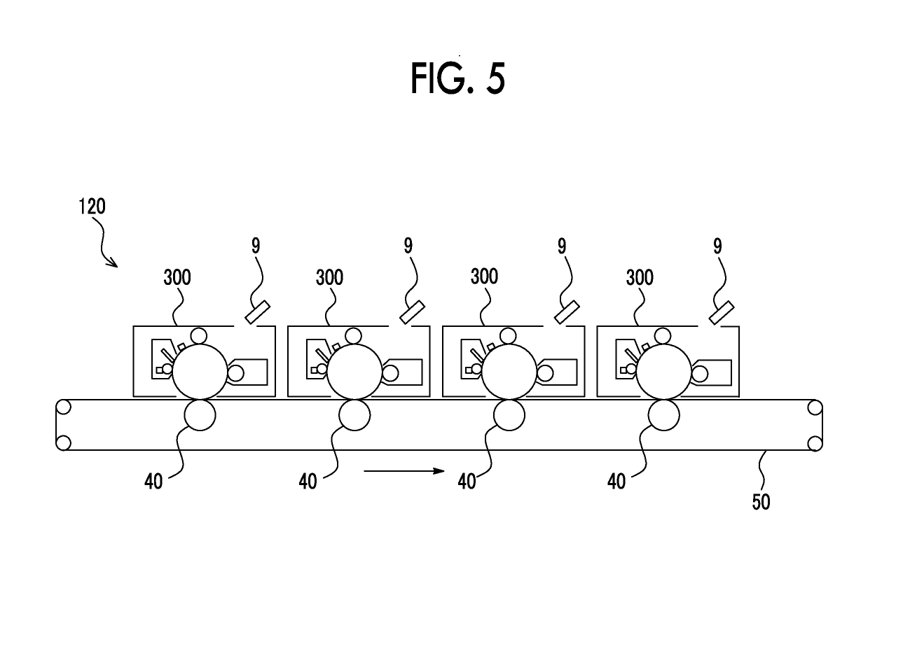

FIG. 5 is a schematic structural view showing another example of the image forming apparatus according to the present exemplary embodiment.

The image forming apparatus 120 shown in FIG. 5 is a tandem type full color image forming apparatus equipped with four process cartridges 300. In the image forming apparatus 120, four process cartridges 300 are disposed parallel with each other on the intermediate transfer member 50, and one electrophotographic photoreceptor may be used for one color. Further, the image forming apparatus 120 has the same configuration as the image forming apparatus 100, except that it is a tandem type.

Moreover, the image forming apparatus according to the present exemplary embodiment (process cartridge) as described above is not limited to the configurations above, known configurations may be applied.

### EXAMPLES

Hereinafter, the invention will be described in detail with reference to Examples below, but the invention is not limited thereto.

### Example 1

### Preparation of Electrophotographic Photoreceptor 1

Preparation of Undercoat Layer

100 parts by weight of zinc oxide (average particle diameter: 70 nm, manufactured by Tayca Corporation, specific surface area: 15 m²/g) is stirred and mixed with 500 parts by weight of toluene while stirring, and 1.3 parts by weight of a silane coupling agent (KBM503: manufactured by Shin-Etsu Chemical Co., Ltd.) is added thereto, followed by stirring for 2 hours. Subsequently, toluene is removed by distillation under reduced pressure and baked at a temperature of 120° C. for 3 hours to obtain zinc oxide having a surface treated with the silane coupling agent.

110 parts by weight of the surface-treated zinc oxide is stirred and mixed with 500 parts by weight of tetrahydrofuran, and then a solution having 0.6 parts by weight of alizarin dissolved in 50 parts by weight of tetrahydrofuran is added thereto, followed by stirring at a temperature of 50° C. for 5 hours. Subsequently, the zinc oxide to which the alizarin is added is collected by filtration under a reduced pressure, and dried under reduced pressure at a temperature of 60° C. to obtain alizarin-attached zinc oxide.

38 parts by weight of a solution prepared by dissolving 60 parts by weight of the alizarin-added zinc oxide, 13.5 parts by weight of a curing agent (blocked isocyanate, Sumidur 3175, manufactured by Sumitomo-Bayer Urethane Co., Ltd.) and 15 parts by weight of a butyral resin (S-Lec BM-1, manufactured by Sekisui Chemical Co., Ltd.) in 85 parts by weight of methyl ethyl ketone is mixed with 25 parts by weight of methyl ethyl ketone. The mixture is dispersed using a sand mill with glass beads having a diameter of 1 mmφ for 2 hours to obtain a dispersion.

0.005 part by weight of dioctyl tin dilaurate as a catalyst, and 40 parts by weight of silicone resin particles (Tospal 145, manufactured by GE Toshiba Silicone Co., Ltd.) are added to the dispersion to obtain a coating liquid for forming an undercoat layer.

An undercoat layer having a thickness of 18.7 μm is obtained by coating the coating liquid on a cylindrical aluminum substrate having a diameter of 30 mm, a length of 340 mm and a thickness of 1 mm as a conductive substrate by dip coating, and drying to cure at a temperature of 170° C. for 40 minutes.

Preparation of Charge Generating Layer

A mixture including 15 parts by weight of hydroxygallium phthalocyanine having the diffraction peaks at least at the positions at 7.3°, 16.0°, 24.9°, and 28.0° of Bragg angles) (2θ±0.2°) in an X-ray diffraction spectrum of Cukα characteristic X rays as a charge generating material, 10 parts by weight of a vinyl chloride-vinyl acetate copolymer resin (VMCH, manufactured by Nippon Unicar Co., Ltd.) as a binder resin, and 200 parts by weight of n-butyl acetate is dispersed using a sand mill with the glass beads having a diameter of 1 mmφ for 4 hours. 175 parts by weight of n-butyl acetate and 180 parts by weight of methyl ethyl ketone are added to the obtained dispersion, followed by stirring to obtain a coating liquid for forming a charge generating layer.

The obtained coating liquid for forming a charge generating layer is dip-coated on the undercoat layer formed in advance on the cylindrical aluminum support, and dried at an ordinary temperature (25° C.) to forma charge generating layer having a film thickness of 0.2 μm.

Preparation of Charge Transport Layer

50 parts by weight of compound (d-1) as a non-reactive charge transporting material, and 55 parts by weigh of a resin (c-1) as a binder resin [a polycarbonate copolymer synthesized by a preparation method as described below] are added to 560 parts by weight of tetrahydrofuran and 240 parts by weight of toluene and dissolved therein to obtain a coating liquid for a charge transport layer. This coating liquid is coated on the charge generating layer and dried at 135° C. for 45 minutes to form a charge transport layer having a film thickness of 25 μm.

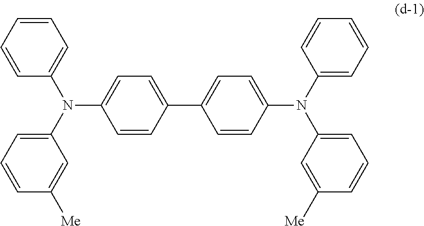 [SMILES: Cc1cccc(N(c2ccccc2)c2ccc(-c3ccc(N(c4ccccc4)c4cccc(C)c4)cc3)cc2)c1]

Preparation of Protective Layer

Next, 5 parts by weight of LUBRON L2 (manufactured by Daikin Industries, Ltd.) and 0.2 parts by weight of a fluorine graft polymer (ARON GF300: manufactured by Toagosei Co., Ltd.) are subjected to a dispersion treatment repeatedly three times for 10 minutes each in an ultrasonic homogenizer (manufactured by Nissei Corporation) in a thermostat at 20° C., together with 300 parts by weight of a mixed solvent THF/isobutyl acetate (weight ratio of 7:3) to obtain a suspension. To the suspension are added 100 parts by weight of a compound (a-11) as a reactive charge transporting material and 2 parts by weight of VE-073 (manufactured by Wako Pure Chemicals Industries, Ltd.) as a polymerization initiator. Further, particles (b-1) having a content in the protective layer of 5% by weight (the amount based on the solid content of the protective layer) as the particles other than fluorine-containing resin particles are added thereto, followed by stirring and mixing at room temperature (25° C.) for 12 hours, to obtain a coating liquid for forming a protective layer.

The obtained coating liquid is coated on the charge transport layer previously formed on a cylindrical aluminum support at an extrusion rate of 150 mm/min by a ring coating method. Thereafter, a curing reaction is carried out at a temperature of 160±5° C. for a period of 60 minutes in the state of an oxygen concentration of 200 ppm or less in a nitrogen dryer having an oxygen concentration system to form a protective layer. The film thickness of the protective layer is 7 μm.

Through the steps above, an electrophotographic photoreceptor is obtained.

### Examples 2 to 46

### Preparation of Electrophotographic Photoreceptors 2 to 46

An undercoat layer and a charge generating layer are formed on a cylindrical aluminum support by the method described in Electrophotographic Photoreceptor 1 by sequential coating. Thereafter, according to Table 1, the protective layer is formed by the method described in Electrophotographic Photoreceptor 1 except that the composition of the coating liquid for forming a protective layer (the kinds and amounts of the reactive charge transporting material, the non-reactive charge transporting material, the resin, and the particles other than fluorine-containing resin particles (denoted as “particle” in the corner in Table 1)) are changed, thereby preparing an electrophotographic photoreceptor.

In addition, in Table 1, the amounts of the charge transporting material and the resin are in parts, and the amount of the particles other than fluorine-containing resin particles is denoted as the amount in the protective layer (the amount (% by weight) based on the solid content of the protective layer).

### Comparative Examples 1 to 3

### Preparation of Electrophotographic Photoreceptors C1 to C3

An undercoat layer and a charge generating layer are formed on a cylindrical aluminum support by the method described in Electrophotographic Photoreceptor 1 by sequential coating. Thereafter, according to Table 2, the protective layer is formed by the method described in Electrophotographic Photoreceptor 1 except that the composition of the coating liquid for forming a protective layer (the kinds and amounts of the reactive charge transporting material, the non-reactive charge transporting material, the resin, and the particles other than fluorine-containing resin particles (denoted as “particle” simply in Table 2)) are changed, thereby preparing an electrophotographic photoreceptor.

In addition, in Table 2, the amounts of the charge transporting material and the resin are in parts, and the amount of the particles other than fluorine-containing resin particles is denoted as the amount in the protective layer (the amount (% by weight) based on the solid content of the protective layer).

Evaluation

Preparation of Developer

Preparation of Resin Particle Dispersion

A solution obtained by mixing and dissolving 370 parts by weight of styrene, 30 parts by weight of n-butylacrylate, 8 parts by weight of acrylic acid, 24 parts by weight of dodecanthiol, and 4 parts by weight of carbon tetraoxide is emulsion-polymerized in a flask containing 6 parts by weight of a nonionic surfactant (NONIPOL 400: manufactured by Sanyo Chemical Industries, Ltd.) and 10 parts by weight of an anionic surfactant (NEOGEN SC: manufactured by Dai-ichi Kogyo Seiyaku Co., Ltd.) dissolved in 550 parts by weight of ion-exchange water, and 50 parts by weight of ion-exchange water in which 4 parts by weight of ammonium persulfate is dissolved is added thereto while slowly mixing over 10 minutes. After flushing with nitrogen, the mixture in the flask is heated in an oil bath until the content reached 70° C., and emulsion polymerization is continued as it is for 5 hours. As a result, a resin particle dispersion in which resin particles having a volume average particle diameter D50v of 150 nm, a glass transition temperature Tg of 58° C., and a weight average molecular weight Mw of 11500 are dispersed is obtained. The solid concentration of this dispersion is 40% by weight.

Preparation of Colorant Particle Dispersion (1)
Carbon black (MOGAL L, manufactured by Cabot Corporation): 60 parts by weight
Nonionic surfactant (NONIPOL 400: manufactured by Sanyo Chemical Industries, Ltd.): 6 parts by weight
Ion-exchange water: 240 parts by weight

The components above are mixed and stirred for 10 minutes using a homogenizer (ULTRA-TURRAX T50: manufactured by IKA Co., Ltd.), and then subjected to a dispersion treatment by using the Ultimizer, thereby preparing a colorant particle dispersion (1) containing colorant (carbon black) particles having an average particle diameter of 250 nm dispersed therein.

Preparation of Colorant Particle Dispersion (2)
Cyan pigment B15:3: 60 parts by weight
Nonionic surfactant (NONIPOL 400: manufactured by Sanyo Chemical Industries, Ltd.): 5 parts by weight
Ion-exchange water: 240 parts by weight

The components above are mixed and stirred for 10 minutes using a homogenizer (ULTRA-TURRAX T50: manufactured by IKA Co., Ltd.), and then subjected to a dispersion treatment by using the Ultimizer, thereby preparing a colorant particle dispersion (2) containing colorant (Cyan pigment) particles having an average particle diameter of 250 nm dispersed therein.

Preparation of Colorant Particle Dispersion (3)
Magenta pigment R122: 60 parts by weight
Nonionic surfactant (NONIPOL 400: manufactured by Sanyo Chemical Industries, Ltd.): 5 parts by weight
Ion-exchange water: 240 parts by weight

The components above are mixed and stirred for 10 minutes using a homogenizer (ULTRA-TURRAX T50: manufactured by IKA Co., Ltd.), and then subjected to a dispersion treatment by using the Ultimizer, thereby preparing a colorant particle dispersion (3) containing colorant (Magenta pigment) particles having an average particle diameter of 250 nm dispersed therein.

Preparation of Colorant Particle Dispersion (4)
Yellow pigment Y180: 90 parts by weight
Nonionic surfactant (NONIPOL 400: manufactured by Sanyo Chemical Industries, Ltd.): 5 parts by weight
Ion-exchange water: 240 parts by weight

The components above are mixed and stirred for 10 minutes using a homogenizer (ULTRA-TURRAX T50: manufactured by IKA Co., Ltd.), and then subjected to a dispersion treatment by using the Ultimizer, thereby preparing a colorant particle dispersion (4) containing colorant (Yellow pigment) particles having an average particle diameter of 250 nm dispersed therein.

Preparation of Release Agent Particle Dispersion
Paraffin wax: 100 parts by weight (HNP0190: manufactured by Nippon Seiro Co., Ltd., melting temperature of 85° C.)
Cationic surfactant: 5 parts by weight (SANISOL B50: manufactured by Kao Corporation)
Ion-exchange water: 240 parts by weight

The components above are dispersed for 10 minutes in a round-bottom stainless steel flask by using a homogenizer (ULTRA-TURRAX T50: manufactured by IKA Co., Ltd.), and then subjected to a dispersion treatment by using a high-pressure extrusion Ultimizer, thereby preparing a release agent particle dispersion containing release agent particles having a volume average particle diameter of 550 nm.

Preparation of Toner K1
Resin particle dispersion: 234 parts by weight
Colorant particle dispersion (1): 30 parts by weight
Release agent particle dispersion: 40 parts by weight
Polyaluminum hydroxide (manufactured by Asada Chemical Industry Co., Ltd., Paho2S): 0.5 parts by weight
Ion-exchange water: 600 parts by weight

The components above are mixed and dispersed in a round-bottom stainless steel flask by using a homogenizer (ULTRA-TURRAX T50: manufactured by IKA Co., Ltd.), and then heated to 40° C. in a heating oil bath while the content in the flask is stirred. After the solution is kept at 40° C. for 30 minutes, generation of coagulated particles having a D50 of 4.5 μm is confirmed. Further, the temperature of the heating oil bath is raised to and kept at 56° C. for 1 hour, and thus, the D50v reached 5.3 p.m. To the dispersion including these coagulated particles is added 26 parts by weight of the resin particle dispersion, and then the temperature of the heating oil bath is raised to and kept at 50° C. for 30 minutes. The pH of the dispersion including these coagulated particles is adjusted to 7.0 by the addition of 1 N sodium hydroxide. Then, the stainless steel flask is tightly sealed; and the mixture is heated to 80° C. while stirred continuously with a magnetic seal and kept at the same temperature for 4 hours. After the mixture is cooled, the toner particles are separated by filtration, washed with ion-exchange water four times, and then freeze-dried, thereby obtaining toner particles K1. The D50 and the shape factors SF1 of the toner particles K1 are 5.9 μm and 132, respectively.

Next, to 100 parts by weight of the toner particles K1, 1 part of rutile type titanium oxide (volume average particle diameter of 20 nm; and n-decyltrimethoxysilane surface-treated), 2.0 parts by weight of silica particles (volume average particle diameter of 40 nm; silicone oil surface-treated; and prepared by gas-phase oxidation), 1 part by weight of cerium oxide particles (volume average particle diameter of 0.7 μm), and 0.3 parts by weight of zinc stearate particles (particles having a number average particle diameter 8.0 μm, obtained by pulverizing higher fatty acid alcohols having a molecular weight of 700 and zinc stearate at 5:1 by weight using a jet mill) are mixed by a 5-liter Henschel mixer at a peripheral velocity of 30 m/s for 15 minutes, and filtered through a sieve having an opening of 45 μm for removing coarse particles, thereby obtaining a toner 1.

Preparation of Toner C1

In the same manner as for the toner particles K1 except that the colorant particle dispersion (2) is used instead of the colorant particle dispersion (1), toner particles C1 are obtained. The D50 and the shape factors SF1 of these toner particles C1 are 5.8 μm and 131, respectively.

In addition, in the same manner as for the toner K1 except that the toner particles C1 are used instead of the toner particles K1, a toner C1 is obtained.

Preparation of Toner M1

In the same manner as for the K1 except that the colorant particle dispersion (3) is used instead of the colorant particle dispersion (1), toner particles M1 are obtained. The D50 and the shape factors SF1 of these toner particles M1 are 5.5 μm and 135, respectively.

In addition, in the same manner as for the toner K1 except that the toner particles M1 are used instead of the toner particles K1, a toner C1 is obtained.

Preparation of Toner Y1

In the same manner as for the toner particles K1 except that the colorant particle dispersion (4) is used instead of the colorant particle dispersion (1), toner particles Y1 are obtained. The D50 and the shape factors SF1 of these toner particles Y1 are 5.9 μm and 130, respectively.

In addition, in the same manner as for the toner K1 except that the toner particles Y1 are used instead of the toner particles K1, a toner Y1 is obtained.

Preparation of Carrier
Ferrite particles (volume average particle diameter: 50 μm): 100 parts by weight
Toluene: 14 parts by weight
Styrene/methacrylate copolymer (component ratio: 90/10): 2 parts by weight
Carbon black (R330: manufactured by Cabot Corporation): 0.2 parts by weight

First, the components above except for ferrite particles are stirred for 10 minutes by a stirrer to prepare a dispersed coating solution. Next, this coating solution and the ferrite particles are placed in a vacuum-deaeration kneader, stirred at 60° C. for 30 minutes, and then dried by deaeration under reduced pressure while further warming, thereby obtaining a carrier. The volumetric resistivity of the carrier is 10¹¹ Ωcm when an electric field of 1000 V/cm is applied.

Preparation of Developers K1, C1, M1, and Y1

5 parts of each of the toners K1, C1, M1, and Y1, based on 100 parts by weight of the carrier, are mixed, stirred in a V blender at 40 rpm for 20 minutes, and filtered through a sieve having an opening of 212 μm, thereby preparing each of developers K1, C1, M1, and Y1.

Performance Evaluation

Performance of Image Formation 1

Each of the developers prepared in each of the electrophotographic photoreceptors in Examples is installed in DocuCentre Color 400CP (manufactured by Fuji Xerox Co., Ltd.), an image evaluation pattern usually having a solid color image portion with an image density of 100%, a halftone image portion with an image density of 10%, and a fine-line image portion under an environment (20° C., 50% RH) is printed. Thereafter, continuously, 30000 sheets of black solid image are printed and then the image evaluation pattern is printed again. Further, the light intensity is adjusted using a filter depending on the sensitivity of the charge generating material.

Evaluation of Stability of Electrical Characteristics

Before and after the performing the image formation 1, the electrophotographic photoreceptor of each of Examples is negatively charged by a scorotron charging device of a grid applied voltage of −700 V usually under an environment (20° C., 50% RH), and then the charged photoreceptor is flash exposed with a light intensity of 10 mJ/m² using a semiconductor laser at 780 nm. After being exposed, the potential (V) of the surface of the photoreceptor after 10 seconds is measured and this value is taken as a value of a residual potential. In any of the photoreceptors, residual potential denotes negative values. In each of the photoreceptors, a value of (the residual potential before performing the image formation 1)−(the residual potential after performing the image formation 1) is calculated and the stability of the electrical characteristics is evaluated. A++ denotes best characteristics.

A++: Less than 10 V

A+: 10 V or more and less than 20 V

A: 20 V or more and less than 30 V

B: 30 V or more and less than 50 V

C: 50 V or more

Evaluation of Scratch Resistance

The degree of generation of scratches on the surface of the electrophotographic photoreceptor surface after performing the image formation 1 is evaluated as follows. A++ denotes best characteristics.

A++: Scratches are not observed even by a microscope.

A+: Scratches are not visually observed, but a little scratches are observed by a microscope.

A: Some scratches are visually observed (acceptable in practical use).

B: Scratches are partially generated.

C: Scratches are wholly generated.

Evaluation of Particle Dispersibility

The dispersibility of the silica particles of the electrophotographic photoreceptor prepared in each of Examples is evaluated by the following method. From the substrate of the electrophotographic photoreceptor, a slice of a laminate including layers from the undercoat layer to the protective layer is cut off using a single blade razor for trimming (manufactured by Nisshin EM Corporation), and the slice is embedded in a photocurable acrylic resin (product name D-800: manufactured by Nippon Electronics Datum Co., Ltd.). Subsequently, by a microtome method (microtome device: manufactured by LEICA) using a diamond knife, the slice is cut such that the cross-section of the slice of laminate is shown. The cross-section of the slice is observed using a laser microscope OLS-1100 manufactured by Olympus Optical Co., Ltd. under a condition of a stepping amount of 0.01 and the dispersibility is judged by the following criteria.

A+: Particles are uniformly dispersed without aggregation.

A: Particles are uniformly dispersed with partial slight aggregation.

B: Slight aggregation occurs.

C: Significant aggregation occurs.

TABLE 1

| | Reactive charge transporting material | | | | | | Particles | | Stability of | | Dispersibility |
|---|---|---|---|---|---|---|---|---|---|---|---|
| | | | Non- | | Resin | | | % by | electrical | Scratch | of silica |
| | Crosslinked | Parts | crosslinked | Parts | Kind | Parts | Kind | weight | characteristics | resistance | particle |
| Example 1 | a-11 | 100 | — | — | — | — | b-1 | 5 | A | A+ | A |
| Example 2 | a-12 | 100 | — | — | — | — | b-1 | 5 | A | A+ | A |
| Example 3 | a-13 | 100 | — | — | — | — | b-1 | 5 | A | A+ | A |
| Example 4 | a-14 | 100 | — | — | — | — | b-1 | 5 | A | A+ | A |
| Example 5 | a-15 | 100 | — | — | — | — | b-1 | 5 | A | A+ | A |
| Example 6 | a-1 | 100 | — | — | — | — | b-1 | 5 | A++ | A++ | A |
| Example 7 | a-2 | 100 | — | — | — | — | b-1 | 5 | A++ | A++ | A+ |
| Example 8 | a-3 | 100 | — | — | — | — | b-1 | 5 | A++ | A++ | A+ |
| Example 9 | a-4 | 100 | — | — | — | — | b-1 | 5 | A+ | A++ | A+ |
| Example 10 | a-5 | 100 | — | — | — | — | b-1 | 5 | A+ | A++ | A+ |
| Example 11 | a-6 | 100 | — | — | — | — | b-1 | 5 | A+ | A++ | A+ |
| Example 12 | a-7 | 100 | — | — | — | — | b-1 | 5 | A | A+ | A+ |
| Example 13 | a-8 | 100 | — | — | — | — | b-1 | 5 | A | A+ | A+ |
| Example 14 | a-9 | 100 | — | — | — | — | b-1 | 5 | A | A+ | A+ |
| Example 15 | a-16 | 100 | — | — | — | — | b-1 | 5 | A+ | A+ | A+ |
| Example 16 | a-17 | 100 | — | — | — | — | b-1 | 5 | A | A | A+ |
| Example 17 | a-18 | 100 | — | — | — | — | b-1 | 5 | A | A | A+ |
| Example 18 | a-19 | 100 | — | — | — | — | b-1 | 5 | A | A | A+ |
| Example 19 | a-20 | 100 | — | — | — | — | b-1 | 5 | A+ | A+ | A+ |
| Example 20 | a-21 | 100 | — | — | — | — | b-1 | 5 | A++ | A++ | A+ |
| Example 21 | a-22 | 100 | — | — | — | — | b-1 | 5 | A++ | A++ | A+ |
| Example 22 | a-23 | 100 | — | — | — | — | b-1 | 5 | A++ | A++ | A+ |
| Example 23 | a-24 | 100 | — | — | — | — | b-1 | 5 | A++ | A++ | A+ |
| Example 24 | a-1 | 100 | — | — | — | — | b-1 | 25 | A++ | A++ | A+ |
| Example 25 | a-1 | 100 | — | — | — | — | b-1 | 1 | A++ | A+ | A+ |
| Example 26 | a-1 | 100 | — | — | — | — | b-1 | 50 | A+ | A++ | A |
| Example 27 | a-1 | 100 | — | — | — | — | b-2 | 5 | A++ | A++ | A |
| Example 28 | a-1 | 100 | — | — | — | — | b-3 | 5 | A++ | A++ | A |
| Example 29 | a-1 | 100 | — | — | — | — | b-4 | 5 | A++ | A++ | A+ |
| Example 30 | a-1 | 100 | — | — | — | — | b-5 | 5 | A++ | A++ | A+ |
| Example 31 | a-1 | 100 | — | — | — | — | b-6 | 5 | A++ | A++ | A+ |
| Example 32 | a-1 | 100 | — | — | — | — | b-7 | 5 | A++ | A++ | A+ |
| Example 33 | a-1 | 100 | — | — | — | — | b-8 | 5 | A++ | A++ | A+ |
| Example 34 | a-1 | 70 | a-10 | 30 | — | — | b-1 | 5 | A++ | A++ | A+ |
| Example 35 | a-2 | 70 | a-10 | 30 | — | — | b-1 | 5 | A++ | A+ | A+ |
| Example 36 | a-3 | 70 | a-10 | 30 | — | — | b-1 | 5 | A++ | A+ | A+ |
| Example 37 | a-4 | 70 | a-10 | 30 | — | — | b-1 | 5 | A+ | A+ | A+ |
| Example 38 | a-5 | 70 | a-10 | 30 | — | — | b-1 | 5 | A++ | A | A+ |
| Example 39 | a-6 | 70 | a-10 | 30 | — | — | b-1 | 5 | A++ | A+ | A+ |
| Example 40 | a-7 | 70 | a-10 | 30 | — | — | b-1 | 5 | A++ | A++ | A+ |
| Example 41 | a-8 | 70 | a-10 | 30 | — | — | b-1 | 5 | A++ | A+ | A+ |
| Example 42 | a-9 | 70 | a-10 | 30 | — | — | b-1 | 5 | A++ | A+ | A+ |
| Example 43 | a-1 | 100 | — | — | — | — | b-1 | 53 | A+ | A++ | A |
| Example 44 | a-1 | 100 | — | — | — | — | b-1 | 33 | A++ | A+ | A+ |
| Example 45 | a-1 | 100 | — | — | — | — | b-1 | 7 | A++ | A+ | A |
| Example 46 | — | — | a-10 | 30 | c-1 | 70 | b-1 | 5 | B | A | C |

TABLE 2

| | Reactive charge transporting material | | | | | | Particles | | Stability of | | Dispersibility |
|---|---|---|---|---|---|---|---|---|---|---|---|
| | | | Non- | | Resin | | | % by | electrical | Scratch | of silica |
| | Crosslinked | Parts | crosslinked | Parts | Kind | Parts | Kind | weight | characteristics | resistance | particle |
| Comparative | a-1 | 100 | — | — | — | — | — | — | A++ | B | — |
| Example 1 | | | | | | | | | | | |
| Comparative | a-1 | 70 | a-10 | 30 | — | — | — | — | A++ | C | — |
| Example 2 | | | | | | | | | | | |
| Comparative | a-1 | 70 | a-10 | 30 | — | — | b-9 | — | A+ | C | C |
| Example 3 | | | | | | | | | | | |

From the results above, it may be seen that in the present Examples, the dispersibility of the silica particles is good, and good results are obtained in the evaluation of the stability of electrical characteristics and scratch resistance, as compared with Comparative Examples.

Hereinafter, details of the abbreviations or the like in Tables 1 and 2 are shown.

Reactive Charge Transporting Materials
(a-1): Exemplary compound (I-b)-21
(a-2): Exemplary compound (I-b)-23
(a-3): Exemplary compound (I-b)-25
(a-4): Exemplary compound (I-d)-7
(a-5): Exemplary compound (I-d)-8
(a-6): Exemplary compound (I-d)-10
(a-7): Exemplary compound (11)-171
(a-8): Exemplary compound (11)-176
(a-9): Exemplary compound (II)-180
(a-10): Compound represented by the following structural formula
(a-11): Compound represented by the following structural formula
(a-12): Compound represented by the following structural formula
(a-13): Compound represented by the following structural formula
(a-14): Compound represented by the following structural formula
(a-15): Compound represented by the following structural formula
(a-16): Exemplary compound (I-a)-21
(a-17): Exemplary compound (I-a)-25
(a-18): Exemplary compound (I-c)-11
(a-19): Exemplary compound (I-c)-17
(a-20): Exemplary compound (I-c)-121
(a-21): Exemplary compound (II)-35
(a-22): Exemplary compound (II)-187
(a-23): Exemplary compound (II)-38
(a-24): Exemplary compound (II)-184

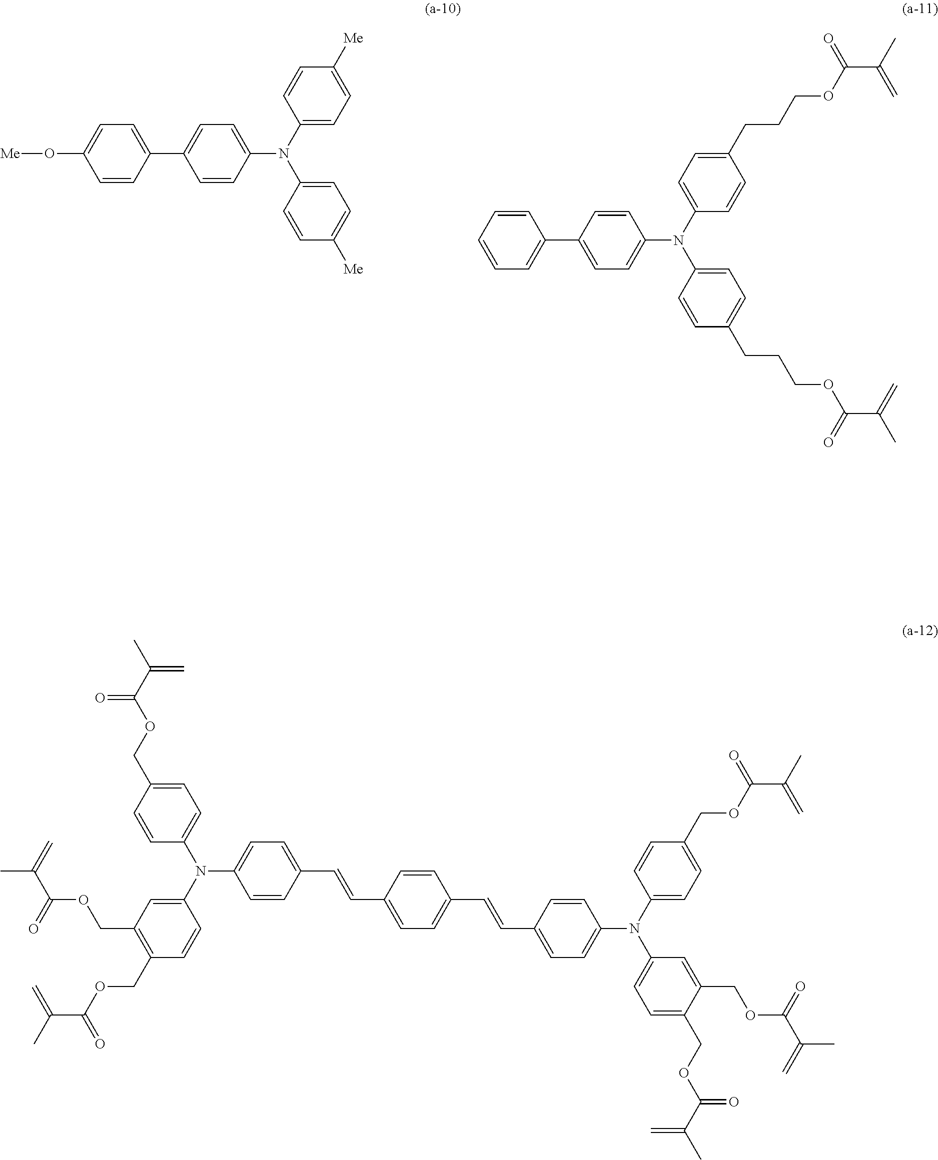 [SMILES: COc1ccc(-c2ccc(N(c3ccc(C)cc3)c3ccc(C)cc3)cc2)cc1 ; C=C(C)C(=O)OCCCc1ccc(N(c2ccc(CCCOC(=O)C(=C)C)cc2)c2ccc(-c3ccccc3)cc2)cc1 ; C=C(C)C(=O)OCc1ccc(N(c2ccc(/C=C/c3ccc(/C=C/c4ccc(N(c5ccc(COC(=O)C(=C)C)cc5)c5ccc(COC(=O)C(=C)C)c(COC(=O)C(=C)C)c5)cc4)cc3)cc2)c2ccc(COC(=O)C(=C)C)c(COC(=O)C(=C)C)c2)cc1]

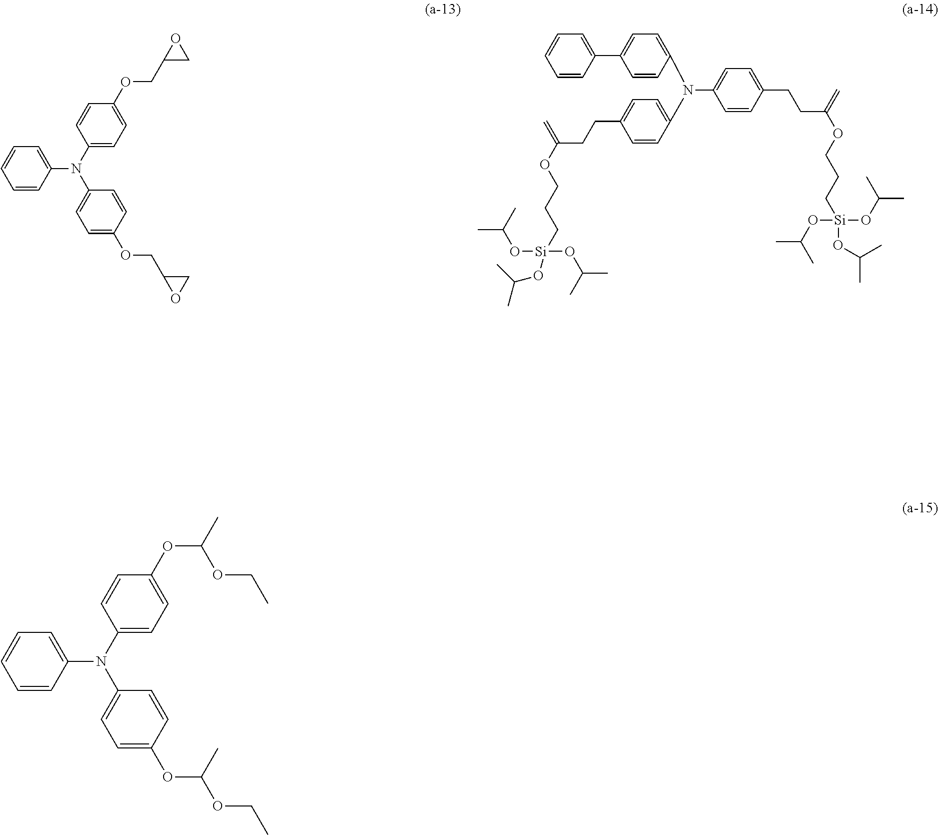 [SMILES: c1ccc(N(c2ccc(OCC3CO3)cc2)c2ccc(OCC3CO3)cc2)cc1 ; C=C(CCc1ccc(N(c2ccc(CCC(=C)OCCC[Si](OC(C)C)(OC(C)C)OC(C)C)cc2)c2ccc(-c3ccccc3)cc2)cc1)OCCC[Si](OC(C)C)(OC(C)C)OC(C)C ; CCOC(C)Oc1ccc(N(c2ccccc2)c2ccc(OC(C)OCC)cc2)cc1]

Particles: Particles other than Fluorine-Containing Resin Particles
b-1: Fumed silica particles (non-hollow silica particles) after the completion of a hydrophobization treatment with hexamethyldisilazane (HMDS), product name: R812, manufactured by Nippon Aerosil Co., Ltd., volume average particle diameter of 7 nm
b-2: Fumed silica particles (non-hollow silica particles) after the completion of a hydrophobization treatment with dimethyldichlorosilane (DDS), product name: R972, manufactured by Nippon Aerosil Co., Ltd., volume average particle diameter of 16 nm
b-3: Fumed silica particles (non-hollow silica particles) after the completion of a hydrophobization treatment with dimethyldichlorosilane (DDS), product name: R974, manufactured by Nippon Aerosil Co., Ltd., volume average particle diameter of 12 nm
b-4: Silica particles (hollow silica particles) after the completion of a hydrophobization treatment with a silane coupling agent, product name: SiliNax, manufactured by Nittetsu Mining Co., Ltd., volume average particle diameter of 100 nm
b-5: Sol-gel Silica particles (hollow silica particles) after the completion of a hydrophobization treatment with a silicone oil, product name: OSCAL1432M, manufactured by JGC Catalysts and Chemicals Ltd. (hydrophobization treatment), volume average particle diameter of 12 nm
b-6: Sol-gel Silica particles (hollow silica particles) after the completion of a hydrophobization treatment with a silane coupling agent, product name: Throughrear 1110, manufactured by JGC Catalysts and Chemicals Ltd. (hydrophobization treatment), volume average particle diameter of 50 nm
b-7: Product name: Throughrear 4110, manufactured by JGC Catalysts and Chemicals Ltd. (hydrophobization treatment), volume average particle diameter of 60 nm
b-8: Sol-gel Silica particles (non-hollow silica particles) after the completion of a hydrophobization treatment with a silicone oil, product name: OSCAL1421, manufactured by JGC Catalysts and Chemicals Ltd., volume average particle diameter of 7 nm
b-9: Hydrophilic silica particles (non-hollow silica particles), product name: OX50, manufactured by Nippon Aerosil Co., Ltd., volume average particle diameter of 90 nm

Resins
(c-1): Polycarbonate copolymer resin synthesized by the following preparation method.

Synthesis of Resin (c-1)

In a flask equipped with a phosgene inlet tube, a thermometer, and a stirrer, 106.9 g (0.398 moles) of 1,1-bis (4-hydroxyphenyl)cyclohexane (solubility parameter=11.28, hereinafter referred to as Z), 24.7 g (0.133 moles) of 4,4′-dihydroxybiphenyl (solubility parameter=12.39, hereinafter referred to as BP), 0.41 g of hydrosulfide, 825 ml (sodium hydroxide 2.018 moles) of a 9.1% sodium hydroxide aqueous solution, and 500 ml of methylene chloride are placed and dissolved under a nitrogen atmosphere, maintained at from 18° C. to 21° C. under stirring, and 76.2 g (0.770 moles) of phosgene is introduced theretinto for 75 minutes to perform a phosgenation reaction. After the completion of the phosgenation reaction, 1.11 g (0.0075 moles) of p-tert-butylphenol and 54 ml (sodium hydroxide 0.266 moles) of a 25% sodium hydroxide aqueous solution are added thereto, followed by stirring, while 0.18 mL (0.0013 moles) of triethylamine is added thereto to perform a reaction at a temperature from 30° C. to 35° C. for 2.5 hours.

The separated methylene chloride phase is washed with an acid and water until the inorganic salts and the amines disappeared, and then methylene chloride is removed to obtain a resin (c-1) [polycarbonate copolymer]. The resin (c-1) [polycarbonate copolymer] has a ratio of structural units of Z ((Z)-0) to BP ((BP-0) of 75:25 in terms of a molar ratio. In addition, the resin had a solubility parameter of 11.56 and a viscosity average molecular weight of 50,000.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising a conductive substrate and a photosensitive layer provided on the conductive substrate,
wherein an outermost surface layer of the electrophotographic photoreceptor is a cured film of a composition comprising a reactive charge transporting material and silica particles having a hydrophobization-treated surface.

2. The electrophotographic photoreceptor according to claim 1, wherein the silica particles are hollow silica particles.

3. The electrophotographic photoreceptor according to claim 1, wherein the reactive charge transporting material is at least one kind selected from the group consisting of the reactive compounds represented by the following formulae (I) and (II): 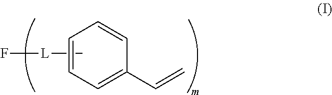
wherein F represents a charge transporting skeleton; L represents a divalent linking group including two or more selected from the group consisting of an alkylene group, an alkenylene group, —C(═O)—, —N(R)—, —S—, and —O—; R represents a hydrogen atom, an alkyl group, an aryl group, or an aralkyl group; and m represents an integer of 1 to 8, 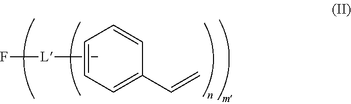
wherein F represents a charge transporting skeleton; L′ represents an (n+1)-valent linking group including two or more selected from the group consisting of a trivalent or tetravalent group derived from an alkane or an alkene, an alkylene group, an alkenylene group, —C(═O)—, —N(R)—, —S—, and —O—; R represents a hydrogen atom, an alkyl group, an aryl group, or an aralkyl group; m′ represents an integer of 1 to 6; and n represents an integer of 2 or 3.

4. The electrophotographic photoreceptor according to claim 2, wherein the reactive charge transporting material is at least one kind selected from the group consisting of the reactive compounds represented by the following formulae (I) and (II): 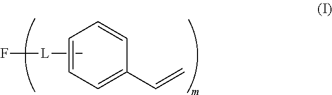
wherein F represents a charge transporting skeleton; L represents a divalent linking group including two or more selected from the group consisting of an alkylene group, an alkenylene group, —C(═O)—, —N(R)—, —S—, and —O—; R represents a hydrogen atom, an alkyl group, an aryl group, or an aralkyl group; and m represents an integer of 1 to 8, 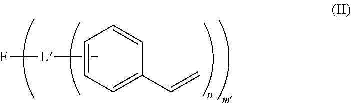
wherein F represents a charge transporting skeleton; L′ represents an (n+1)-valent linking group including two or more selected from the group consisting of a trivalent or tetravalent group derived from an alkane or an alkene, an alkylene group, an alkenylene group, —C(═O)—, —N(R)—, —S—, and —O—; R represents a hydrogen atom, an alkyl group, an aryl group, or an aralkyl group; m′ represents an integer of 1 to 6; and n represents an integer of 2 or 3.

5. The electrophotographic photoreceptor according to claim 3, wherein the reactive compound represented by formula (I) is a reactive compound which is at least one kind selected from the group consisting of the reactive compounds represented by the following formula (I-a), the following formula (I-b), the following formula (I-c), and the following formula (I-d): 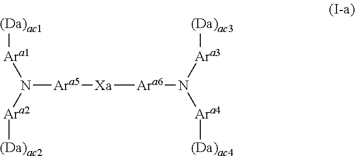
wherein Ar^{a1} to Ar^{a4} each independently represents a substituted or unsubstituted aryl group; Ar^{a5} and Ar^{a6} each independently represents a substituted or unsubstituted arylene group; Xa represents a divalent linking group formed by a combination of the groups selected from an alkylene group, —O—, —S—, and an ester group; Da represents a group represented by the following formula (IA-a); and ac1 to ac4 each independently represents an integer of 0 to 2, provided that the total number of Da is 1 or 2, 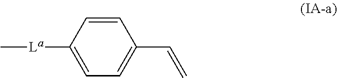
wherein La is represented by *—(CH₂)ₐₓ—O—CH₂— and represents a divalent linking group linked to a group represented by Arₐ₁ to Arₐ₄ at *; and ax represents an integer of 1 or 2, 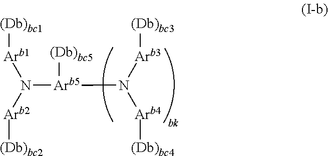
wherein Ar^{b1} to Ar^{b4} each independently represents a substituted or unsubstituted aryl group; Ar^{b5} represents a substituted or unsubstituted aryl group, or a substituted or unsubstituted arylene group; Db represents a group represented by the following formula (IA-b); bc1 to bc5 each independently represents an integer of 0 to 2; and bk represents 0 or 1, provided that the total number of Db is 1 or 2, 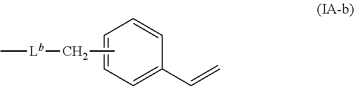
wherein L^{b} includes a group represented by *—(CH₂)_{bn}—O— and represents a divalent linking group linked to a group represented by Ar^{b1} to Ar^{b5} at *; and bn represents an integer of 3 to 6, 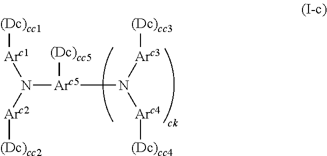
wherein Ar^{c1} to Ar^{c4} each independently represent a substituted or unsubstituted aryl group; Ar^{c5} represents a substituted or unsubstituted aryl group, or a substituted or unsubstituted arylene group; Dc represents a group represented by the following formula (IA-c); cc1 to cc5 each independently represent an integer of 0 to 2; and ck represents 0 or 1, provided that the total number of Dc is from 1 to 8, 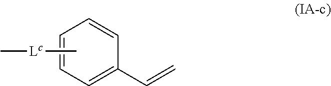
wherein Lc represents a divalent linking group including one or more groups selected from the group consisting of —C(═O)—, —N(R)—, —S—, and a group formed by a combination of —C(═O)—, and —O—, —N(R)—, or —S—; and R represents a hydrogen atom, an alkyl group, an aryl group, or an aralkyl group, 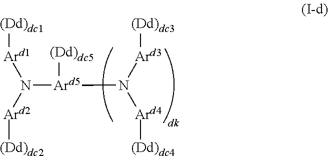
wherein Ar^{d1} to Ar^{d4} each independently represent a substituted or unsubstituted aryl group; Ar^{d5} represents a substituted or unsubstituted aryl group, or a substituted or unsubstituted arylene group; Dd represents a group represented by the following formula (IA-d); dc1 to dc5 each independently represent an integer of 0 to 2; and dk represents 0 or 1, provided that the total number of Dd is from 3 to 8, 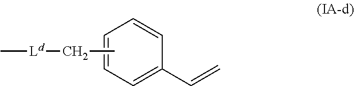
wherein L^{d} includes a group represented by *—(CH₂)_{dn}—O—, and represents a divalent linking group linked to a group represented by Ar^{d1} to Ar^{d5} at *; and do represents an integer of 1 to 6.

6. The electrophotographic photoreceptor according to claim 4, wherein the reactive compound represented by formula (I) is a reactive compound which is at least one kind selected from the group consisting of the reactive compounds represented by the following formula (I-a), the following formula (I-b), the following formula (I-c), and the following formula (I-d): 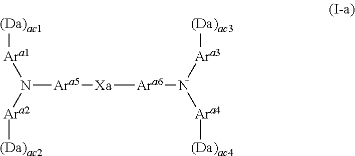
wherein Ar^{a1} to Ar^{a4} each independently represent a substituted or unsubstituted aryl group; Ar^{a5} and Ar^{a6} each independently represent a substituted or unsubstituted arylene group; Xa represents a divalent linking group formed by a combination of the groups selected from an alkylene group, —O—, —S—, and an ester group; Da represents a group represented by the following formula (IA-a); and ac1 to ac4 each independently represent an integer of 0 to 2, provided that the total number of Da is 1 or 2, 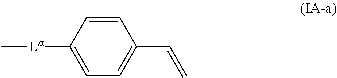
wherein La is represented by *—(CH₂)ₐₓ—O—CH₂— and represents a divalent linking group linked to a group represented by Arₐ₁ to Arₐ₄ at *; and ax represents an integer of 1 or 2, 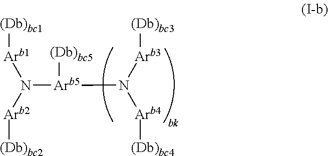
wherein Ar^{b1} to Ar^{b4} each independently represent a substituted or unsubstituted aryl group; Ar^{b5} represents a substituted or unsubstituted aryl group, or a substituted or unsubstituted arylene group; Db represents a group represented by the following formula (IA-b); bc1 to bc5 each independently represent an integer of 0 to 2; and bk represents 0 or 1, provided that the total number of Db is 1 or 2, 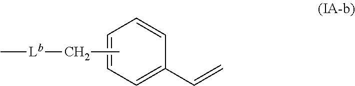
wherein L^{b} includes a group represented by *—(CH₂)_{bn}—O— and represents a divalent linking group linked to a group represented by Ar^{b1} to Ar^{b5} at *; and bn represents an integer of 3 to 6, 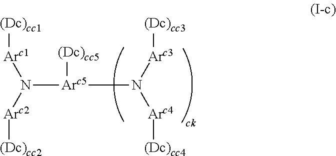
wherein Ar^{c1} to Ar^{c4} each independently represent a substituted or unsubstituted aryl group; Ar^{c5} represents a substituted or unsubstituted aryl group, or a substituted or unsubstituted arylene group; Dc represents a group represented by the following formula (IA-c); cc1 to cc5 each independently represent an integer of 0 to 2; and ck represents 0 or 1, provided that the total number of Dc is from 1 to 8, 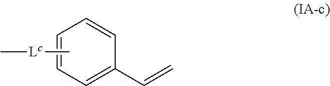
wherein Lc represents a divalent linking group including one or more groups selected from the group consisting of —C(═O)—, —N(R)—, —S—, and a group formed by a combination of —C(═O)—, and —O—, —N(R)—, or —S—; and R represents a hydrogen atom, an alkyl group, an aryl group, or an aralkyl group, 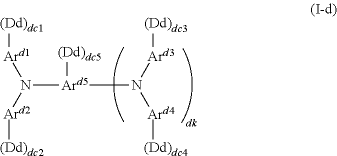
wherein Ar^{d1} to Ar^{d4} each independently represent a substituted or unsubstituted aryl group; Ar^{d5} represents a substituted or unsubstituted aryl group, or a substituted or unsubstituted arylene group; Dd represents a group represented by the following formula (IA-d); dc1 to dc5 each independently represent an integer of 0 to 2; and dk represents 0 or 1, provided that the total number of Dd is from 3 to 8, 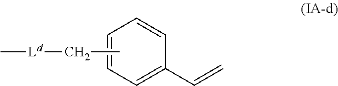
wherein L^{d} includes a group represented by *—(CH₂)_{dn}—O—, and represents a divalent linking group linked to a group represented by Ar^{d1} to Ar^{d5} at *; and do represents an integer of 1 to 6.

7. The electrophotographic photoreceptor according to claim 5, wherein the group represented by the formula (IA-c) is a group represented by the following formula (IA-c1): 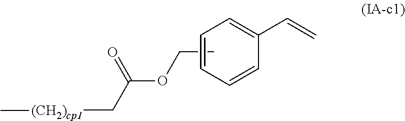
wherein cp1 represents an integer of 0 to 4.

8. The electrophotographic photoreceptor according to claim 6, wherein the group represented by the formula (IA-c) is a group represented by the following formula (IA-c1): 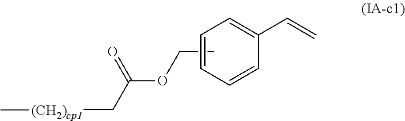
wherein cp1 represents an integer of 0 to 4.

9. The electrophotographic photoreceptor according to claim 3, wherein the compound represented by the formula (II) is a compound represented by the following formula (II-a): 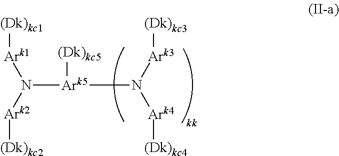
wherein Ar^{k1} to Ar^{k4} each independently represent a substituted or unsubstituted aryl group; Ar^{k5} represents a substituted or unsubstituted aryl group, or a substituted or unsubstituted arylene group; Dk represents a group represented by the following formula (IIA-a); kc1 to kc5 each independently represent an integer of 0 to 2; and kk represents 0 or 1, provided that the total number of Dk is from 1 to 8, 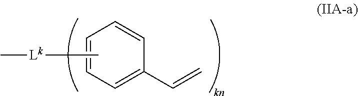
wherein L^{k} represents a (kn+1)-valent linking group including two or more selected from the group consisting of a trivalent or tetravalent group derived from an alkane or an alkene, and an alkylene group, an alkenylene group, —C(═O)—, —N(R)—, —S—, and —O—; R represents a hydrogen atom, an alkyl group, an aryl group, or an aralkyl group; and kn represents an integer of 2 or 3.

10. The electrophotographic photoreceptor according to claim 4, wherein the compound represented by the formula (II) is a compound represented by the following formula (II-a): 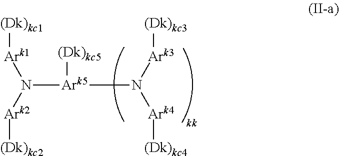
wherein Ar^{k1} to Ar^{k4} each independently represent a substituted or unsubstituted aryl group; Ar^{k5} represents a substituted or unsubstituted aryl group, or a substituted or unsubstituted arylene group; Dk represents a group represented by the following formula (IIA-a); kc1 to kc5 each independently represent an integer of 0 to 2; and kk represents 0 or 1, provided that the total number of Dk is from 1 to 8, 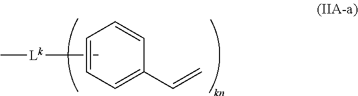
wherein L^{k} represents a (kn+1)-valent linking group including two or more selected from the group consisting of a trivalent or tetravalent group derived from an alkane or an alkene, and an alkylene group, an alkenylene group, —C(═O)—, —N(R)—, —S—, and —O—; R represents a hydrogen atom, an alkyl group, an aryl group, or an aralkyl group; and kn represents an integer of 2 or 3.

11. The electrophotographic photoreceptor according to claim 3, wherein the group linked to the charge transporting skeleton represented by F of the compound represented by the formula (II) is a group represented by the following formula (IIA-a1) or (IIA-a2): 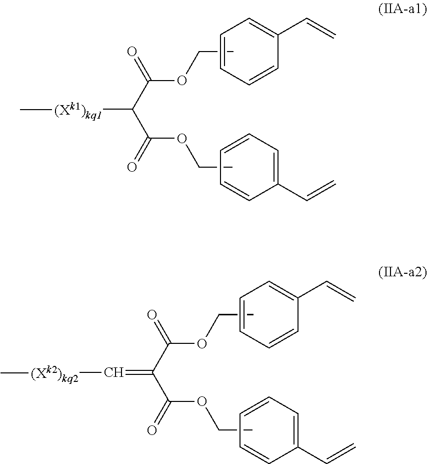
wherein X^{k1} represents a divalent linking group; kq1 represents an integer of 0 or 1; X^{k2} represents a divalent linking group; and kq2 represents an integer of 0 or 1.

12. The electrophotographic photoreceptor according to claim 4, wherein the group linked to the charge transporting skeleton represented by F of the compound represented by the formula (II) is a group represented by the following formula (IIA-a1) or (IIA-a2): 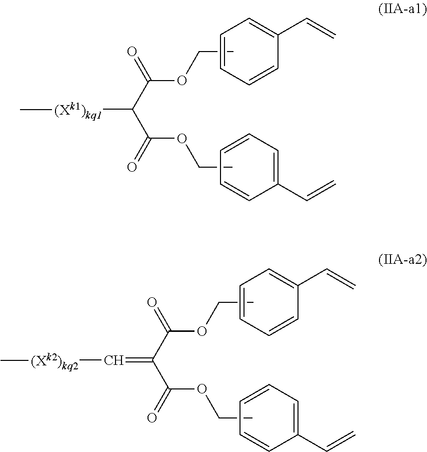
wherein X^{k1} represents a divalent linking group; kq1 represents an integer of 0 or 1; X^{k2} represents a divalent linking group; and kq2 represents an integer of 0 or 1.

13. The electrophotographic photoreceptor according to claim 3, wherein the group linked to the charge transporting skeleton represented by F of the compound represented by the formula (II) is a group represented by the following formula (IIA-a3) or (IIA-a4): 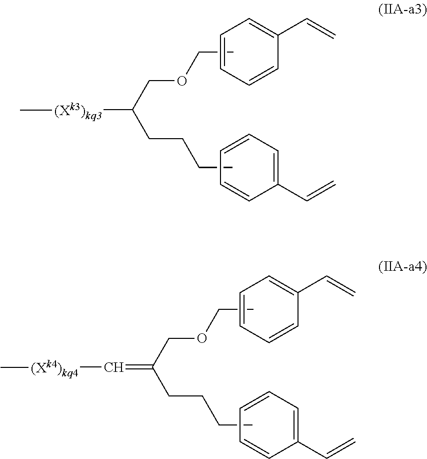
wherein X^{k3} represents a divalent linking group; kq3 represents an integer of 0 or 1; X^{k4} represents a divalent linking group; and kq4 represents an integer of 0 or 1.

14. The electrophotographic photoreceptor according to claim 4, wherein the group linked to the charge transporting skeleton represented by F of the compound represented by the formula (II) is a group represented by the following formula (IIA-a3) or (IIA-a4): 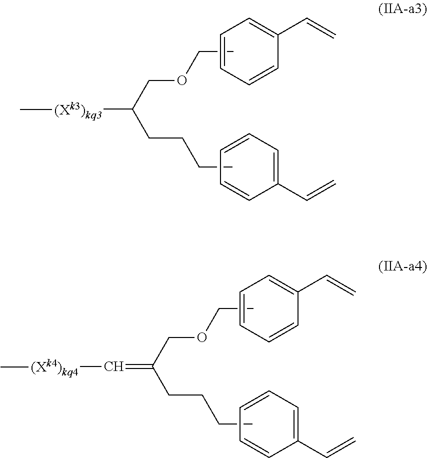
wherein X^{k3} represents a divalent linking group; kq3 represents an integer of 0 or 1; X^{k4} represents a divalent linking group; and kq4 represents an integer of 0 or 1.

15. The electrophotographic photoreceptor according to claim 1, wherein a content of the silica particles is from 1% by weight to 50% by weight based on the outermost surface layer.

16. The electrophotographic photoreceptor according to claim 1, wherein a content of the silica particles is from 5% by weight to 30% by weight based on the outermost surface layer.

17. A process cartridge which is detachable from an image forming apparatus, the process cartridge comprising the electrophotographic photoreceptor according to claim 1.

18. An image forming apparatus comprising:
the electrophotographic photoreceptor according to claim 1;
a charging unit that charges a surface of the electrophotographic photoreceptor;
an electrostatic latent image forming unit that forms an electrostatic latent image on the surface of a charged electrophotographic photoreceptor;
a developing unit that develops the electrostatic latent image formed on the surface of the electrophotographic photoreceptor by a developer including a toner to form a toner image; and
a transfer unit that transfers the toner image onto a surface of a recording medium.
